(19) United States
(12) Patent Application Publication
(10) Pub. No.: US 2026/0022250 A1
(43) Pub. Date: Jan. 22, 2026

(54) Plasma Assisted Production of Carbon Black

(71) Applicant: Orion Engineered Carbons IP GmbH & Co. KG, Monheim (DE)

(72) Inventors: Arndt-Peter Schinkel, Lahnstein (DE); Eddy Timmermans, Hürth (DE); Jad Abi Haidar, Köln (DE); David Deters, Bonn (DE)

(21) Appl. No.: 18/846,689

(22) PCT Filed: Mar. 14, 2023
(86) PCT No.: PCT/EP2023/056507

§ 371 Date: Sep. 13, 2024

(30) Foreign Application Priority Data
Mar. 15, 2022 (EP) 22162325.9

(51) Int. Cl. C09C 1/48

(52) U.S. Cl. CPC C09C 1/485; C09C 1/487

(57) ABSTRACT

The present invention relates to plasma assisted production of carbon black. Particularly, the present invention relates to a method and a reactor, wherein the carbon black feedstock can be injected in multiply positions in the carbon black reactor to avoid droplets in the plasma zone.

### CROSS-REFERENCE TO RELATED APPLICATIONS

This application is the United States national phase of International Patent Application No. PCT/EP2023/056507 filed Mar. 14, 2023, and claims priority to European Patent Application No. 22162325.9 filed Mar. 15, 2022, the disclosures of which are hereby incorporated by reference in their entireties.

### BACKGROUND OF THE INVENTION

### Field of the Invention

The present invention relates to plasma assisted production of carbon black. Particularly, the present invention relates to a method and a reactor, wherein the carbon black feedstock can be injected in multiply positions in the carbon black reactor to avoid droplets in the plasma zone.

### Description of Related Art

Carbon blacks have numerous uses such as a reinforcing agent or filler for the rubber and tire industries. Moreover, carbon black has seen increased use in other areas such as coloring agents and reprographic toners for copying machines. The various applications of carbon black necessitate a diverse range of carbon black characteristics such as particle size, structure, yield, surface area, and stain.

Typically, the production of carbon black produces a significant amount of CO₂ as a by-product. The challenge is to have a carbon black process in place producing consistently carbon blacks with drastically reduced CO₂ emissions. Having a process installed using only electrical energy sources could solve this issue using only green electricity.

Moreover, the available feedstock is often limited due to the presence of droplets in the plasma zone. Droplets in the plasma zone can damage the inner lining of the reaction chamber since in the plasma zone the droplets can contribute to deposit at the wall leading to temperatures above the melting point of the inner lining.

Accordingly, the objective of the present invention is to provide a reactor and a method for the production of carbon black that overcomes the aforementioned drawbacks.

### SUMMARY OF THE INVENTION

This objective can be achieved by a method for producing carbon black comprising: (a) injecting the plasma gas to a carbon black reactor, (b) subjecting the plasma gas to a plasma zone to obtain a product mixture comprising carbon black, (c) quenching the product mixture, (d) separating carbon black from the product mixture, wherein (i) the plasma gas comprises or consists of a carbon black feedstock, (ii) the carbon black feedstock is injected to the plasma gas upstream the plasma zone, (iii) the carbon black feedstock is injected in the plasma zone, but preferably after the area where the plasma is generated, and/or (iv) the carbon black feedstock is injected to the plasma gas downstream the plasma zone.

Moreover, a reactor for producing carbon black having a flow passage along a central longitudinal axis of the reactor is provided that comprises: (A) a reaction chamber, (B) injection means for supplying carbon black feedstock, and (C) means to generate a plasma in the reaction chamber thereby forming a plasma zone, wherein (i) the injection means for supplying carbon black feedstock are located upstream the plasma zone, (ii) the injection means for supplying carbon black feedstock are located at the plasma zone, but preferably after the area where the plasma is generated, and/or (iii) the injection means for supplying carbon black feedstock are located downstream the plasma zone, preferably directly behind the plasma zone. Moreover, a carbon black produced according to the inventive method is provided by preferably using the reactor according to the invention.

The invention is also directed to the use of a minimum molar percentage of plasma gas, plasma gas having a critical temperature below the temperature of the gas, and/or materials having a critical temperature below the temperature of the gas (preferably plasma gas having a critical temperature below the temperature of the gas) for the production carbon black to prevent the formation of droplets in a reactor (or condensation in a reactor), wherein the plasma gas and the carbon black feedstock are mixed before subjecting the gas to the plasma zone, wherein the minimum molar percentage is more than x_{dilutant}, based on the total molar amount of the plasma gas including the carbon black feedstock, wherein x_{dilutant} is calculated according to Formula (V), Formula (IX) and/or Formula (XVII),

$${x}_{dilutant} = max ( 1 - \frac{{P}_{0} exp ( - \frac{{Δ}_{vap} {H}_{m}}{RT} + \frac{{Δ}_{vap} {H}_{m}}{{RT}_{b}} )}{P} , 0 ) \cdot 100 \qquad Formula ( V )$$

wherein x_{dilutant} is the dilution, P [Pa] is the pressure of the plasma gas mixture, P₀ [Pa] is the atmospheric pressure, set to 101325 Pa, ΔᵥₐₚHₘ [J/mol] is the normal molar enthalpy of evaporation (e.g. calculated according to Formula (I)) of the carbon black feedstock, R [J/mol/K] is universal gas constant, i.e. 8.314463 J/mol/K, T [K] is system temperature or temperature of the plasma gas mixture, T_{b} [K] is the normal (at atmospheric pressure P₀=101325 Pa) boiling temperature of the carbon black feedstock,

$${x}_{dilutant} = max ( 1 - \frac{1}{P {\sum }_{i = 1}^{N} \frac{{x}_{i}^{vapour}}{100 {P}_{i}^{s}}} , 0 ) \cdot 100 \qquad Formula ( IX )$$

wherein x_{dilutant} is the dilution, P [Pa] is the pressure of the plasma gas mixture, i is the respective compound in the carbon black feedstock,

$${\sum }_{i = 1}^{N}$$

is the sum from i equals 1 to N, i is the compound index of the compounds in the carbon black feedstock,

$${x}_{i}^{vapour}$$

is the molar percentage of the respective compound in the carbon black feedstock,

$${P}_{i}^{s} [ Pa ]$$

is the vapor pressure of the respective compound i in the carbon black feedstock at the plasma gas temperature T [K],

$${P}_{i}^{s}$$

is calculated according to Formula (X),

$${P}_{i}^{s} = {P}_{0} exp ( - \frac{{Δ}_{vap}}{RT} + \frac{{Δ}_{vap} {H}_{m , i}}{{RT}_{b , i}} ) \qquad Formula ( X )$$

P₀ [Pa] is the atmospheric pressure, set to 101325 Pa, ΔᵥₐₚHₘᵢ [J/mol] is the molar normal enthalpy of evaporation (e.g. calculated according to Formula (I)) of the respective compound in the carbon black feedstock, R [J/mol/K] is universal gas constant, i.e. 8.314463 J/mol/K, T [K] is system temperature or temperature of the plasma gas mixture, T_{b,i} [K] is the normal (at atmospheric pressure P₀=101325 Pa) boiling temperature of the respective compound in the carbon black feedstock,

$${x}_{dilutant} = max ( 1 - \frac{1}{P {\sum }_{i = 1}^{10} \frac{{x}_{pseudo , i}^{vapour}}{100 {P}_{pseudo , i}^{s}}} , 0 ) \cdot 100 \qquad Formula ( XVII )$$

wherein x_{dilutant} is the dilution, P [Pa] is the pressure of the plasma gas mixture, i is the respective sample of the carbon black feedstock,

$${\sum }_{i = 1}^{10}$$

is the sum form i equals 1 to N, i is the compound index of the sample of the carbon black feedstock,

$${x}_{pseudo , i}^{vapour}$$

is the molar percentage of the respective sample of the carbon black feedstock,

$${P}_{pseudo , i}^{s} [ Pa ]$$

is the vapor pressure of the respective sample i of the carbon black feedstock at the plasma gas temperature T [K],

$${P}_{pseudo , i}^{s}$$

is calculated according to Formula (XVIII),

$${P}_{pseudo , i}^{s} = {P}_{0} exp ( - \frac{{Δ}_{vap} {H}_{m . i}}{RT} + \frac{{Δ}_{vap} {H}_{m , i}}{{RT}_{b , i}} ) \qquad Formula ( XVIII )$$

P₀ [Pa] is the atmospheric pressure, set to 101325 Pa, ΔᵥₐₚH_{m,i} [J/mol] is the normal molar enthalpy of evaporation (e.g. calculated according to Formula (XIII)) of the respective sample of the carbon black feedstock, R [J/mol/K] is universal gas constant, i.e. 8.314463 J/mol/K, T [K] is system temperature or temperature of the plasma gas mixture, T_{b,i} [K] is the normal (at atmospheric pressure P₀=101325 Pa) boiling temperature of the respective sample of the carbon black feedstock, preferably the molar percent of the plasma gas is between more than x_{dilutant} and (x_{dilutant}+20 mol-%), more preferably the molar percent of the plasma gas is between (x_{dilutant}+1 mol-%) and (x_{dilutant}+15 mol-%), even more preferably the molar percent of the plasma gas is between (x_{dilutant}+3 mol-%) and (x_{dilutant}+12 mol-%), and most preferably the molar percent of the plasma gas is between (x_{dilutant}+5 mol-%) and (x_{dilutant}+10 mol-%).

Moreover, the invention is directed to the use of at least two injection means for a carbon black feedstock in a reactor for producing carbon black having a flow passage along a central longitudinal axis of the reactor to prevent the formation of droplets in a reactor (or condensation in a reactor), wherein the reactor comprises: (A) a reaction chamber, (B) injection means for supplying carbon black feedstock, and (C) means to generate a plasma in the reaction chamber thereby forming a plasma zone, wherein (i) the injection means for supplying carbon black feedstock are located upstream the plasma zone, (ii) the injection means for supplying carbon black feedstock are located at the plasma zone, but preferably after the area where the plasma is generated, and/or (iii) the injection means for supplying carbon black feedstock are located downstream the plasma zone, preferably directly behind the plasma zone.

### BRIEF DESCRIPTION OF THE DRAWINGS

The terms Fig., Figs., Figure, and Figures are used interchangeably in the specification to refer to the corresponding figures in the drawings.

FIG. 1: Reactor for the production of carbon black.

FIG. 2: Section of a swirling element in the x-z-plane

FIG. 3: Section of a swirling element in the x-y-plane

FIG. 4: Section of the tubular conduit including a feedstock lance and a swirling element connected to the outer surface of feedstock lance.

FIG. 5: Section of the tubular conduit including an inflow funnel, a feedstock lance and a swirling element connected to the outer surface of feedstock lance.

FIG. 6: Section of the tubular conduit including a feedstock lance and a swirling element connected to the inner surface of tubular conduit.

FIG. 7: Section of the tubular conduit including an inflow funnel, a feedstock lance and a swirling element connected to the inner surface of tubular conduit.

FIG. 8: Section of swirling element having two areas of constant pitches and a smooth connection.

FIG. 9: Section of swirling element having two areas of constant pitches and a sharp connection.

FIG. 10: Section of swirling element having a continuous increasing/decreasing pitch.

FIG. 11: Section of a feedstock lance containing three swirling elements having different alignments.

FIG. 12: Section of a feedstock lance containing three swirling elements having different alignments.

FIG. 13: A multiview projection of a swirling element having one vane attached to the outer surface of the feedstock lance.

FIG. 14: Section of swirling element without a feedstock lance.

### DESCRIPTION OF THE INVENTION

As mentioned above, the present invention relates to a carbon black reactor and a method for producing carbon black, preferably using the aforementioned carbon black reactor. The present invention is described with reference to the accompanying figures, which do not limit the scope and ambit of the invention.

It must be noted that, as used in the specification and the appended claims, the singular forms “a,” “an” and “the” include plural referents unless the context clearly dictates otherwise. Thus, for example, reference to “a feedstock” includes mixtures of two or more such feedstocks, and the like.

The “longitudinal axis” refers to an axis extending in the direction of the length (or longitude) of an object. The “lateral axis” refers to an axis extending in the direction of the width of an object. The “transversal axis” refers to an axis extending in the direction of the height of an object. The axes are positioned orthogonal to each other. Accordingly, the term “central longitudinal axis of the reactor” refers to the operative axis extending in the direction of the length of the carbon black reactor. The reaction chamber and the tubular conduit are arranged along the aforementioned central longitudinal axis of the reactor. The longitudinal axis of the tubular conduit and the central longitudinal axis of the reactor can be coaxial.

The term “swirl” refers to a gas flow that has a spin in or along a specific direction such as along an axis. The terms swirl and spin can be used synonymously. Thus, swirled gas flow is a directional rotary movement along an axis. The swirled gas flow according to the present invention has a spin along the central longitudinal axis of the reactor. It is evident that the swirl or spin of a gas can rotate left or right in the flow direction. Depending on the design of the swirling element, the rotation can be adjusted. However, it is desired that the swirling elements and/or vanes are designed so that the rotation of the flow is either left or right and propagates in the flow direction. The rotation axis of the gas is generally substantially coaxial or coaxial to the central longitudinal axis of the reactor or the central longitudinal axis of the tubular conduit.

A gas flow can be swirled by passing swirling elements that are capable to swirl or spin the gas flow. For instance, the swirling elements provide means to induce the aforementioned directional rotary movement along an axis of the gas flow. In the present invention the gas is a plasma gas or feedstock. The swirling elements are described in detail below.

The diameter always refers to the inner diameter of an object unless otherwise indicated. For example, the diameter of the tubular conduit refers to the inner diameter of the tubular conduit.

The invention is directed to a method for producing carbon black comprising: (a) injecting plasma gas to a carbon black reactor, (b) subjecting the plasma gas to a plasma zone (or plasma torch) to obtain a product mixture comprising carbon black, (c) quenching the product mixture, (d) separating carbon black from the product mixture, wherein (i) the plasma gas comprises or consists of a carbon black feedstock, (ii) the carbon black feedstock is injected to the plasma gas upstream the plasma zone, (iii) the carbon black feedstock is injected in the plasma zone, but preferably after the area where the plasma is generated, and/or (iv) the carbon black feedstock is injected to the plasma gas downstream the plasma zone.

Accordingly, it is possible to provide the carbon black feedstock in multiply positions in the carbon black reactor. It is important to avoid the formation of droplets in the plasma zone of the reaction chamber. The amount of carbon black feedstock (feedstock, or feedstock for carbon black) that is present in the plasma gas can have an influence of the droplet formation in the plasma zone. Accordingly, introducing the feedstock downstream the area where the plasma is generated, for instance in the plasma zone or downstream the plasma zone, can reduce the amount of carbon black feedstock that is present upstream the plasma zone. The area where the plasma is generated means the area where the excitation of the plasma gas takes place. For example, the area where the microwave radiation excites the plasma gas.

The product mixture refers to a mixture comprising the produced carbon black. Moreover, plasma gas and further pyrolysis products can be present.

The plasma zone is the area in the reaction chamber where the plasma is present or the plasma torch is present. The plasma zone can also be regarded as plasma column, plasma torch, plasma flame, plasma jet, or plasma. The size of the plasma zone can be chosen as desired. Said size can be adapted by e.g. the gas flow (plasma gas flow) and the energy input of the plasma generator. Generally, the plasma zone begins at the position where plasma gas is excited and extends downstream the reaction chamber or reactor. Accordingly, if the carbon black feedstock is injected in the plasma zone it is particularly preferred that the injection is done after the area where the plasma is generated or after the area where plasma gas is excited.

The feedstock can be introduced in one of the above-mentioned locations in the reaction chamber. However, it is desired that more than one position is used to introduce the feedstock. For example, a first carbon black feedstock is introduced upstream the plasma zone and a second carbon black feedstock is introduced downstream the area where the plasma is generated, preferably after the area where the plasma gas is excited.

A first carbon black feedstock can be injected in the plasma gas before subjecting the plasma gas to a plasma zone, and a second carbon black feedstock is injected in the plasma zone but preferably after the area where the plasma is generated.

A first carbon black feedstock can be injected in the plasma gas before subjecting the plasma gas to a plasma zone, and wherein a second carbon black feedstock injected directly after the plasma zone.

It is desired that the first and second carbon black feedstock is the same carbon black feedstock. However, it is possible that the carbon black feedstock differs from each other.

If the plasma gas is swirled before entering the reaction chamber, it is preferred that feedstock is introduced downstream the plasma zone, i.e. directly behind the plasma zone. It is believed that the swirl of the plasma gas amends the form of the plasma resulting in a backflow in the center of the plasma so that carbon black feedstock injected directly behind the plasma is dragged in the plasma.

The feedstock that is injected to the plasma gas upstream the plasma zone can be either injected by a feedstock lance that is coaxial to the central longitudinal axis of the reactor or injected by nozzles that are arranged perpendicularly to the central longitudinal axis of the reactor. The perpendicular nozzles can be circumferentially arranged in the reaction chamber. This arrangement can be used to induce a swirl of the plasma gas (plasma gas mixture).

The means to generate a plasma is not limited to specific plasma generating means so that any suitable device can be used. The plasma can be generated in response to excitation of the plasma gas by microwave energy, plasma can be generated in response to excitation of the plasma gas by an electric arc, plasma can be generated in response to excitation of the plasma gas by a corona discharge, plasma can be generated in response to excitation of the plasma gas by a dielectric-barrier discharge (DBD), and/or plasma can be generated in response to excitation of the plasma gas by radio frequency energy, preferably plasma can be generated in response to excitation of the plasma gas by microwave energy. The frequency of the microwave energy can be between 500 Mhz and 100 Ghz, preferably between 800 Mhz to 10 Ghz, more preferably 900 t Mhz o 5 Ghz, most preferably 900 Mhz to 3 Ghz.

The plasma gas can be preheated before subjecting the gas to the plasma zone (or the reaction chamber), preferably the plasma gas is preheated to a temperature between 100 to 1600° C., such as 300 to 1400° C., 400 to 1200° C., 500 to 1000° C., 600 to 1500° C., 100 to 300° C., 200 to 400° C., 300 to 500° C., 400 to 600° C., 1000 to 1500° C., or 700 to 900° C. Preheating should be applied by electrical means. A combustion of a fuel should be avoided so that the CO₂ emission can be lowered. Similarly, the carbon black feedstock can be preheated to a temperature between 100 to 600° C., such as 150 to 500° C., or 200 to 400° C. The energy source for the preheating of the carbon black feedstock and/or the plasma gas should be electrical energy, preferably electrical energy generated from a renewable source.

The plasma gas comprising the carbon black feedstock can have a temperature: (i) from 260 to 920 K, preferably 269 to 700 K, (ii) 290 to 340 K, (iii) 340 to 390 K, (iv) 390 to 440 K, (v) 440 to 490 K, (vi) 490 to 540 K, (vii) 540 to 590 K, (viii) 590 to 640 K, (ix) 640 to 690 K, or (x) 690 to 740 K.

The temperature of the plasma gas can be important so that the droplet formation of the carbon black feedstock can be avoided. Gas at a low temperature negatively affects droplet formation in the reaction chamber.

The plasma gas can comprise or can be hydrogen (H₂) and/or water (H₂O), and/or wherein the plasma gas comprises or is the carbon black feedstock. Accordingly, the plasma gas can be the carbon black feedstock. The plasma gas and the carbon black feedstock should be mixed before subjecting the gas to the plasma zone. The plasma gas can also comprise or is N₂, CO₂, and/or air. However, hydrogen (H₂) and/or water (H₂O) is the preferred plasma gas, wherein hydrogen is the most preferred plasma gas. It is particularly desired that the plasma gas is a material having a critical temperature below the temperature of the gas. The gas generally refers to the plasma gas mixture present upstream the plasma zone.

The carbon black is formed by subjecting the carbon black feedstock to the plasma, i.e. a plasma assisted carbon black production. After the formation of the carbon black, the product mixture comprising carbon black is quenched. Quenching the product mixture lowers the temperature of the product mixture. Moreover, it is possible to control the product properties by quenching the product mixture. A cooling medium such as water, a heat exchanger, and/or a quench boiler can be used.

To prevents droplets (or prevent condensation) in or before the plasma zone, a minimum dilution of materials having a critical temperature below the temperature of the gas might be necessary depending on the temperature of the gas (plasma gas, plasma gas mixture). This is of particular importance if carbon black feedstock is used that has a high boiling point or a high critical temperature. Such a carbon black feedstock tends to from droplets (condensate, or turns simply into a liquid phase) in or in proximity of the plasma zone that can damage the reactor, the reactor chamber and/or the inner lining of the reactor chamber.

The material having a critical temperature below the temperature of the gas should be present in the plasma gas including the carbon black feedstock, before subjecting the gas to the plasma zone, in a molar ratio that the carbon black feedstock does not form droplets (or does not condensate, or is not in a liquid phase) in the carbon black reactor.

Materials having a critical temperature below the temperature of the gas are not present as a liquid, i.e. they have no vapor pressure at the temperature of the gas. The gas refers to the plasma gas including the carbon black feedstock, particularly that is present upstream the plasma zone. The critical temperature of a substance is the temperature at and above which vapor of the material (or substance) cannot be liquefied, no matter how much pressure is applied. At low pressures, the material is in a gaseous phase and at high pressures the material is in a supercritical fluid phase. The critical temperature of materials or substances is disclosed in “Landolt-Bornstein, Zahlenwerte und Funktionen, 6. Aufl. Bd. 2/1, Tabelle 21116, page 328 Berlin-Heidelberg-New York: Springer 1971” or NIST Chemistry WebBook (https://webbook.nist.gov/chemistry/name-ser/).

It is particularly desired that the plasma gas is a material or comprises materials having a critical temperature below the temperature of the gas. For instance, hydrogen has a critical temperature of 33.18 K. The temperature of the plasma gas (including carbon black feedstock) has normally a temperature above 10° C., such as above 18° C., above 30° C. or above 100° C., so that hydrogen is a suitable plasma gas. Methane that can be used to produce carbon black, i.e. is considered as a feedstock material, and has a critical temperature of 190.56 K so that methane will be a material having a critical temperature below the temperature of the gas, if the gas (or plasma gas, plasma gas mixture including the carbon black feedstock) has a temperature above 190.56 K.

It is particularly desired that the plasma gas and the carbon black feedstock are mixed (plasma gas and carbon black mixture including the carbon black feedstock) before subjecting the gas to the plasma zone in a molar ratio that the carbon black feedstock does not form droplets in the carbon black reactor. The molar ratio can be calculated as described below.

Moreover, it is particularly desired that a material having a critical temperature below the temperature of the gas (i.e. of the system, of the gas mixture, and/or of the plasma gas mixture) is present in the plasma gas including the carbon black feedstock (plasma gas and carbon black mixture including the carbon black feedstock), before subjecting the gas to the plasma zone, in a molar ratio that the carbon black feedstock does not form droplets in the carbon black reactor. The molar ratio can be calculated as described below.

If it is desired that a higher amount of feedstock materials is used, additional (iii) carbon black feedstock (second carbon black feedstock) can be injected in the plasma zone, but preferably after the area where the plasma is generated, and/or (iv) carbon black feedstock is injected to the plasma gas downstream and/or behind the plasma zone. Behind can mean 1 to 50 mm behind the plasma zone or behind the plasma torch.

The desired molar ratio of the plasma gas (without the feedstock) or materials having a critical temperature below the temperature of the gas (i.e. of the system, of the gas mixture, and/or of the plasma gas mixture) can be calculated using the following Formula (V), Formula (VI), Formula (IX), and/or Formula (XVII). Particularly, the minimum molar percentage of plasma gas, plasma gas having a critical temperature below the temperature of the gas, and/or materials having a critical temperature below the temperature of the gas (preferably plasma gas having a critical temperature below the temperature of the gas) is calculated using the above-mentioned formulas.

In the following, the calculation of the necessary dilution or dilution x_{dilutant} of a carbon black feedstock and/or materials having a critical temperature above the temperature of the gas (i.e. of the system, of the gas mixture, and/or of the plasma gas mixture) is described. The necessary (or minimal) dilution x_{dilutant} is indicated as molar percentage of plasma gas and/or materials having a critical temperature below the temperature of the gas (i.e. of the system, of the gas mixture, and/or of the plasma gas mixture). In other words, generally, a specific percentage of materials having a critical temperature below the temperature of the gas is needed to avoid the condensation of materials having a critical temperature above the temperature of the gas. Materials having a critical temperature below the temperature of the gas can be the plasma gas and/or partly carbon black feedstock. Materials having a critical temperature above the temperature of the gas can be the carbon black feedstock (the first carbon black feedstock).

In the formulas for the calculation of x_{dilutant} the pressure P [Pa] as well as the temperature T can be chosen as desired. For instance, it is desired that the process is carried out at 1 atm or 101325 Pa, and 300 K.

For any pure compound (e.g. a carbon black feedstock) the vapour pressure can be estimated starting from the normal boiling point if the vapour pressure depending on the temperature is not available. For the compounds a normal evaporation entropy of 88 J/mol/K is used following the Pictet-Troutonsch rule. It is particularly preferred that for all formulas 88 J/mol/K is used for the normal evaporation entropy (molar evaporation entropy P=101325 Pa). Alternatively, the Cedenbergsche equation can be used. The term “normal” refers to the respective value at 1 atm, i.e. 101325 Pa. If the pressure is not explicitly mentioned for a calculation, it is desired to use 1 atm. Even though specific units are indicated (for e.g. the temperature and pressure), it is possible to convert units to suitable units.

Starting with the normal boiling point and the molar entropy of evaporation we obtain the normal molar enthalpy of evaporation denoted by ΔᵥₐₚHₘ by

$${Δ}_{vap} {H}_{m} = {T}_{b} {Δ}_{vap} {S}_{m} \qquad Formula ( I )$$

wherein ΔᵥₐₚHₘ [J/mol] is the normal molar enthalpy of evaporation of the carbon black feedstock, T_{b} [K] is the normal boiling point, ΔᵥₐₚSₘ [J/K/mol] is the normal molar entropy of evaporation of the carbon black feedstock. The carbon black feedstock refers to the carbon black feedstock having a critical temperature above the temperature of the gas.

The differential equation for the boiling curve can be derived from the phase equilibrium conditions following the equation of Clausius Clapyron:

$$\frac{dP}{dT} = \frac{{Δ}_{vap} {H}_{m}}{T ( {V}_{m}^{vapour} - {V}_{m}^{liquid} )} \qquad Formula ( II )$$

wherein

$$\frac{dP}{dT}$$

is the slope of the tangent to the coexistence vapour pressure curve at any point,

$$( {V}_{m}^{vapour} - {V}_{m}^{liquid} )$$

is the volume change of the phase transition between gas and liquid, ΔᵥₐₚHₘ [J/mol] is the normal molar enthalpy of evaporation (e.g. calculated according to Formula (I)).

Assuming a constant enthalpy of evaporation, neglecting the liquid volume against the molar vapor volume and assuming the ideal gas law for the molar volume of the vapor phase we obtain the vapor pressure equation:

$$\frac{{P}^{s}}{{P}_{0}} = exp ( - \frac{{Δ}_{vap} {H}_{m}}{RT} + \frac{{Δ}_{vap} {H}_{m}}{{RT}_{b}} ) \qquad Formula ( III )$$

wherein P^{s} [Pa] is the vapor pressure of the carbon black feedstock at the plasma gas temperature T [K], P₀ [Pa] is the atmospheric pressure, set to 101325 Pa, R is universal gas constant, i.e. 8.314463 J/mol/K, T [K] is system temperature or temperature of the plasma gas, T_{b} [K] is the normal boiling temperature of the carbon black feedstock. The carbon black feedstock refers to the carbon black feedstock having a critical temperature above the temperature of the gas.

The dilution x_{dilutant} in percentage is

$${x}_{dilutant} = max ( \frac{P - {P}^{s}}{P} , 0 ) \cdot 100 \qquad Formula ( IV )$$

wherein x_{dilutant} is the dilution, P^{s} [Pa] is the vapor pressure of the carbon black feedstock at the plasma gas temperature T [K], P₀ [Pa] is the atmospheric pressure, set to 101325 Pa.

Combining Formula (III) and (IV) results in the following Formula (V). The formulas (IV), (V) and (VI) have the provision that the minimum value is 0 (zero) since a negative value for the molar ratio simply means that no dilution is needed, i.e. the molar ratio is zero (indicated as max (,0)).

$${x}_{dilutant} = max ( 1 - \frac{{P}_{0} exp ( - \frac{{Δ}_{vap} {H}_{m}}{RT} + \frac{{Δ}_{vap} {H}_{m}}{{RT}_{b}} )}{P} , 0 ) \cdot 100 \qquad Formula ( V )$$

wherein x_{dilutant} is the dilution, P [Pa] is the pressure of the plasma gas mixture, P₀ [Pa] is the atmospheric pressure, set to 101325 Pa, ΔᵥₐₚHₘ [J/mol] is the normal molar enthalpy of evaporation (e.g. calculated according to Formula (I)) of the carbon black feedstock, R [J/mol/K] is universal gas constant, i.e. 8.314463 J/mol/K, T [K] is system temperature or temperature of the plasma gas mixture, T_{b} [K] is the normal (at atmospheric pressure P₀=101325 Pa) boiling temperature of the carbon black feedstock. The carbon black feedstock refers to the carbon black feedstock having a critical temperature above the temperature of the gas.

Alternatively, Formula (VI) can be used provided that x_{dilutant} is over 0, that means that the feedstock and plasma gas (or material having a critical temperature below the temperature of the gas) is selected in a way that a minimum molar ratio of the plasma gas (or material having a critical temperature below the temperature of the gas) is needed.

$${x}_{dilutant} = ( 1 - \frac{{P}_{0} exp ( - \frac{{Δ}_{vap} {H}_{m}}{RT} + \frac{{Δ}_{vap} {H}_{m}}{{RT}_{b}} )}{P} ) \cdot 100 \qquad Formula ( VI )$$

wherein x_{dilutant} is the dilution, P [Pa] is the pressure of the plasma gas mixture, P₀ [Pa] is the atmospheric pressure, set to 101325 Pa, ΔᵥₐₚHₘ [J/mol] is the normal molar enthalpy of evaporation (e.g. calculated according to Formula (I)) of the carbon black feedstock, R [J/mol/K] is universal gas constant, i.e. 8.314463 J/mol/K, T [K] is system temperature or temperature of the plasma gas mixture, T_{b} [K] is the normal (at atmospheric pressure P₀=101325 Pa) boiling temperature of the carbon black feedstock. The carbon black feedstock refers to the carbon black feedstock having a critical temperature above the temperature of the gas.

The dilution x_{dilutant} refers to the molar percent of the plasma gas, the molar percent of the plasma gas having a critical temperature below the temperature of the gas, and/or the molar percent of the materials having a critical temperature below the temperature of the gas. Preferably, the dilution x_{dilutant} refers to the molar percent of the plasma gas having a critical temperature below the temperature of the gas, and/or the molar percent of the materials having a critical temperature below the temperature of the gas. More preferably, the dilution x_{dilutant} refers to the molar percent of the plasma gas having a critical temperature below the temperature of the gas, and the molar percent of the materials having a critical temperature below the temperature of the gas. Most preferably, the dilution x_{dilutant} refers to the molar percent of the materials having a critical temperature below the temperature of the gas.

In tables 1 and 2, the dilution x_{dilutant} was calculated, wherein the minimum x_{dilutant} is zero (indicated as max (,0)). Accordingly, the values in these tables indicate the molar percentage of the plasma gas and/or materials having a critical temperature below the temperature of the gas to avoid condensation (no droplets). C3 to C23 in Table 1 refer to an aliphatic hydrocarbon having the respective number of carbons. For instance, C3 stands for C₃H₈. The normal molar evaporation enthalpy ΔᵥₐₚHₘ where calculated using the formula ΔᵥₐₚHₘ=T_{b}ΔᵥₐₚSₘ using the normal molar evaporation entropy of 88 J/mol K. The percentages where calculated using Formula (V). Each measurement or calculation refer to a specific gas temperature, such as 268.04 K, 300 K, 350 K, 400 K, 450 K, 500 K, 550 K, 600 K, 650 K, and 700 K, as indicated in the tables. In the formula, the temperature can be chosen as desired. The system pressure or the pressure of the gas/plasma gas mixture P [Pa] is 101325 Pa. The table 2 refers to aromatic feedstocks

It is possible to set the temperature T of the plasma gas for the calculation including the carbon black feedstock to the system temperature minus 10 K or 5 K so that the resulting molar percentage considers deviations of the temperature of the gas. This can be done for T in all formulas. However, T should be the temperature of the plasma gas including the carbon black feedstock.

Again, the calculated molar percentage refer to the plasma gas including the carbon black feedstock that is present upstream the plasma zone. Additional feedstock can be injected directly into the plasma zone or after the plasma zone in any suitable amount.

TABLE 1
Calculated molar percentage of the plasma gas and/or materials having a critical temperature below
the temperature of the gas necessary to avoid condensation considering different gas temperatures

| | | | T [K] | | | | | | | | | |
|---|---|---|---|---|---|---|---|---|---|---|---|---|
| | Boiling | Evaporation | 268.04 | 300 | 350 | 400 | 450 | 500 | 550 | 600 | 650 | 700 |
| | Points | enthalpy | Molar percentage of the plasma gas and/or materials | | | | | | | | | |
| | T_{b} | Δᵥₐₚ Hₘ | having a critical temperature below the temperature | | | | | | | | | |
| Aliphatic | [K] | [J/mol] | of the gas necessary to avoid condensation [mol-%] | | | | | | | | | |
| C3 | 268.04 | 20328 | 0 | 0 | 0 | 0 | 0 | 0 | 0 | 0 | 0 | 0 |
| C4 | 290.92 | 23936 | 14 | 0 | 0 | 0 | 0 | 0 | 0 | 0 | 0 | 0 |
| C5 | 313.8 | 27192 | 80 | 27 | 0 | 0 | 0 | 0 | 0 | 0 | 0 | 0 |
| C6 | 336.68 | 30096 | 95 | 77 | 0 | 0 | 0 | 0 | 0 | 0 | 0 | 0 |
| C7 | 359.56 | 32648 | 98 | 92 | 47 | 0 | 0 | 0 | 0 | 0 | 0 | 0 |
| C8 | 382.44 | 35112 | 99 | 97 | 77 | 0 | 0 | 0 | 0 | 0 | 0 | 0 |
| C9 | 405.32 | 37224 | 100 | 99 | 89 | 46 | 0 | 0 | 0 | 0 | 0 | 0 |
| C10 | 428.2 | 39336 | 100 | 99 | 95 | 71 | 0 | 0 | 0 | 0 | 0 | 0 |
| C11 | 451.08 | 41272 | 100 | 100 | 97 | 84 | 36 | 0 | 0 | 0 | 0 | 0 |
| C12 | 473.96 | 43032 | 100 | 100 | 99 | 91 | 60 | 0 | 0 | 0 | 0 | 0 |
| C13 | 496.84 | 44792 | 100 | 100 | 99 | 94 | 75 | 17 | 0 | 0 | 0 | 0 |
| C14 | 519.72 | 46376 | 100 | 100 | 100 | 97 | 84 | 44 | 0 | 0 | 0 | 0 |
| C15 | 542.6 | 47784 | 100 | 100 | 100 | 98 | 89 | 60 | 0 | 0 | 0 | 0 |
| C16 | 565.48 | 49192 | 100 | 100 | 100 | 99 | 92 | 71 | 16 | 0 | 0 | 0 |
| C17 | 588.36 | 50512 | 100 | 100 | 100 | 99 | 95 | 79 | 37 | 0 | 0 | 0 |
| C18 | 611.24 | 51744 | 100 | 100 | 100 | 99 | 96 | 84 | 52 | 0 | 0 | 0 |
| C19 | 634.12 | 52976 | 100 | 100 | 100 | 100 | 97 | 88 | 63 | 3 | 0 | 0 |
| C20 | 657 | 54208 | 100 | 100 | 100 | 100 | 98 | 91 | 72 | 25 | 0 | 0 |
| C21 | 679.88 | 55352 | 100 | 100 | 100 | 100 | 99 | 93 | 78 | 40 | 0 | 0 |
| C22 | 702.76 | 56408 | 100 | 100 | 100 | 100 | 99 | 95 | 83 | 51 | 0 | 0 |

TABLE 2
Calculated molar percentage of the plasma gas and/or materials having a critical temperature below
the temperature of the gas necessary to avoid condensation considering different gas temperatures.

| | | | T [K] | | | | | | | | | |
|---|---|---|---|---|---|---|---|---|---|---|---|---|
| | Boiling | Evaporation | 268.04 | 300 | 350 | 400 | 450 | 500 | 550 | 600 | 650 | 700 |
| | Points | enthalpy | Molar percentage of the plasma gas and/or materials | | | | | | | | | |
| | T_{b} | Δᵥₐₚ Hₘ | having a critical temperature below the temperature | | | | | | | | | |
| Aromatics | [K] | [J/mol] | of the gas necessary to avoid condensation [mol-%] | | | | | | | | | |
| C6H6 | 353 | 31064 | 97 | 85 | 9 | 0 | 0 | 0 | 0 | 0 | 0 | 0 |
| C10H10 | 491 | 43208 | 100 | 100 | 99 | 91 | 62 | 0 | 0 | 0 | 0 | 0 |
| C14H10 | 611.5 | 53812 | 100 | 100 | 100 | 100 | 98 | 91 | 69 | 18 | 0 | 0 |

Formula (V) and Formula (VI) are particularly useful for a carbon black feedstock comprising one carbon black feedstock that has a critical temperature above the temperature of the gas. For instance, the carbon black feedstock comprises several hydrocarbons having a critical temperature below the temperature of the gas and one hydrocarbon having a critical temperature above the temperature of the gas. It is desired that the calculations according to Formula (V), Formula (VI), Formula (IX) and Formula (XVII) consider the carbon black feedstock having a critical temperature above the temperature of the gas.

The plasma gas and the carbon black feedstock should be mixed before subjecting the gas to the plasma zone, wherein the molar percent of the plasma gas or the molar percent of materials having a critical temperature below the temperature of the gas (preferably the molar percent of materials having a critical temperature below the temperature of the gas) is more than x_{dilutant}, based on the total molar amount of the plasma gas including the carbon black feedstock, wherein x_{dilutant} can be calculated according to Formula (V):

$${x}_{dilutant} = max ( 1 - \frac{{P}_{0} exp ( - \frac{{Δ}_{vap} {H}_{m}}{RT} + \frac{{Δ}_{vap} {H}_{m}}{{RT}_{b}} )}{P} , 0 ) \cdot 100 \qquad Formula ( V )$$

wherein x_{dilutant} is the dilution, P [Pa] is the pressure of the plasma gas mixture, P₀ [Pa] is the atmospheric pressure, set to 101325 Pa, ΔᵥₐₚHₘ [J/mol] is the normal molar enthalpy of evaporation (e.g. calculated according to Formula (I)) of the carbon black feedstock, R [J/mol/K] is universal gas constant, i.e. 8.314463 J/mol/K, T [K] is system temperature or temperature of the plasma gas mixture, T_{b} [K] is the normal (at atmospheric pressure P₀=101325 Pa) boiling temperature of the carbon black feedstock, preferably the molar percent of the plasma gas is between more than x_{dilutant} and (x_{dilutant}+20 mol-%), more preferably the molar percent of the plasma gas is between (x_{dilutant}+1 mol-%) and (x_{dilutant}+15 mol-%), even more preferably the molar percent of the plasma gas is between (x_{dilutant}+3 mol-%) and (x_{dilutant}+12 mol-%), and most preferably the molar percent of the plasma gas is between (x_{dilutant}+5 mol-%) and (x_{dilutant}+10 mol-%). The molar percent of the plasma gas can be at least (or is) x_{dilutant}, more preferably the molar percent of the plasma gas is at least (x_{dilutant}+1 mol-%), even more preferably the molar percent of the plasma gas is at least (x_{dilutant}+3 mol-%), and most preferably the molar percent of the plasma gas is at least (x_{dilutant}+5 mol-%).

The dilution x_{dilutant} refers to the molar percent of the plasma gas, the molar percent of the plasma gas having a critical temperature below the temperature of the gas, and/or the molar percent of the materials having a critical temperature below the temperature of the gas. Preferably, the dilution x_{dilutant} refers to the molar percent of the plasma gas having a critical temperature below the temperature of the gas, and/or the molar percent of the materials having a critical temperature below the temperature of the gas. More preferably, the dilution x_{dilutant} refers to the molar percent of the plasma gas having a critical temperature below the temperature of the gas, and the molar percent of the materials having a critical temperature below the temperature of the gas. Most preferably, the dilution x_{dilutant} refers to the molar percent of the materials having a critical temperature below the temperature of the gas.

The molar percentage refers to said carbon black feedstock before subjecting the gas to the plasma zone. Generally, the plasma gas that is a material having a critical temperature below the temperature of the gas, such as hydrogen. Accordingly, the optimal molar ratio of the plasma gas (or materials having a critical temperature below the temperature of the gas) and carbon black feedstock can be utilized without the formation of droplets in or before the plasma zone. Additionally, the highest possible proportion of the carbon black feedstock is beneficial for the properties of the produced carbon black.

Accordingly, it is possible to precisely adjust the feedstock content that is present in the plasma gas. It should be noted that feedstock that is injected directly in the plasma zone or downstream the plasma zone can be injected in any suitable amount. Said feedstock can be the second carbon black feedstock. Accordingly, the first carbon black feedstock is the feedstock injected before the plasma zone.

The plasma gas and the carbon black feedstock (plasma gas and carbon black mixture) can be mixed before subjecting the gas to the plasma zone, wherein the molar percent, based on the total molar amount of the plasma gas including the carbon black feedstock, of the plasma gas and/or of the materials having a critical temperature below the temperature of the gas (at atmospheric pressure of 101325 Pa) is (i) 1 to 20 mol-% for a carbon black feedstock having a normal boiling point and/or a final normal boiling point of 270 to 300 K and a temperature of the gas mixture of from 250 to 290 K, (ii) 30 to 95 mol-% for a carbon black feedstock having a normal boiling point of more than 300 to 350 K and a temperature of the gas mixture of from 270 to 300 K, (iii) 50 to 80 mol-% for a carbon black feedstock having a normal boiling point and/or a final normal boiling point of more than 350 to 400 K and a temperature of the gas mixture of from 340 to 360 K, (iv) 50 to 75 mol-% for a carbon black feedstock having a normal boiling point and/or a final normal boiling point of more than 400 to 450 K and a temperature of the gas mixture of from 390 to 420 K, (v) 40 to 65 mol-% for a carbon black feedstock having a normal boiling point and/or a final normal boiling point of more than 450 to 500 K and a temperature of the gas mixture of from 440 to 460 K, (vi) 20 to 65 mol-% for a carbon black feedstock having a normal boiling point and/or a final normal boiling point of more than 500 to 550 K and a temperature of the gas mixture of from 490 to 520 K, (vii) 20 to 55 mol-% for a carbon black feedstock having a normal boiling point and/or a final normal boiling point of more than 550 to 610 K and a temperature of the gas mixture of from 540 to 570 K, or (viii) 30 to 65 mol-% for a carbon black feedstock having a normal boiling point and/or a final normal boiling point of more than 610 to 670 K and a temperature of the gas mixture of from 590 to 630 K. It is preferred that the plasma gas has a critical temperature that is below 270 K.

It is possible that the plasma gas consists of the carbon black feedstock, preferably of carbon black feedstock having a critical temperature below the temperature of the gas. Moreover, the feedstock can be a composition comprising many different hydrocarbons. Each hydrocarbon can have a different boiling point and/or critical temperature. For instance, the plasma gas comprises 40 wt.-% H₂, 20 wt.-% C₃H₈ and 40 wt.-% of a hydrocarbon having a critical temperature above the temperature of the gas.

Generally, the plasma gas comprising carbon black feedstock, before subjecting the gas to the plasma zone (at atmospheric pressure of 101325 Pa), (i) for a carbon black feedstock having a final normal boiling point of 270 to 300 K and a temperature of the gas mixture of from 250 to 290 K, comprises 1 mol-% to 20 mol-% of materials having a critical temperature below the temperature of the gas, (ii) for a carbon black feedstock having a final normal boiling point of more than 300 to 350 K and a temperature of the gas mixture of from 270 to 290 K, comprises 30 to 95 mol-% of materials having a critical temperature below the temperature of the gas, (iii) for a carbon black feedstock having a final normal boiling point of more than 350 to 400 K and a temperature of the gas mixture of from 340 to 360 K, comprises 50 to 80 mol-% of materials having a critical temperature below the temperature of the gas, (iv) for a carbon black feedstock having a final normal boiling point of more than 400 to 450 K and a temperature of the gas mixture of from 390° C. to 420 K, comprises 50 to 75 mol-% of materials having a critical temperature below the temperature of the gas, (v) for a carbon black feedstock having a final normal boiling point of more than 450 to 500 K and a temperature of the gas mixture of from 440 to 460 K, comprises 40 to 65 mol-% of materials having a critical temperature below the temperature of the gas, (vi) for a carbon black feedstock having a final normal boiling point of more than 500 to 550 K and a temperature of the gas mixture of from 490 to 520 K, comprises to 65 mol-% of materials having a critical temperature below the temperature of the gas, (vii) for a carbon black feedstock having a final normal boiling point of more than 550 to 610 K and a temperature of the gas mixture of from 540 to 570 K, comprises 20 to 55 mol-% of materials having a critical temperature below the temperature of the gas, or (viii) for a carbon black 20 feedstock having a final normal boiling point of more than 610 to 670 K and a temperature of the gas mixture of from 590 to 630 K, comprises 30 to 65 mol-% of materials having a critical temperature below the temperature of the gas, wherein the materials preferably comprise plasma gas, such as hydrogen, or carbon black feedstock.

If the carbon black feedstock comprises more than one hydrocarbon, it is possible to measure the final normal boiling point of the feedstock mixture and use the final normal boiling point for the calculation of x_{dilutant} in Formula (V) and Formula (VI). This is particularly useful if the carbon black feedstock comprises hydrocarbons within a narrow normal boiling point distribution, such as +/−30 K.

The boiling point of a hydrocarbon feedstock can be measured by distillation or vacuum distillation. If more than one hydrocarbon feedstock (carbon black feedstock composition) is used, a boiling curve can be measured and a “final boiling point” (or “end boiling point”) is obtained, such as measured according to ASTM D 86-04b. Generally, the final boiling point can be considered as the boiling point of the hydrocarbon with the highest boiling point in the composition or in the fraction. The normal boiling point or the final normal boiling point is the respective boiling point at 1 atm.

However, Formula (V) and Formula (VI) is preferably used for a carbon black feedstock comprising one hydrocarbon. Moreover, said hydrocarbon generally has a critical temperature above the temperature of the gas. This means that carbon black feedstock without a specific proportion of the plasma gas or materials having a critical temperature below the temperature of the gas form droplets in the reaction chamber or in proximity to the plasma zone. This also holds true for the formulas mentioned below.

For carbon black feedstock compositions, e.g. more than one carbon black feedstock (or a carbon black feedstock comprising more than one compound), such as hydrocarbons, is present, the following formulas (IX) and (XVII) should be used. Both formulas can also be used for a carbon black feedstock only comprising one hydrocarbon feedstock, i.e. only one carbon black feedstock (or a carbon black feedstock comprising one compound). Said compounds of the carbon black feedstock refers to compounds or materials having a critical temperature above the temperature of the gas. In other words, more than one material is present that has a critical temperature above the temperature of the gas.

If said carbon black feedstock mixture comprises compounds or materials that have a critical temperature above the temperature of the gas as well as a critical temperature below the temperature of the gas, only the materials or compounds that have a critical temperature above the temperature of the gas will be considered for the calculations. The materials or compounds that have a critical temperature below the temperature of the gas do not condense and can act as dilutant for the materials that have a critical temperature above the temperature of the gas. The temperature of the gas (gas mixture, plasma gas mixture) should be the minimum temperature that is present upstream the plasma zone or the zone where the plasma is generated.

For instance, the carbon black feedstock can be split in two parts. Part 1 contains all the species having a critical temperature below or equal the temperature of the mixture and part 2 contains all the species have a critical temperature above the temperature of the mixture. The part 1 are also called dilutant and part 2 noDilutant. The number of species in part 2 is denoted by N. The maximum pressure of the carbon black feedstock without a dilutant is defined as follows:

$${P}_{noDilutant} = \frac{1}{{\sum }_{i = 1}^{N} \frac{{x}_{i}^{vapour}}{100 {P}_{i}^{s}}} \qquad Formula ( VII )$$

In this equation

$${x}_{i}^{vapour}$$

denotes the molar fraction of species i in % and Pᵢ^{s} denotes the vapor pressure of the species i at the temperature of the mixture. To obtain gaseous mixture the molar fraction of the dilutant (e.g. in the mixture of part 1 and 2) has to be at least

$${x}_{dilutant} = max ( \frac{P - {P}_{noDilutant}}{P} , 0 ) \cdot 100 \qquad Formula ( VIII )$$

Combining Formula (VII) and (VIII) results in the following Formula (IX). The formulas (VIII) and (IX) have the provision that the minimum value is 0 (zero) since a negative value for the molar ratio simply means that no dilution is needed, i.e. the molar ratio is zero.

$${x}_{dilutant} = max ( 1 - \frac{1}{P {\sum }_{i = 1}^{N} \frac{{x}_{i}^{vapour}}{100 {P}_{i}^{s}}} , 0 ) \cdot 100 \qquad Formula ( IX )$$

wherein x_{dilutant} is the dilution, P [Pa] is the pressure of the plasma gas mixture, i is the respective compound in the carbon black feedstock,

$${\sum }_{i = 1}^{N}$$

is the sum from i equals 1 to N, i is the compound index of the compounds in the carbon black

$${x}_{i}^{vapour}$$

is the molar percentage of the respective compound in the carbon black feedstock,

$${P}_{i}^{s} [ Pa ]$$

is the vapor pressure of the respective compound i in the carbon black feedstock at the plasma gas temperature T [K],

$${P}_{i}^{s}$$

is calculated according to Formula (X),

$${P}_{i}^{s} = {P}_{0} exp ( - \frac{{Δ}_{vap} {H}_{m , i}}{RT} + \frac{{Δ}_{vap} {H}_{m , i}}{{RT}_{b , i}} ) \qquad Formula ( X )$$

P₀ [Pa] is the atmospheric pressure, set to 101325 Pa, ΔᵥₐₚH_{m,i} [J/mol] is the molar normal enthalpy of evaporation (e.g. calculated according to Formula (I)) of the respective compound in the carbon black feedstock, R [J/mol/K] is universal gas constant, i.e. 8.314463 J/mol/K, T [K] is system temperature or temperature of the plasma gas mixture, T_{b,i} [K] is the normal (at atmospheric pressure P₀=101325 Pa) boiling temperature of the respective compound in the carbon black feedstock. The carbon black feedstock refers to the carbon black feedstock (i.e. the compounds in the carbon black feedstock) having a critical temperature above the temperature of the gas.

In the following three exemplary mixtures are shown and the resulting dilution x_{dilutant} is calculated.

Mixture 1 comprises 10 mol.-% octane (C8H18, Tc=568 K), 30 mol.-% nonane (C9H20, Tc=594 K), 30 mol.-% dodecane (C12H26, Tc-658 K), 30 mol.-% docosane (C22, Tc=786 K). Again, the critical temperature Tc of materials or substances is disclosed in “Landolt-Bornstein, Zahlenwerte und Funktionen, 6. Aufl. Bd. 2/1, Tabelle 21116, page 328 Berlin-Heidelberg-New York: Springer 1971”.

Mixture 2 comprises 5 mol.-% C9H20, 10 mol.-% C10H22, 30 mol.-% C12H26, 20 mol.-% C14H30, 5 mol.-% C15H32, 5 mol.-% C16H34, 5 mol.-% C19H40, 20 mol.-% C22H46.

Mixture 3 comprises 15 mol.-% C10H22, 15 mol.-% C12H26, 10 mol.-% C14H30, 5 mol.-% C17H36, 5 mol.-% C18H28, 5 mol.-% C19H40, 20 mol.-% C22H46, 25 mol.-% C23H48.

In table 3 the molar percentages of the plasma gas and/or materials having a critical temperature below the temperature of the gas necessary to avoid condensation for mixtures 1 to 3 are shown. The system pressure or the pressure of the gas/plasma gas mixture P [Pa] is 101325 Pa.

For instance, mixture 3 at 550 K does only comprise carbon black feedstock or compounds (materials) in the carbon black feedstock that have critical temperatures above the temperature of the gas (i.e. 550 K). The compound or materials with the lowest critical temperature in the mixture is octane (C8H18, Tc=568 K), wherein the temperature of the gas, i.e. 550 K, is lower than the Tc of octane, i.e. 568 K. Thus, all compounds in mixture 3 is used for the calculation of the dilution x_{dilutant}. If one of the compounds or materials has a critical temperature below the temperature of the gas, this compound is not used as carbon black feedstock compound in the equations above including the molar fraction.

TABLE 3
Calculated molar percentage of the plasma gas and/or materials having
a critical temperature below the temperature of the gas necessary
to avoid condensation considering different gas temperatures

| | Molar percentage of the plasma gas and/or materials | | | | | | | | | |
|---|---|---|---|---|---|---|---|---|---|---|
| | having a critical temperature below the temperature | | | | | | | | | |
| System | of the gas necessary to avoid condensation [mol-%] | | | | | | | | | |
| temperature T [K] | 268.04 | 300 | 350 | 400 | 450 | 500 | 550 | 600 | 650 | 700 |
| Mixture 1 | 100 | 100 | 99.95 | 99.45 | 96.39 | 83.98 | 46.02 | 0 | 0 | 0 |
| Mixture 2 | 100 | 100 | 99.93 | 99.3 | 95.62 | 81.21 | 38.68 | 0 | 0 | 0 |
| Mixture 3 | 100 | 100 | 99.97 | 99.71 | 98.1 | 91.43 | 70.74 | 18.81 | 0 | 0 |

The plasma gas and the carbon black feedstock should be mixed before subjecting the gas to the plasma zone, wherein the molar percent of the plasma gas or the molar percent of materials having a critical temperature below the temperature of the gas (preferably the molar percent of materials having a critical temperature below the temperature of the gas) is more than x_{dilutant}, based on the total molar amount of the plasma gas including the carbon black feedstock, wherein x_{dilutant} can be calculated according to Formula (IX):

$${x}_{dilutant} = max ( 1 - \frac{1}{P {\sum }_{i = 1}^{N} \frac{{x}_{i}^{vapour}}{100 {P}_{i}^{s}}} , 0 ) \cdot 100 \qquad Formula ( IX )$$

wherein x_{dilutant} is the dilution, P [Pa] is the pressure of the plasma gas mixture, i is the respective compound in the carbon black feedstock (having a critical temperature above the temperature of the gas mixture),

$${\sum }_{i = 1}^{N}$$

is the sum from i equals 1 to N, i is the compound index of the compounds in the carbon black feedstock,

$${x}_{i}^{vapour}$$

is the molar percentage of the respective compound in the carbon black feedstock,

$${P}_{i}^{s} [ Pa ]$$

is the vapor pressure of the respective compound i in the carbon black feedstock at the plasma gas temperature T [K],

$${P}_{i}^{s}$$

is calculated according to Formula (X),

$${P}_{i}^{s} = {P}_{0} exp ( - \frac{{Δ}_{vap} {H}_{m , i}}{RT} + \frac{{Δ}_{vap} {H}_{m , i}}{{RT}_{b , i}} ) \qquad Formula ( X )$$

P₀ [Pa] is the atmospheric pressure, set to 101325 Pa, ΔᵥₐₚHₘᵢ [J/mol] is the molar normal enthalpy of evaporation (e.g. calculated according to Formula (I)) of the respective compound in the carbon black feedstock, R [J/mol/K] is universal gas constant, i.e. 8.314463 J/mol/K, T [K] is system temperature or temperature of the plasma gas mixture, T_{b,i} [K] is the normal (at atmospheric pressure P₀=101325 Pa) boiling temperature of the respective compound in the carbon black feedstock. The carbon black feedstock refers to the carbon black feedstock (i.e. the compounds in the carbon black feedstock) having a critical temperature above the temperature of the gas. Preferably the molar percent of the plasma gas is between more than x_{dilutant} and (x_{dilutant}+20 mol-%), more preferably the molar percent of the plasma gas is between (x_{dilutant}+1 mol-%) and (x_{dilutant}+15 mol-%), even more preferably the molar percent of the plasma gas is between (x_{dilutant}+3 mol-%) and (x_{dilutant}+12 mol-%), and most preferably the molar percent of the plasma gas is between (x_{dilutant}+5 mol-%) and (x_{dilutant}+10 mol-%). The molar percent of the plasma gas can be at least (or is) x_{dilutant}, more preferably the molar percent of the plasma gas is at least (x_{dilutant}+1 mol-%), even more preferably the molar percent of the plasma gas is at least (x_{dilutant}+3 mol-%), and most preferably the molar percent of the plasma gas is at least (x_{dilutant}+5 mol-%).

The dilution x_{dilutant} refers to the molar percent of the plasma gas, the molar percent of the plasma gas having a critical temperature below the temperature of the gas, and/or the molar percent of the materials having a critical temperature below the temperature of the gas. Preferably, the dilution x_{dilutant} refers to the molar percent of the plasma gas having a critical temperature below the temperature of the gas, and/or the molar percent of the materials having a critical temperature below the temperature of the gas. More preferably, the dilution x_{dilutant} refers to the molar percent of the plasma gas having a critical temperature below the temperature of the gas, and the molar percent of the materials having a critical temperature below the temperature of the gas. Most preferably, the dilution x_{dilutant} refers to the molar percent of the materials having a critical temperature below the temperature of the gas.

As mentioned before, Formula (XVII) can be used to calculate the dilutants x_{dilutant} for a carbon black feedstock or a carbon black feedstock mixture. Said carbon feedstock and/or carbon feedstock mixture should comprise one or more than one critical temperature above the temperature of the gas.

Formula (XVII) is particularly useful for carbon black feedstock comprising a huge amount of different materials. For instance, the carbon black feedstock comprises unknown materials.

The entire carbon black feedstock is preferably considered for the calculation. Alternatively, only carbon black feedstock materials having a critical temperature above the temperature of the gas are considered for the calculation.

In Formula (XVII) the carbon black feedstock is divided by 10 samples or 10 fractions. For each fraction or sample, it is assumed that the fraction or sample consists of one pseudo component (or material, or compound). Generally, the component with the highest boiling temperature in each sample is considered as the pseudo component for the respective sample. The samples should have the same vol.-% fraction, such as 1/10 vol.-%, of the entire carbon black feedstock. It is not necessary that carbon black feedstock sample is exactly divided in equal volume-based fraction.

An atmospheric distillation experiment accordingly to ASTM D 86-04b can be done, preferably for an unknown carbon black feedstock. If the total sample cannot be fully evaporated at atmospheric conditions (1 atm) a vacuum distillation has to be applied and recalculated to atmospheric conditions accordingly to the ASTM D 5236-03. The total mixture (e.g. 100 ml) will be separated by distillation into 10 samples/fractions (of e.g. 10 ml). The normal boiling temperature of the last drop of each sample i is determined and denoted by T_{b,i} wherein T_{b,i} is the normal boiling temperature [K] for the respective pseudo component. For each sample the mass and the molecular weight is determined. The molecular weight can be determined by the determination of the number average molecular weight using vapor-pressure osmometry (ASTM D 3592-77).

The boiling temperature of the materials mentioned herein refers to the normal boiling temperature, i.e. the boiling temperature at atmospheric pressure P=101325 Pa.

The number of moles per sample is obtained using Formula (XI).

$${n}_{i} = \frac{{m}_{i}}{{M}_{i}} \qquad Formula ( XI )$$

In this equation the number of moles of the sample i is denoted by nᵢ, the mass of the sample i is denoted by mᵢ, the molecular weight is denoted by Mᵢ, and the volume of each sample is determined.

The molar fraction of each sample is determined by

$${x}_{pseudo , i} = 100 {n}_{i} / {\sum }_{i = 1}^{10} {n}_{i} \qquad Formula ( XII )$$

For each sample a pseudo normal heat of evaporation ΔᵥₐₚH_{m,i} using a normal entropy of evaporation of

$${Δ}_{vap} {S}_{m} = 88 \frac{J}{mol K}$$

is calculated:

$${Δ}_{vap} {H}_{m , i} = {T}_{b , i} {Δ}_{vap} {S}_{m} \qquad Formula ( XIII )$$

For each sample i a pseudo vapor pressure

$${P}_{pseudo , i}^{s}$$

is calculated accordingly to

$$\frac{{P}_{pseudo , i}^{s}}{{P}_{0}} = exp ( - \frac{{Δ}_{vap} {H}_{m , i}}{RT} + \frac{{Δ}_{vap} {H}_{m , i}}{{RT}_{b , i}} ) \qquad Formula ( XIV )$$

P₀ [Pa] is the atmospheric pressure, set to 101325 Pa, ΔᵥₐₚH_{m,i} [J/mol] is the normal molar enthalpy of evaporation (e.g. calculated according to Formula (I)) of the respective sample (or fraction) of the carbon black feedstock, R [J/mol/K] is universal gas constant, i.e. 8.314463 J/mol/K, T [K] is system temperature or temperature of the plasma gas mixture, T_{b,i} [K] is the normal (at atmospheric pressure P₀=101325 Pa) boiling temperature of the respective sample (or fraction) of the carbon black feedstock.

The pseudo pressure is calculated accordingly to

$${P}_{pseudo} = \frac{1}{{\sum }_{i = 1}^{10} \frac{{x}_{pseudo , i}^{vapour}}{{P}_{pseudo , i}^{s}}} \qquad Formula ( XV )$$

The necessary molar fraction of the plasma gas in the mixture of the 10 pseudo components (preferably having a critical temperature below the temperature of the mixture) is calculated by

$${x}_{dilutant} = max ( \frac{P - {P}_{pseudo}}{P} , 0 ) \cdot 100 \qquad Formula ( XVI )$$

Combining Formula (XV) and (XVI) results in the following Formula (XVII). The formulas (XVI) and (XVII) have the provision that the minimum value is 0 (zero) since a negative value for the molar ratio simply means that no dilution is needed, i.e. the molar ratio is zero.

$${x}_{dilutant} = max ( 1 - \frac{1}{P {\sum }_{i = 1}^{10} \frac{{x}_{pseudo , i}^{vapour}}{100 {P}_{pseudo , i}^{s}}} , 0 ) \cdot 100 \qquad Formula ( XVII )$$

wherein x_{dilutant} is the dilution, P [Pa] is the pressure of the plasma gas mixture, i is the respective sample of the carbon black feedstock (preferably having a critical temperature above the temperature of the plasma gas mixture, more preferably the entire carbon black feedstock),

$${\sum }_{i = 1}^{10}$$

is the sum form i equals 1 to N, i is the compound index of the sample of the carbon black feedstock,

$${x}_{pseudo , i}^{vapour}$$

is the molar percentage of the respective sample of the carbon black feedstock,

$${P}_{pseudo , i}^{s} [ Pa ]$$

is the vapor pressure of the respective sample i of the carbon black feedstock at the plasma gas temperature T [K],

$${P}_{pseudo , i}^{s}$$

is calculated according to Formula (XVIII),

$${P}_{pseudo , i}^{s} = {P}_{0} exp ( - \frac{{Δ}_{vap} {H}_{m , i}}{R T} + \frac{{Δ}_{vap} {H}_{m , i}}{R {T}_{b , i}} ) \qquad Formula ( XVIII )$$

P₀ [Pa] is the atmospheric pressure, set to 101325 Pa, ΔᵥₐₚH_{m,i} [J/mol] is the normal molar enthalpy of evaporation (e.g. calculated according to Formula (XIII)) of the respective sample of the carbon black feedstock, R [J/mol/K] is universal gas constant, i.e. 8.314463 J/mol/K, T [K] is system temperature or temperature of the plasma gas mixture, T_{b,i} [K] is the normal (at atmospheric pressure P₀=101325 Pa) boiling temperature of the respective sample of the carbon black feedstock. The carbon black feedstock refers to the entire carbon black feedstock (i.e. the compounds in the carbon black feedstock). Alternatively, the carbon black feedstock refers to the carbon black feedstock (i.e. the compounds in the carbon black feedstock) having a critical temperature above the temperature of the gas.

It is desired that Formula (XVII) is used for calculate the desired dilution for an unknown carbon black feedstock mixture. However, it is possible to use Formula (XVII) also for said calculation for a known carbon black feedstock. Unknown carbon black feedstock refers to a carbon black feedstock that comprises a huge number of different compounds that are partly not identified. Nevertheless, it is possible to analyze every compound and the fraction in the mixture of a carbon black feedstock mixture.

The plasma gas and the carbon black feedstock are mixed before subjecting the gas to the plasma zone, wherein the molar percent of the plasma gas, the molar percent of the plasma gas having a critical temperature below the temperature of the gas, and/or the molar percent of the materials having a critical temperature below the temperature of the gas (preferably the molar percent of the plasma gas having a critical temperature below the temperature of the gas) is more than x_{dilutant}, based on the total molar amount of the plasma gas including the carbon black feedstock, wherein x_{dilutant} is calculated according to Formula (XVII):

$${x}_{dilutant} = max ( 1 - \frac{1}{P {\sum }_{i = 1}^{10} \frac{{x}_{pseudo , i}^{vapour}}{100 {P}_{pseudo , i}^{s}}} , 0 ) \cdot 100 \qquad Formula ( XVII )$$

wherein x_{dilutant} is the dilution, P [Pa] is the pressure of the plasma gas mixture, i is the respective sample of the carbon black feedstock (preferably having a critical temperature above the temperature of the plasma gas mixture, more preferably the entire carbon black feedstock),

$${\sum }_{i = 1}^{10}$$

is the sum form i equals 1 to N, is the compound index of the sample of the carbon black feedstock,

$${x}_{pseudo , i}^{vapour}$$

is the molar percentage of the respective sample of the carbon black feedstock,

$${P}_{p seudo , i}^{s} [ Pa ]$$

is the vapor pressure of the respective sample i of the carbon black feedstock at the plasma gas temperature T [K],

$${P}_{pseudo , i}^{s}$$

is calculated according to Formula (XVIII),

$${P}_{pseudo , i}^{s} = {P}_{0} exp ( - \frac{{Δ}_{vap} {H}_{m , i}}{R T} + \frac{{Δ}_{vap} {H}_{m , i}}{R {T}_{b , i}} ) \qquad Formula ( XVIII )$$

P₀ [Pa] is the atmospheric pressure, set to 101325 Pa, ΔᵥₐₚH_{m,i} [J/mol] is the normal molar enthalpy of evaporation (e.g. calculated according to Formula (XIII)) of the respective sample of the carbon black feedstock, R [J/mol/K] is universal gas constant, i.e. 8.314463 J/mol/K, T [K] is system temperature or temperature of the plasma gas mixture, T_{b,i} [K] is the normal (at atmospheric pressure P₀=101325 Pa) boiling temperature of the respective sample of the carbon black feedstock.

Preferably the molar percent of the plasma gas is between more than x_{dilutant} and (x_{dilutant}+20 mol-%), more preferably the molar percent of the plasma gas is between (x_{dilutant}+1 mol-%) and (x_{dilutant}+15 mol-%), even more preferably the molar percent of the plasma gas is between (x_{dilutant}+3 mol-%) and (x_{dilutant}+12 mol-%), and most preferably the molar percent of the plasma gas is between (x_{dilutant}+5 mol-%) and (x_{dilutant}+10 mol-%). The molar percent of the plasma gas can be at least (or is) x_{dilutant}, more preferably the molar percent of the plasma gas is at least (x_{dilutant}+1 mol-%), even more preferably the molar percent of the plasma gas is at least (x_{dilutant}+3 mol-%), and most preferably the molar percent of the plasma gas is at least (x_{dilutant}+5 mol-%). The carbon black feedstock refers to the entire carbon black feedstock (i.e. the compounds in the carbon black feedstock). Alternatively, the carbon black feedstock refers to the carbon black feedstock (i.e. the compounds in the carbon black feedstock) having a critical temperature above the temperature of the gas.

The carbon black feedstock that is mixed before subjecting the gas to the plasma zone can be analyzed by distillation of the carbon black feedstock, wherein the carbon black feedstock is separated by distillation into 10 samples/fractions and the temperature at which the last drop of each respective sample/fraction is distilled is used as the respective boiling point T_{b,i} [K] of the sample/fraction. It is desired that the 10 samples/fractions have the same molar percentage of the analyzed carbon black feedstock. Preferably, each sample comprises compounds with a similar boiling point, wherein similar refers to a boiling point of +/−20 K.

It can be suitable to use more than 10 samples or fractions. For instance, the compounds of the carbon black feedstock have a huge range of boiling points. Accordingly, the Formula can be amended in that the number of samples is 15, 20, 25, 30 or 40.

In table 4 a measured boiling curve according to ASTM D 86-04b is shown derived from an exemplary sample of a carbon black feedstock for calculating x_{dilutant} using Formula (XVII). The entire carbon black feedstock is used. The normal boiling temperature reading is the temperature of the last drop of each fraction.

TABLE 4
Distillation of an exemplary carbon black
feedstock according to ASTM D 86 - 04b.

| | normal boiling | |
|---|---|---|
| | temperature | normal boiling |
| Evaporated Point/Vol.-% | reading*¹/° C. | temperature in K |
| IBP (initial boiling point) | 184.6 | 457.75 |
| 5 | 196.5 | 469.65 |
| 10 | 210.7 | 483.85 |
| 20 | 247.5 | 520.65 |
| 30 | 279.3 | 552.45 |
| 40 | 299.7 | 572.85 |
| 50 | 313.3 | 586.45 |
| 60 | 323.5 | 596.65 |
| 70 | 331.1 | 604.25 |
| 80 | 336.5 | 609.65 |
| 90 | 339.9 | 613.05 |
| 95 | 341.3 | 614.45 |
| EP (end boiling point or | 341.8 | 614.95 |
| final boiling point) | | |

*¹particularly corrected observed temperature reading according to ASTM D 86 - 04b

During the distillation the sample is split into 10 samples each having approx. 1/10 vol.-% of the initial carbon black feedstock (carbon black feedstock mixture) (see table 5). The molecular weight was determined by the determination of the number average molecular weight using vapor-pressure osmometry (ASTM D 3592-77). The number of moles per sample was obtained using Formula (XI). The molar fraction of each sample is calculated.

TABLE 5
Calculation of the molar fraction obtained from the distillation mentioned in table 4.

| | Normal | | | | | Molar fraction | $\frac{{x}_{pseudo , i}^{vapour}}{100 {P}_{pseudo , i}^{s}} /$ |
|---|---|---|---|---|---|---|---|
| Sample | Boiling Temp/ | Enthalpy of Evaporation/ | Mass/ | Molecular Weight/ | No. of | ${x}_{pseudo , i}^{vapour} /$ | bar⁻¹ (T = 573.15 K) |
| i | K | (J/mol) | g | (g/mol) | moles | mol.- % | (P₀ = 1.01325 bar) |
| 1 | 457.75 | 42578.8 | 10 | 128 | 0.078 | 16.421 | 0.03115412 |
| 2 | 469.65 | 45817.2 | 10 | 150 | 0.066 | 13.895 | 0.05201083 |
| 3 | 483.85 | 48615.6 | 10 | 185 | 0.054 | 11.368 | 0.07655499 |
| 4 | 520.65 | 50410.8 | 10 | 213 | 0.047 | 9.895 | 0.09711397 |
| 5 | 552.45 | 51607.6 | 10 | 233 | 0.043 | 9.053 | 0.11421462 |
| 6 | 572.85 | 52505.2 | 10 | 249 | 0.040 | 8.421 | 0.1282671 |
| 7 | 586.45 | 53174 | 10 | 262 | 0.038 | 8 | 0.14021337 |
| 8 | 596.65 | 53649.2 | 10 | 271 | 0.037 | 7.789 | 0.1508393 |
| 9 | 604.25 | 53948.4 | 10 | 277 | 0.036 | 7.579 | 0.15627253 |
| 10 | 609.65 | 54071.6 | 10 | 281 | 0.036 | 7.579 | 0.16036529 |

In table 4 the pressure P₀ is 1.01325 bar instead of 101325 Pa. Accordingly,

$${\sum }_{i = 1}^{10} \frac{{x}_{pseudo , i}^{vapour}}{100 {P}_{pseudo , i}^{s}}$$

is 1.10700611 bar⁻¹ and therefore, x_{dilutant} at an operating pressure P of 1 bar and a temperature T of 573.15 K is as follows:

$${x}_{dilutant} = ( 1 - \frac{1}{1 bar 1.10700611 \frac{1}{bar}} ) 100 = 9.67 \%$$

For various system pressures and temperatures, the dilution or minimum dilution x_{dilutant} calculated in the following table.

TABLE 6
Minimal dilution of various system pressures and temperatures

T/° C.

| P/bar | 225 | 250 | 275 | 300 |
|---|---|---|---|---|
| 0.2 | 13.03 | 0 | 0 | 0 |
| 0.3 | 42.02 | 0 | 0 | 0 |
| 0.5 | 65.21 | 36.46 | 0 | 0 |
| 0.7 | 75.15 | 54.62 | 21.6 | 0 |
| 0.9 | 80.67 | 64.7 | 39.02 | 0 |
| 0.95 | 81.69 | 66.56 | 42.23 | 4.91 |
| 1 | 82.61 | 68.23 | 45.12 | 9.67 |

Accordingly, at least one of Formula (V), Formula (IX) or Formula (XVII) should be used to calculate the molar percent of the plasma gas or the molar percent of materials having a critical temperature below the temperature of the gas (preferably the molar percent of materials having a critical temperature below the temperature of the gas), based on the total molar amount of the plasma gas including the carbon black feedstock, i.e. the plasma gas before subjecting to the plasma zone. Preferably, all formulas Formula (V), Formula (IX) and Formula (XVII) are used.

In other words, the plasma gas and the carbon black feedstock are mixed before subjecting the gas to the plasma zone, wherein the molar percent of the plasma gas, the molar percent of the plasma gas having a critical temperature below the temperature of the gas, and/or the molar percent of the materials having a critical temperature below the temperature of the gas (preferably the molar percent of the plasma gas having a critical temperature below the temperature of the gas) is more than x_{dilutant}, based on the total molar amount of the plasma gas including the carbon black feedstock, wherein x_{dilutant} is calculated according to Formula (V), Formula (IX) and/or Formula (XVII),

$${x}_{dilutant} = max ( 1 - \frac{{P}_{0} exp ( - \frac{{Δ}_{vap} {H}_{m}}{R T} + \frac{{Δ}_{vap} {H}_{m}}{R {T}_{b}} )}{P} , 0 ) \cdot 100 \qquad Formula ( V )$$

wherein x_{dilutant} is the dilution, P [Pa] is the pressure of the plasma gas mixture, P₀ [Pa] is the atmospheric pressure, set to 101325 Pa, ΔᵥₐₚHₘ [J/mol] is the normal molar enthalpy of evaporation (e.g. calculated according to Formula (I)) of the carbon black feedstock, R [J/mol/K] is universal gas constant, i.e. 8.314463 J/mol/K, T [K] is system temperature or temperature of the plasma gas mixture, T_{b} [K] is the normal (at atmospheric pressure P₀=101325 Pa) boiling temperature of the carbon black feedstock,

$${x}_{dilutant} = max ( 1 - \frac{1}{P {\sum }_{i = 1}^{N} \frac{{x}_{i}^{vapour}}{100 {P}_{i}^{s}}} , 0 ) \cdot 100 \qquad Formula ( IX )$$

wherein x_{dilutant} is the dilution, P [Pa] is the pressure of the plasma gas mixture, i is the respective compound in the carbon black feedstock,

$${\sum }_{i = 1}^{N}$$

is the sum form i equals 1 to N, i is the compound index of the compounds in the carbon black feedstock,

$${x}_{i}^{vapour}$$

is the molar percentage of the respective compound in the carbon black feedstock,

$${P}_{i}^{s} [ Pa ]$$

is the vapor pressure of the respective compound i in the carbon black feedstock at the plasma gas temperature T [K],

$${P}_{i}^{s}$$

is calculated according to Formula (X),

$${P}_{i}^{s} = {P}_{0} exp ( - \frac{{Δ}_{vap} {H}_{m , i}}{RT} + \frac{{Δ}_{vap} {H}_{m , i}}{{RT}_{b , i}} ) \qquad Formula ( X )$$

P₀ [Pa] is the atmospheric pressure, set to 101325 Pa, ΔᵥₐₚHₘᵢ [J/mol] is the molar normal enthalpy of evaporation (e.g. calculated according to Formula (I)) of the respective compound in the carbon black feedstock, R [J/mol/K] is universal gas constant, i.e. 8.314463 J/mol/K, T [K] is system temperature or temperature of the plasma gas mixture, T_{b,i} [K] is the normal (at atmospheric pressure P₀=101325 Pa) boiling temperature of the respective compound in the carbon black feedstock,

$${x}_{dilutant} = max ( 1 - \frac{1}{P {\sum }_{i = 1}^{10} \frac{{x}_{pseudo , i}^{vapour}}{100 {P}_{pseudo , i}^{s}}} , 0 ) \cdot 100 \qquad Formula ( XVII )$$

wherein x_{dilutant} is the dilution, P [Pa] is the pressure of the plasma gas mixture, i is the respective sample of the carbon black feedstock,

$${\sum }_{i = 1}^{10}$$

is the sum form i equals 1 to N, i is the compound index of the sample of the carbon black feedstock,

$${x}_{pseudo , i}^{vapour}$$

is the molar percentage of the respective sample of the carbon black feedstock,

$${P}_{pseudo , i}^{s} [ Pa ]$$

is the vapor pressure of the respective sample i of the carbon black feedstock at the plasma gas temperature T [K],

$${P}_{pseudo , i}^{s}$$

is calculated according to Formula (XVIII),

$${P}_{pseudo , i}^{s} = {P}_{0} exp ( - \frac{{Δ}_{vap} {H}_{m , i}}{RT} + \frac{{Δ}_{vap} {H}_{m , i}}{{RT}_{b , i}} ) \qquad Formula ( XVIII )$$

P₀ [Pa] is the atmospheric pressure, set to 101325 Pa, ΔᵥₐₚH_{m,i} [J/mol] is the normal molar enthalpy of evaporation (e.g. calculated according to Formula (XIII)) of the respective sample of the carbon black feedstock, R [J/mol/K] is universal gas constant, i.e. 8.314463 J/mol/K, T [K] is system temperature or temperature of the plasma gas mixture, T_{b,i} [K] is the normal (at atmospheric pressure P₀=101325 Pa) boiling temperature of the respective sample of the carbon black feedstock,
   preferably the molar percent of the plasma gas is between more than x_{dilutant} and (x_{dilutant}+20 mol-%), more preferably the molar percent of the plasma gas is between (x_{dilutant}+1 mol-%) and (x_{dilutant}+15 mol-%), even more preferably the molar percent of the plasma gas is between (x_{dilutant}+3 mol-%) and (x_{dilutant}+12 mol-%), and most preferably the molar percent of the plasma gas is between (x_{dilutant}+5 mol-%) and (x_{dilutant}+10 mol-%). The molar percent of the plasma gas can be at least (or is) x_{dilutant}, more preferably the molar percent of the plasma gas is at least (x_{dilutant}+1 mol-%), even more preferably the molar percent of the plasma gas is at least (x_{dilutant}+3 mol-%), and most preferably the molar percent of the plasma gas is at least (x_{dilutant}+5 mol-%). The carbon black feedstock should refer to the carbon black feedstock (i.e. the compounds in the carbon black feedstock) having a critical temperature above the temperature of the gas. Alternatively, the carbon black feedstock refers to the entire carbon black feedstock (i.e. the compounds in the carbon black feedstock). Thus, x_{dilutant} can be calculated according to Formula (V), Formula (IX) and Formula (XVII). x_{dilutant} can be calculated according to Formula (V), Formula (IX) or Formula (XVII). x_{dilutant} can be calculated according to Formula (V), and Formula (XVII). x_{dilutant} can be calculated according to Formula (V), and Formula (IX). x_{dilutant} can be calculated according to Formula (V), or Formula (XVII). x_{dilutant} can be calculated according to Formula (V), or Formula (IX). It is generally desired that the temperature of the plasma gas is as low as possible to avoid the cleavage of C—C bonding in the carbon black feedstock.

The invention is further directed to the use of a minimum molar percentage of plasma gas, plasma gas having a critical temperature below the temperature of the gas, and/or materials having a critical temperature below the temperature of the gas (preferably plasma gas having a critical temperature below the temperature of the gas) for the production of carbon black, preferably a reactor according to the invention, preferably utilizing the method according to the invention, to prevent the formation of droplets in a reactor (or condensation in a reactor), wherein the plasma gas and the carbon black feedstock are mixed before subjecting the gas to the plasma zone, wherein the minimum molar percentage is more than x_{dilutant}, based on the total molar amount of the plasma gas including the carbon black feedstock, wherein x_{dilutant} is calculated according to Formula (V), Formula (IX) and/or Formula (XVII),

$${x}_{dilutant} = max ( 1 - \frac{{P}_{0} exp ( - \frac{{Δ}_{vap} {H}_{m}}{RT} + \frac{{Δ}_{vap} {H}_{m}}{{RT}_{b}} )}{P} , 0 ) \cdot 100 \qquad Formula ( V )$$

wherein x_{dilutant} is the dilution, P [Pa] is the pressure of the plasma gas mixture, P₀ [Pa] is the atmospheric pressure, set to 101325 Pa, ΔᵥₐₚHₘ [J/mol] is the normal molar enthalpy of evaporation (e.g. calculated according to Formula (I)) of the carbon black feedstock, R [J/mol/K] is universal gas constant, i.e. 8.314463 J/mol/K, T [K] is system temperature or temperature of the plasma gas mixture, T_{b} [K] is the normal (at atmospheric pressure P₀=101325 Pa) boiling temperature of the carbon black feedstock,

$${x}_{dilutant} = max ( 1 - \frac{1}{P {\sum }_{i = 1}^{N} \frac{{x}_{i}^{vapour}}{100 {P}_{i}^{s}}} , 0 ) \cdot 100 \qquad Formula ( IX )$$

wherein x_{dilutant} is the dilution, P [Pa] is the pressure of the plasma gas mixture, i is the respective compound in the carbon black feedstock,

$${\sum }_{i = 1}^{N}$$

is the sum from i equals 1 to N, i is the compound index of the compounds in the carbon black feedstock,

$${x}_{i}^{vapour}$$

is the molar percentage of the respective compound in the carbon black feedstock,

$${P}_{i}^{s} [ Pa ]$$

is the vapor pressure of the respective compound i in the carbon black feedstock at the plasma gas temperature T [K],

$${P}_{i}^{s}$$

is calculated according to Formula (X),

$${P}_{i}^{s} = {P}_{0} exp ( - \frac{{Δ}_{vap} {H}_{m , i}}{RT} + \frac{{Δ}_{vap} {H}_{m , i}}{{RT}_{b , i}} ) \qquad Formula ( X )$$

P₀ [Pa] is the atmospheric pressure, set to 101325 Pa, ΔᵥₐₚHₘᵢ [J/mol] is the molar normal enthalpy of evaporation (e.g. calculated according to Formula (I)) of the respective compound in the carbon black feedstock, R [J/mol/K] is universal gas constant, i.e. 8.314463 J/mol/K, T [K] is system temperature or temperature of the plasma gas mixture, T_{b,i} [K] is the normal (at atmospheric pressure P₀=101325 Pa) boiling temperature of the respective compound in the carbon black feedstock,

$${x}_{dilutant} = max ( 1 - \frac{1}{P {\sum }_{i = 1}^{10} \frac{{x}_{pseudo , i}^{vapour}}{100 {P}_{pseudo , i}^{s}}} , 0 ) \cdot 100 \qquad Formula ( XVII )$$

wherein x_{dilutant} is the dilution, P [Pa] is the pressure of the plasma gas mixture, i is the respective sample of the carbon black feedstock,

$${\sum }_{i = 1}^{10}$$

is the sum form i equals 1 to N, i is the compound index of the sample of the carbon black feedstock,

$${x}_{pseudo , i}^{vapour}$$

is the molar percentage of the respective sample of the carbon black feedstock,

$${P}_{pseudo , i}^{s} [ Pa ]$$

is the vapor pressure of the respective sample i of the carbon black feedstock at the plasma gas temperature T [K],

$${P}_{pseudo , i}^{s}$$

is calculated according to Formula (XVIII),

$${P}_{pseudo , i}^{s} = {P}_{0} exp ( - \frac{{Δ}_{vap} {H}_{m , i}}{RT} + \frac{{Δ}_{vap} {H}_{m , i}}{{RT}_{b , i}} ) \qquad Formula ( XVIII )$$

P₀ [Pa] is the atmospheric pressure, set to 101325 Pa, ΔᵥₐₚH_{m,i} [J/mol] is the normal molar enthalpy of evaporation (e.g. calculated according to Formula (XIII)) of the respective sample of the carbon black feedstock, R [J/mol/K] is universal gas constant, i.e. 8.314463 J/mol/K, T [K] is system temperature or temperature of the plasma gas mixture, T_{b,i} [K] is the normal (at atmospheric pressure P₀=101325 Pa) boiling temperature of the respective sample of the carbon black feedstock,
   preferably the molar percent of the plasma gas is between more than x_{dilutant} and (x_{dilutant}+20 mol-%), more preferably the molar percent of the plasma gas is between (x_{dilutant}+1 mol-%) and (x_{dilutant}+15 mol-%), even more preferably the molar percent of the plasma gas is between (x_{dilutant}+3 mol-%) and (x_{dilutant}+12 mol-%), and most preferably the molar percent of the plasma gas is between (x_{dilutant}+5 mol-%) and (x_{dilutant}+10 mol-%).

Said expressions in brackets such as (x_{dilutant}+20 mol-%) or (x_{dilutant}+xx mol-%) mean a x_{dilutant} plus an additional molar percentage, such as 20 mol-%. Accordingly, said expressions in brackets can be formulated without brackets.

It is also possible to provide a method that automatically and continuously adjust the molar percentage of plasma gas, plasma gas having a critical temperature below the temperature of the gas, and/or materials having a critical temperature below the temperature of the gas for the production carbon black, to the minimum molar percentage required to prevent the formation of droplets in a reactor described above.

Moreover, the invention is directed to the use of at least two injection means for a carbon black feedstock in a reactor, preferably a reactor according to the invention, for producing carbon black having a flow passage along a central longitudinal axis of the reactor, preferably according to the invention, to prevent the formation of droplets in a reactor (or condensation in a reactor), wherein the reactor comprises: (A) a reaction chamber, (B) injection means for supplying carbon black feedstock, and (C) means to generate a plasma in the reaction chamber thereby forming a plasma zone, wherein (i) the injection means for supplying carbon black feedstock are located upstream the plasma zone, (ii) the injection means for supplying carbon black feedstock are located at the plasma zone, but preferably after the area where the plasma is generated, and/or (iii) the injection means for supplying carbon black feedstock are located downstream the plasma zone, preferably directly behind the plasma zone.

The at least two injection means should be (i) the injection means for supplying carbon black feedstock that are located upstream the plasma zone and (ii) the injection means for supplying carbon black feedstock that are located at the plasma zone, but preferably after the area where the plasma is generated.

The pressure in the plasma zone and/or the pressure of the plasma gas in the plasma zone is 0.1 to 1.3 bar, such as 0.1 to 1.2 bar, 0.1 to 1.1 bar, 0.1 to 1 bar, 0.2 to 1 bar, 0.2 to below 1 bar, 0.1 to 0.5 bar, 0.2 to 0.9 bar, 0.3 to 0.8 bar, or 0.3 to 0.5 bar, wherein preferably the pressure upstream the plasma zone and/or the pressure of the plasma gas upstream the plasma zone is higher than the pressure in the plasma zone and/or the pressure of the plasma gas in the plasma zone. At a pressure below 0.3 bar it is likely that acetylene is obtained as an intermediate to produce carbon black. Acetylene has an influence on the produced carbon black so that it is desired that either the pressure in the plasma zone and/or the pressure of the plasma gas in the plasma zone is below 0.3 bar or above 0.3 bar. The reaction time for the formation of carbon black is very short in a plasma assisted production. Reducing the pressure is beneficial for uniform properties of the produced carbon black.

The pressure upstream the plasma zone and/or the pressure of the plasma gas upstream the plasma zone can be 0.1 to 3 bar, such as 0.2 to 2.6 bar, 0.5 to 2.5 bar, 0.9 to 2.2 bar, 1 to 2 bar, 1.5 to 2 bar, 1.6 to 3 bar, 1 bar to 1.5 bar, or 1.1 to 1.4 bar, wherein preferably the pressure upstream the plasma zone and/or the pressure of the plasma gas upstream the plasma zone is higher than the pressure in the plasma zone and/or the pressure of the plasma gas in the plasma zone.

The pressure in the reaction chamber can be simply reduced using a pump or a Laval nozzle can be used. The reaction chamber can be designed as a Laval nozzle so that the gas flows at a speed below 1 Ma before the narrowed portion of the Laval nozzle, at a speed of 1 Ma in the narrowed portion of the Laval nozzle and at a speed above 1 Ma after the narrowed portion of the Laval nozzle, wherein the plasma is generated in the narrowed portion of the Laval nozzle. The reaction chamber can be designed as a Laval nozzle, wherein the plasma is generated in the narrowed portion of the Laval nozzle.

The reaction chamber can be designed as a Laval nozzle so that the gas flow has a speed below 1 Ma before the narrowed portion of the Laval nozzle, a speed of below 1 Ma in the narrowed portion of the Laval nozzle and a speed below 1 Ma after the narrowed portion of the Laval nozzle, wherein the plasma is generated in the narrowed portion of the Laval nozzle, wherein the gas flow speed in the narrowed portion is higher as before the narrowed portion and the gas flow speed after the narrowed portion is higher as in the narrowed portion.

To ensure a homogenous mixing of the plasma gas and the feedstock, it is desired to provide swirl to the plasma gas. Additionally, the swirl can be used at the same time to stabilize the plasma. Thus, the plasma gas, before subjecting the gas to the plasma zone, can be swirled, preferably the plasma gas has a swirl number between 0.2 and 1.2, preferably 0.3 to 0.8, more preferably 0.5 to 0.7, even more preferably 0.55 to 0.65. Generally, the swirl intensity is a measure of the angular momentum of the gas. It is characterized by the swirl number, S, defined as the ratio of the axial flux of angular momentum to the axial flux of axial momentum (Gupta et al., 1984).

The swirl can be introduced using a swirling element. The swirling element can comprise vanes to produce the swirl or the plasma gas and/or carbon black feedstock is injected tangential, e.g. one or more tangential inlets. For a tangential injection of the plasma gas and/or carbon black feedstock it is desired that the injection is done in a tubular conduit, particularly a tubular conduit connected to the reaction chamber. It is particularly preferred that the swirl is introduced upstream the plasma zone.

The plasma can be generated in response to excitation of the plasma gas by microwave energy and thereby generating a plasma zone, wherein the microwave radiation is applied perpendicular to the central longitudinal axis of the reactor or the flow direction of the plasma gas, and/or the microwave radiation is applied radially and circumferentially to the central longitudinal axis of the reactor or the flow direction of the plasma gas. It is desired that the perpendicular microwave radiation is applied from one direction.

It is also possible to inject H₂O, and/or it is possible that silica is injected to the product mixture after (downstream) the plasma zone. It is preferred that H₂O is injected upstream the plasma zone. H₂O and/or silica can adapt the surface properties of the produced carbon black.

The temperature in the plasma zone can be between 1200 and 5000 K, such as 1300 to 4000 K, 1300 to 3000 K, 1400 to 3500 K, 1300 to 2500 K, 1300 to 2000 K, 1300 to 1800 K, or 1500 to 3000 K. The temperature generally refers to the temperature of the plasma.

The carbon black feedstock can be any suitable feedstock for the production of carbon black. For instance, the carbon black feedstock is a liquid, preferably at 23° C. and 1 atm. The carbon black feedstock can comprise non-aromatic feedstock, an aromatic feedstock, aliphatic feedstock, aliphatic oil, sustainable feedstock, renewable carbon black feedstock and/or a bio-based feedstock. Said feedstock refers to the first and/or second carbon black feedstock.

Sustainable carbon black feedstocks (i.e. feedstock for carbon black), such as aliphatic oils, renewable carbon black feedstocks and biomass-based feedstocks, have a high content of aliphatic C—C bonding and a low content of aromatic C—C bonding. The aliphatic C—C bonding is weak in comparison to the C—H bonding or aromatic C—C bonding. Hence, predominantly the C—C bonding of sustainable carbon black feedstocks is destroyed where the C—H bonding scission is preferred to obtain unsaturated species for the formation of carbon black.

The carbon black feedstock (i.e. feedstock for carbon black) can be or can comprise a non-aromatic feedstock, an aromatic feedstock, aliphatic feedstock, aliphatic oil, sustainable feedstock, renewable carbon black feedstock and/or a bio-based feedstock. Accordingly, the carbon black feedstock is not limited to renewable carbon black feedstock, sustainable feedstock and/or a bio-based feedstock.

Preferably the aliphatic feedstock comprises aliphatic materials in a high amount such as 20 to 100 wt.-%, such as 40 to 100 wt.-%, 50 to 99 wt.-%, 60 to 95 wt.-%, or 80 to 90 wt.-%, of the feedstock for carbon black is derived from aliphatic feedstock, based on the total weight of the feedstock for carbon black. Sustainable feedstock, renewable carbon black feedstock and/or a bio-based feedstock often comprise a high content of aliphatic feedstock as mentioned above.

Sustainable carbon black feedstocks refer to feedstocks that have generally a high content of aliphatic C—C bonding and preferably a low content of aromatic C—C bonding. Sustainable carbon black feedstocks can include aliphatic oils, renewable carbon black feedstock, and biomass-based feedstocks. Biomass-based feedstocks, sustainable carbon black and/or renewable carbon black feedstock can be distinguished from fossil-based feedstock by measuring the C14 content in the feedstock (Radiocarbon dating). The relative amount of C14 atoms compared to C12 (C14 to C12 ratio) is lower in fossil-based feedstock in comparison to biomass-based feedstocks.

Preferably, the carbon black feedstock is renewable carbon black feedstock. The renewable carbon black feedstock can comprise a plant-based feedstock, preferably a non-edible plant-based feedstock and/or a waste plant-based feedstock. As used herein, the term “non-edible” refers to materials that are not suitable for human consumption. The term “waste” refers to materials that are discarded or disposed of as unsuitable or no longer useful for the intended purpose, e.g., after use. With respect to edible oils, i.e., cooking oils, used cooking oils are considered waste.

The renewable carbon black feedstock may comprise solid components and/or liquid components. Preferably, the renewable carbon black feedstock may comprise liquid components.

The renewable carbon black feedstock preferably may comprise plant-based oils and more preferably non-edible plant-based oils and/or waste plant-based oils.

The renewable carbon black feedstock according to the present invention may comprise wood, grass, cellulose, hemicellulose, lignin, waste material comprising natural rubber and/or synthetic rubber obtained from a renewable source material, black liquor, tall oil, rubber seed oil, tobacco seed oil, castor oil, pongamia oil, crambe oil, neem oil, apricot kernel oil, rice bran oil, cashew nut shell oil, Cyperus esculentus oil, cooking oil, distillation residues from biodiesel plants or a mixture or combination of any of the foregoing.

As used herein, the term “wood” refers to porous and fibrous structural tissue found in the stems and roots of trees and other woody plants. Suitable examples of wood include, but are not limited to, pine, spruce, larch, juniper, ash, hornbeam, birch, alder, beech, oak, pines, chestnut, mulberry or mixtures thereof. Suitable examples of grass include, but are not limited to, cereal grass, such as maize, wheat, rice, barley or millet; bamboos and grass of natural grassland and species cultivated in lawns and pasture. Suitable examples of lignin may include, but are not limited to, lignin removed by Kraft process and lignosulfonates. Waste materials comprising natural rubber and/or synthetic rubber obtained from a renewable source material may be tires, cable sheaths, tubes, conveyor belts, shoe soles, hoses or mixtures thereof. Natural rubber may be derived from rubber trees (Helvea brasiliensis), guayule, and dandelion. Synthetic rubber may include styrene-butadiene rubber such as emulsion-styrene-butadiene rubber (ESBR) and solution-styrene-butadiene rubber (SSBR), polybutadiene, polyisoprene, ethylene-propylene-diene rubber (EPDM), ethylene-propylene rubber (EPM), butyl rubber, halogenated butyl rubber, chlorinated polyethylene, chlorosulfonated polyethylene, acrylonitrile-butadiene rubber, hydrogenated acrylonitrile-butadiene rubber, polychloroprene, acrylate rubber, ethylene-vinylacetate rubber, ethylene-acrylic rubber, epichlorohydrin rubber, silicone rubber, fluorosilicone rubber, fluorocarbon rubber or a mixture or combinations of any of the foregoing. Synthetic rubber, such as polybutadiene, may be produced from alcohol obtained through fermentation of plant biomass. Suitable preparation of alcohol obtained through fermentation and preparation of polybutadiene from such alcohol is described in EP 2 868 697 A1.

As used herein, the term “cooking oil” refers to edible oils used in food preparation, such as in frying, baking and other types of cooking. According to the present invention, cooking oils may comprise rice bran oil, rapeseed oil, linseed oil, palm oil, coconut oil, canola oil, soybean oil, sunflower oil, cotton seed oil, pine seed oil, olive oil, corn oil, grape seed oil, safflower oil, acai palm oil, jambu oil, sesame oil, chia seed oil, hemp oil, perilla oil, peanut oil, stillingia oil, cashew nut oil, brazil nut oil, macadamia nut oil, walnut oil, almond oil, hazel nut oil, beechnut oil, candlenut oil, chestnut oil or a mixture or combination of any of the foregoing. The cooking oil of the present invention may be used cooking oil. As used herein, the term “used cooking oil” refers to oils originating from commercial or industrial food processing operations, such as restaurants, that have been used for food preparation, such as cooking or frying.

Solid components may be selected from, but are not limited to, wood, grass, cellulose, hemicellulose, lignin, waste material comprising natural rubber and/or synthetic rubber obtained from a renewable source material or a mixture or combination of any of the foregoing.

Liquid components may be selected from, but are not limited to, black liquor, tall oil, rubber seed oil, tobacco seed oil, castor oil, pongamia oil, crambe oil, neem oil, apricot kernel oil, rice bran oil, cashew nut shell oil, Cyperus esculentus oil, cooking oil, distillation residues from biodiesel plants or a mixture or combination of any of the foregoing. Some oils may be solid at room temperature, e.g., at temperatures of 25° C., but liquid at elevated temperatures, such as temperatures above 25° C., e.g., temperatures in a range of 25 to 100° C. As used herein, the term “black liquor” refers to a by-product from the Kraft process which comes from the sulfate and soda processes of making cellulosic pulp.

Non-edible plant-based feedstock may comprise, but is not limited to, wood, cellulose, hemicellulose, lignin, black liquor, tall oil, rubber seed oil, tobacco seed oil, castor oil, pongamia oil, crambe oil, neem oil, apricot kernel oil, rice bran oil, cashew nut shell oil, Cyperus esculentus oil, distillation residues from biodiesel plants, waste materials comprising natural rubber and/or synthetic rubber obtained from a renewable source material or a mixture or combination of any of the foregoing.

Waste plant-based feedstock may comprise, but is not limited to, waste material comprising natural rubber and/or synthetic rubber obtained from a renewable source material, used cooking oils or a mixture or combination of any of the foregoing.

The carbon black feedstock may comprise tall oil. The terms “tall oil” and “crude tall oil” may be used interchangeably throughout this description unless otherwise stated. Tall oil is derived from the chemical pulping of woods. Typically, tall oil is a mixture comprising resin acids, fatty acids, sterols, alcohols and further alkyl hydrocarbon derivatives. Tall oil may be a natural unrefined product or a refined product. Refined tall oil may include tall oil fatty acid, tall oil fatty rosin, distilled tall oil and tall oil pitch. Tall oil can be distilled to obtain tall oil resin acids containing more than 10 wt.-% of resin acid content. Tall oil may also be refined to tall oil fatty acids, where the resin acid content is typically less than 10 wt.-%. Suitable examples of tall oil may include, but are not limited to, SYLFAT™ products, SYLVATAL™ products, SYLVABLEND™ products and SYLVAROS™ products, all available from Kraton Corporation (USA), as well as tall oil products, such as crude tall oils and Tall Oil 1, available from UCY Energy (Germany).

The carbon black feedstock (i.e. feedstock for carbon black) may in particular comprise tall oil pitch. Tall oil pitch is obtained as a nonvolatile residue from refining by distillation of tall oil and may be mixed with fore-runs of tall oil refining. The yield of tall oil pitch in the refining process may range from about 15 to 50 wt.-%, depending for example on the quality and composition of the tall oil. Tall oil pitch typically comprises neutral substances, free acids including resin acids and fatty acids, fatty acid esters, bound and free sterols, and polymeric compounds. Additionally, metals, metal cations, inorganic and organic compounds including metal resinates and salts of fatty acids can be found in tall oil pitch. Said metal cations typically originate from wood and fertilizers. Suitable examples of tall oil pitch include, but are not limited to, SYLVABLEND™ products, such as SYLVABLEND FA7002, SYLVABLEND PF 40, SYLVABLEND PF 60 and SYLVABLEND SF75 all available from Kraton Corporation (USA) as well as Tall Oil 1, UCY-TOF40 and UCY-TOF60 all available from UCY Energy (Germany).

According to the present invention, the carbon black feedstock (i.e. feedstock for carbon black) can be a mixture of renewable carbon black feedstock and conventional carbon black feedstock. Conventional carbon black feedstock may be aliphatic or aromatic, saturated or unsaturated hydrocarbons or mixtures thereof, coal tar distillates, residual oils which are produced during the catalytic cracking of petroleum fractions, residual oils which are produced during olefin production through cracking of naphta or gas oil, natural gas or a mixture or combination of any of the foregoing. Accordingly, the carbon black feedstock is not limited to a specific feedstock material. The carbon black feedstock can be a liquid, a solid as well as a gas. It is preferred that the carbon black feedstock is a liquid or gas. Liquid means in this case that the feedstock is in the liquid form at standard temperature and normal pressure (T=296.15 K and P 101325 Pa). For instance, gaseous carbon black feedstock can be an aliphatic feedstock, such as methane, ethane, acetylene, ethylene, ethane, propyne, propane propene, butadiene, butane, pentane, or a mixture thereof.

The carbon black feedstock (i.e. feedstock for carbon black) of the present invention may comprise the renewable carbon black feedstock in an amount greater than or equal to 10 wt. % based on the total weight of the carbon black feedstock. For example, the carbon black feedstock according to the present invention can comprise the renewable carbon black feedstock in an amount greater than or equal to 15 wt. %, or in an amount greater than or equal to 20 wt. %, or in an amount greater than or equal to 25 wt. %, or in an amount greater than or equal to 30 wt. %, or in an amount greater than or equal to 35 wt. %, or in an amount greater than or equal to 40 wt. %, or in an amount greater than or equal to 45 wt. %, or in an amount greater than or equal to 50 wt. %, or in an amount greater than or equal to 55 wt. %, or in an amount greater than or equal to 60 wt. %, or in an amount greater than or equal to 65 wt. %, or in an amount greater than or equal to 70 wt. %, or in an amount greater than or equal to 75 wt. %, or in an amount greater than or equal to 80 wt. %, or in an amount greater than or equal to 85 wt. %, or in an amount greater than or equal to 90 wt. %, or in an amount greater than or equal to 95 wt. %, the weight percentage being based on the total weight of the carbon black feedstock. The carbon black feedstock may comprise the renewable carbon black feedstock in an amount greater than or equal to 10 wt.-%, preferably greater than or equal to 15 wt.-%, particularly preferably greater than or equal to 25 wt.-%, more preferably greater than or equal to 50 wt.-%, even more preferably greater than or equal to 85 wt.-%, most preferably greater than or equal to 99 wt.-%, the weight percent being based on the total weight of the carbon black feedstock. The carbon black feedstock can consist of the renewable carbon black feedstock.

The carbon black feedstock (i.e. feedstock for carbon black) of the present invention may comprise tall oil pitch in an amount of greater than or equal to 5 wt.-%, such as greater than or equal to 10 wt.-%, or greater than or equal to 15 wt.-%, or greater than or equal to 20 wt.-%, or greater than or equal to 25 wt.-%, or greater than or equal to 30 wt.-%, or greater than or equal to 35 wt.-%, greater than or equal to 40 wt.-%, or greater than or equal to 45 wt.-%, or greater than or equal to 50 wt.-%, or greater than or equal to 55 wt.-%, or greater than or equal to 60 wt.-%, or greater than or equal to 65 wt.-%, or greater than or equal to 70 wt.-%, or greater than or equal to 75 wt.-%, or greater than or equal to 80 wt.-%, or greater than or equal to 85 wt.-%, or greater than or equal to 90 wt.-%, or greater than or equal to 95 wt.-%, the weight percent being based on the total weight of the carbon black feedstock. The carbon black feedstock may comprise tall oil pitch in an amount greater than or equal to 10 wt.-%, preferably greater than or equal to 15 wt.-%, particularly preferably greater than or equal to 25 wt.-%, more preferably greater than or equal to 50 wt.-%, even more preferably greater than or equal to 85 wt.-%, most preferably greater than or equal to 95 wt.-%, the weight percent being based on the total weight of the carbon black feedstock. The carbon black feedstock can consist of tall oil pitch.

The renewable carbon black feedstock of the present invention may comprise tall oil pitch in an amount of greater than or equal to 5 wt.-%, such as greater than or equal to 10 wt.-%, or greater than or equal to 15 wt.-%, or greater than or equal to 20 wt.-%, or greater than or equal to 25 wt.-%, or greater than or equal to 30 wt.-%, or greater than or equal to 35 wt.-%, or greater than or equal to 40 wt.-%, or greater than or equal to 45 wt.-%, or greater than or equal to 50 wt.-%, or greater than or equal to 55 wt.-%, or greater than or equal to 60 wt.-%, or greater than or equal to 65 wt.-%, or greater than or equal to 70 wt.-%, or greater than or equal to 75 wt.-%, or greater than or equal to 80 wt.-%, or greater than or equal to 85 wt.-%, or greater than or equal to 90 wt.-%, or greater than or equal to 95 wt.-%, the weight percent being based on the total weight of the renewable carbon black feedstock. The renewable carbon black feedstock may comprise tall oil pitch in an amount greater than or equal to 10 wt.-%, preferably greater than or equal to 15 wt.-%, particularly preferably greater than or equal to 25 wt.-%, more preferably greater than or equal to 50 wt.-%, even more preferably greater than or equal to 85 wt.-%, most preferably greater than or equal to 95 wt.-%, the weight percent being based on the total weight of the renewable carbon black feedstock. The renewable carbon black feedstock may consist of tall oil pitch.

The carbon black of the present invention can have a pMC (percent of modern carbon) of 1% or more, determined according to ASTM D6866-20 Methode B (AMS), such as 2% or more, or 5% or more, or 7% or more, or 10% or more, or 12% or more, or 15% or more, or 17% or more, or 20% or more, or 22% or more, or 25% or more, or 27% or more, or 30% or more, or 32% or more, or 35% or more, or 37% or more, or 40% or more, or 42% or more, or 45% or more, or 47% or more, or 50% or more, or 52% or more, or 55% or more, or 57% or more, or 60% or more, or 62% or more, 65% or more, or 67% or more, or 70% or more, or 72% or more, or 75% or more, or 77% or more, or 80% or more, or 82% or more, or 85% or more, or 87% or more, or 90% or more, or 92% or more, or 95% or more, or 97% or more, or 99% or more. For each sample, a ratio of ¹⁴C/¹²C is calculated and compared to measurements made on Oxalic Acid II standard (NIST-4990C). The measured values (pMC) are corrected by d13C measured using an isotope ratio mass spectrometer (IRMS). The carbon black of the present invention can have a pMC (percent of modern carbon) of 5% or more, determined according to ASTM D6866-20 Methode B (AMS), preferably of 10% or more, particularly preferably of 15% or more, more preferably of 50% or more, even more preferably of 85% or more, most preferably of 90% or more. The carbon black of the present invention can have a pMC (percent of modern carbon) of 100%, determined according to ASTM D6866-20 Methode B (AMS).

Generally, 60 to 100 wt.-%, preferably 90 to 100 wt.-%, more preferably 97 to 100 wt.-%, even more preferably 99 to 100 wt.-% and most preferably 99.9 to 100 wt.-% of the carbon black feedstock comprises compounds comprising at least 5 carbon atoms. It is also possible that the entire carbon black feedstock comprises compounds comprising at least 5 carbon atoms.

The carbon black feedstock can be derived from biomethane. Preferably the carbon black feedstock comprises 45 to 75 vol.-% of methane, 25 to 55 vol.-% CO₂, 0 to 10 vol.-% of H₂O, 0.01 to 5 vol.-% of N₂, 0.01 to 2 vol.-% of 02, 0 to 1 vol.-% of H₂.

As mentioned above, the plasma gas can comprise or can be hydrogen and/or water, or the plasma gas comprises or is the carbon black feedstock. Preferably, the plasma gas comprises or is hydrogen and is derived from the pyrolysis of the carbon black feedstock.

The hydrogen as plasma gas increases the level of H radicals and/or H+ Ions and thus, increases the yield of carbon black. The aliphatic C—C bonding is weak in comparison to the C—H bonding or aromatic C—C bonding. Hence, predominantly the C—C bonding is destroyed where the C—H bonding scission is preferred to obtain unsaturated species for the formation of carbon black. A high level of H radicals and/or H+ Ions can accelerate C—H scission by a bi or tri molecular reaction using hydrogen as plasma gas. This can result to higher yields and uniform characteristics of the carbon black. This is particularly useful for sustainable carbon black materials.

The method can further comprise separating carbon black and H₂ present in the product mixture, and/or providing the separated H₂ as the plasma supply gas. Reusing the produced H₂ leads to an environmentally friendly process. Moreover, CO, CO₂, H₂O can also be separate from the product mixture.

The plasma supply gas or the hot plasma supply gas should not be heated by the combustion of a fuel. Accordingly, the emission of CO₂ can be reduced. It is preferred that the preheating is only done by using electricity and/or waste heat from the production of carbon black or other processes.

The produced carbon black can have (a) a STSA surface area determined according to ASTM D6556-17 in a range from 40 to 140 m²/g, preferably from 60 to 130 m²/g, more preferably 65 to 120 m²/g, and an oil absorption number (OAN) measured according to ASTM D2414-18 in a range from 40 to 200 mL/100 g, preferably from 60 to 180 mL/100 g, more preferably from 80 to 160 mL/100 g, (b) a STSA surface area determined according to ASTM D6556-17 in a range from 40 to 120 m²/g, preferably from 50 to 100 m²/g, more preferably 65 to 90 m²/g, and an oil absorption number (OAN) measured according to ASTM D2414-18 in a range from 40 to 180 mL/100 g, preferably from 50 to 160 mL/100 g, more preferably from 70 to 150 mL/100 g, (c) a STSA surface area determined according to ASTM D6556-17 in a range from 200 to 600 m²/g, preferably from 250 to 500 m²/g, more preferably 300 to 450 m²/g, and an oil absorption number (OAN) measured according to ASTM D2414-18 in a range from 50 to 150 mL/100 g, preferably from 60 to 120 mL/100 g, more preferably from 70 to 100 mL/100 g, and/or (d) a STSA surface area determined according to ASTM D6556-17 in a range from 140 to 210 m²/g, preferably from 150 to 200 m²/g, more preferably 160 to 190 m²/g, and an oil absorption number (OAN) measured according to ASTM D2414-18 in a range from 100 to 200 mL/100 g, preferably from 110 to 170 mL/100 g, more preferably from 120 to 160 mL/100 g.

The plasma gas flow (preferably the hydrogen gas flow) can be 10 Nm³/h to 10000 Nm³/h, such as 20 Nm³/h to 5000 Nm³/h, 30 Nm³/h to 2000 Nm³/h, 40 Nm³/h to 1000 Nm³/h, or 50 Nm³/h to 500 Nm³/h. Preferably, the gas flow is 40 Nm³/h to 1000 Nm³/h and most preferably the gas flow is 50 Nm³/h to 500 Nm³/h. The desired flow has an influence on the plasma zone. Plasma zone means the zone where the plasma is present. The plasma zone can be enlarged by reducing the gas flow, preferably if a microwave plasma is used. Similarly, the plasma can be adjusted by the power of the plasma generator.

Furthermore a reactor for producing carbon black having a flow passage along a central longitudinal axis of the reactor is provided that comprises: (A) a reaction chamber, (B) injection means for supplying carbon black feedstock, and (C) means to generate a plasma in the reaction chamber thereby forming a plasma zone, wherein (i) the injection means for supplying carbon black feedstock are located upstream the plasma zone, (ii) the injection means for supplying carbon black feedstock are located at the plasma zone, but preferably after the area where the plasma is generated, and/or (iii) the injection means for supplying carbon black feedstock are located downstream the plasma zone, preferably directly behind the plasma zone.

As described for the method, the reactor can comprise one or more injection means for the feedstock. It is preferred that at least one injection means is located upstream the plasma zone and one injection means is located downstream the reaction zone.

Preferably reaction chamber is designed as a Laval nozzle, comprising a narrowed portion in which the plasma is generated. Using a Laval nozzle has the advantage that the pressure can be reduced for the production of carbon black at a precise position. The reaction chamber can also be a tubular conduit.

The means to generate a plasma is an arc plasma generator, a microwave plasma generator, a corona discharge plasma generator, or a dielectric-barrier discharge (DBD) plasma generator, or a radiofrequency (RF) plasma generator, preferably a microwave plasma generator. The plasma generators are generally located outside the reaction chamber. The RF plasma generator and the microwave plasma generator are generally located outside the reaction chamber. The type of plasma as well as the plasma generator is not limited to a specific type.

The means to generate a plasma is preferably a microwave plasma generator. The microwave plasma generator should comprise a magnetron and a resonator. Moreover, the microwave plasma generator can comprise a magnetron, a circulator, a coupler, a tuner, a waveguide, such as a tapered waveguide, and a resonator. The microwave plasma generator can comprise a ring resonator circumferentially attached to the reaction chamber.

The microwave plasma generator can comprise a waveguide and a resonator so that the microwave energy is applied perpendicularly to the plasma gas with respect to the central longitudinal axis of the reaction chamber.

The injection means for supplying carbon black feedstock should be located upstream the plasma zone and is a feedstock lance arranged coaxial to the central longitudinal axis of the reactor. The injection means for supplying carbon black feedstock can be located upstream the plasma zone and is a feedstock lance arranged coaxial to the central longitudinal axis of the reactor and the injection means for supplying carbon black feedstock are located at the plasma zone, but preferably after the area where the plasma is generated.

The inner lining of the reaction chamber comprises aluminum oxide, preferably the inner lining of the reaction chamber in the area of the plasma zone comprises aluminum oxide, preferably 90 to 100 wt.-% of aluminum oxide, more preferably 95 to 100 wt.-% of aluminum oxide, most preferably 98 to 100 wt.-% of aluminum oxide. Aluminium oxide can withstand high temperatures so that the production of carbon black can be done using high temperatures.

The reactor can further comprise a swirling element that is able to swirl the plasma gas and wherein the swirling element is attached upstream to the reaction chamber. The swirling element can comprise vanes to induce the swirl to the plasma gas or can comprise injection means that allow a tangential injection of the carbon black feedstock or the plasma gas. Preferably the swirling element is present in a tubular conduit.

The reactor can further comprise a flow guide means connected upstream to the reaction chamber or upstream to the swirling element, wherein the flow guide means is able to receive the plasma gas and cause the plasma gas to flow parallel to the central longitudinal axis of the reactor/reaction chamber. The flow guide means can comprise a cylindrical body comprising openings in the wall of the cylindrical body that are substantially orthogonal, preferably orthogonal, to the central longitudinal axis of the reactor and the cylindrical body is in connection with the tubular conduit and positioned along the central longitudinal axis of the reactor.

The feedstock injection means should be a feedstock lance and extending through a tubular conduit with a gap between the inner surface of the conduit and the outer surface of the feedstock lance defining a passageway for the plasma gas, wherein preferably the feedstock lance being arranged along the central longitudinal axis of the reactor, or wherein the injection means is a lance and extending through the tubular conduit with a gap between the inner surface of the conduit and the outer surface of the lance defining a passageway for the plasma gas, wherein preferably the lance being arranged along the central longitudinal axis of the reactor.

Generally, the reactor further comprises a first and a second swirling element, wherein the first swirling element is arranged closer to the reaction chamber. The swirling element(s) each individually should comprise at least one vane, preferably a plurality of vanes, wherein the plurality of vanes is preferably arranged rotationally symmetric with respect to the central longitudinal axis of the reactor.

If the vane has a continuous decreasing pitch along the flow direction, the gas will be swirled in a right rotation. It is particularly preferred that all vanes of a swirling element have an either an increasing pitch or a decreasing pitch. Generally, all vanes of each swirling elements have an either an increasing pitch or a decreasing pitch so that the rotation of the gas is either left or right. A continuously increasing/decreasing pitch further avoids the interruption of the flow.

The swirling element(s) each individually comprises at least one vane, preferably a plurality of vanes, wherein preferably the at least one vane is inclined with respect to the central longitudinal axis of the reactor, preferably in an angle of 10 to 70°, preferably 15 to 60°, more preferably 25 to 55° and most preferably 25 to 50°.

The at least one vane should be inclined with respect to the central longitudinal axis of the reactor in the plane containing the central longitudinal axis of the reactor and a respective transversal axis, wherein the respective transversal axis is orthogonal to the central longitudinal axis of the reactor and orthogonal to a respective lateral axis, wherein the respective lateral axis is orthogonal to the central longitudinal axis of the reactor and is extending in the direction of the width of the respective vane, wherein preferably the vane is inclined with respect to the central longitudinal axis of the reactor in the aforementioned plane in an angle of 10 to 70°, preferably 15 to 60°, more preferably 25 to 55° and most preferably 25 to 50°.

An alternative definition of the inclination of the vane with respect to the tubular conduit and the central longitudinal axis of the reactor is that the length axis of the vane is parallel to the central longitudinal axis of the reactor and then, the specific vane is rotated by the above-defined angles around the respective central lateral axis of the respective vane. An example for a simple vane is a plate or a rectangle plate, such as a metallic plate. This rectangle plate can than rotated by the above-defined angles, such as for the first and/or second angle.

Providing two series of vanes, namely two swirling elements arranged in series provides the advantage that the swirl of the plasma gas can be induced stepwise so that no flow detachment occurs.

Each of the aforementioned swirling elements (or vane(s)) are normally attached to the inner surface of the tubular conduit or the outer surface of the feedstock injection means such as a feedstock lance. Accordingly, depending on the particular attachment, a gap between the swirling elements (or vane(s)) and the inner surface of the tubular conduit or the outer surface of the feedstock injection means is formed. It is preferred that the gap is small so that most of the gas must pass the swirling element in order to provide a swirled gas and further enhance the technical effect. Moreover, it is particularly advantageous that the swirling elements (or vane(s)) are attached to the inner surface of the tubular conduit since the back flow of gases can be prevented. The attachment of the swirling elements (or vane(s)) to the outer surface of the feedstock injection means provides an advantageous simple construction.

The side of the at least one vane facing the flow can have a constant pitch and/or a continuous increasing/decreasing pitch along the flow direction with respect to the central longitudinal axis of the reactor in the plane containing the central longitudinal axis of the reactor and a respective transversal axis, wherein the respective transversal axis is orthogonal to the central longitudinal axis of the reactor and orthogonal to a respective lateral axis, wherein the respective lateral axis is orthogonal to the central longitudinal axis of the reactor and is extending in the direction of the width of the respective vane.

At least one the swirling element can comprise a vane forming a continuous thread along the central longitudinal axis of the reactor, preferably the vane has 2 to 10 windings, such as 2 to 5 windings, preferably the continuous thread has different pitches, namely a first and a second pitch, wherein the second pitch is larger than the first pitch, and/or the continuous thread has a constant pitch, and/or the pitch of the continuous thread increases/decreases continuously.

The at least one vane should have a planar or curved shape or a combination thereof, and/or wherein the at least one vane has a continuous increasing/decreasing pitch along the flow direction.

The first swirling element can have at least one vane inclined with a first angle with respect to the central longitudinal axis of the reactor in the plane containing the central longitudinal axis of the reactor and a respective transversal axis, and wherein the second swirling element has at least one vane inclined with a second angle with respect to the central longitudinal axis of the reactor in the plane containing the central longitudinal axis of the reactor and a respective transversal axis, wherein the respective transversal axis is orthogonal to the central longitudinal axis of the reactor and orthogonal to a respective lateral axis, wherein the respective lateral axis is orthogonal to the central longitudinal axis of the reactor and is extending in the direction of the width of the respective vane, wherein the first angle is greater than the second angle, preferably the first angle is in the range between 15 to 70°, such as 20 to 60°, 30 to 55°, 35 to 60°, 35 to 55°, or 40 to 50°, and/or the second angle is in the range of 10 to 60°, such as 10 to 55°, 15 to 50°, 20 to 45°, 20 to 40°, or 25 to 35°, and/or wherein the first angle differs from the second angle by at least 5 to 40°, such as 5 to 30°, 8 to 25°, 5 to 20°, or 10 to 20°

The at least one swirling element(s) should be affixed to or integrally formed on the inner surface of the tubular conduit and/or on the outer surface of the feedstock lance, wherein the at least one swirling element(s) is/are preferably replaceable affixed to the inner surface of the tubular conduit and/or on the outer surface of the feedstock lance.

The tubular conduit can further comprise an inflow funnel located in front of the swirling elements with respect to the flow direction, wherein the diameter of the inflow funnel preferably decreases continuously along the flow direction, preferably the diameter ratio of the maximum diameter to the minimum diameter of the inflow funnel is in the range of greater than 1 to 3, such as 1.1 to 2 or 1.5 to 2.

The injection of the feedstock by the lance in the center of the conduit has the advantage that the feedstock is not in contact with the wall. This reduces the possibility of condensation if the tube has a lower temperature than the gas.

The feedstock injection means can comprise at least one injection opening and/or at least one nozzle, wherein the at least one injection opening and/or at least one nozzle is arranged substantially orthogonal to the central longitudinal axis of the reactor and/or arranged at an angle in the range of 70 to 90°, such as 75 to 89°, 80 to 88°, to the central longitudinal axis of the reactor.

The reactor should further comprise a quenching chamber subsequent and downstream to the reaction chamber, preferably comprising means for injecting a quenching medium into the flow passage along the central longitudinal axis of the reactor or using a heat exchanger to reduce the temperature.

The carbon black can be separated from the gases by a simple separation of the solids.

Furthermore, carbon black produced according the inventive method preferably using the inventive reactor is provided.

The invention will now be described with reference to the accompanying figures which do not limit the scope and ambit of the invention. The description provided is purely by way of example and illustration. However, specific features exemplified in the figures can be used to further restrict the scope of the invention and claims.

The reactor according to the present invention is generally represented in FIG. 1 by numeral (100). The reactor in FIG. 1 (100) comprises a chamber (002) in which the plasma (004) is generated. The plasma generator in FIG. 1 is a microwave plasma generator (003), wherein the microwave radiation in introduced into the chamber (002) perpendicular with respect to the along the central longitudinal axis of the reactor (101). The means to provide the plasma are not restricted. For instance, plasma could be radio frequency plasma, arc plasma and microwave plasma. Moreover, the microwave radiation can be provided perpendicular to the central longitudinal axis of the reactor. Accordingly, the microwave radiation for providing the plasma (004) in the reactor (100) can be supplied from one direction or a ring resonator can be used so that the microwave radiation is directed circumferentially into the reaction chamber (002).

The plasma (004) provided by the microwave radiation is present in the reaction chamber (002) without touching the refractory lining (005) of the reactor (100). In FIG. 1 the reactor chamber (002) is designed as a Laval nozzle. A Laval nozzle is a tube which is pinched in the middle making an asymmetric hourglass shape. It is used to accelerate the plasma gas to supersonic speeds in the axial direction, by converting the thermal energy of the flow into kinetic energy. However, the shape of the reaction chamber is not limited to a Laval nozzle design. It is also possible to provide a tubular tube with a constant inner diameter, or different diameters connected with conical parts or connected without conical parts.

The letters A, B, C, D illustrate the possible positions for the introduction of carbon black feedstock (feedstock) (103). However, it is also possible that the plasma gas (102) already comprises the carbon black feedstock (103) or is the carbon black feedstock (103) so that no additional introduction of feedstock (103) as illustrated by A, B, C and D is necessary. Position A for the introduction of carbon black feedstock can be a feedstock lance (A) that is position along the central longitudinal axis of the reactor (101). Accordingly, said lance (A) is position upstream (before, in front of) the means to provide the plasma, e.g. microwave generator (003), or upstream the plasma (004). The feedstock can also be introduced at position (B), e.g. via a nozzle (or injection nozzle), that is also position upstream the plasma (004). The nozzle at position (B) is arranged perpendicularly with respect to the central longitudinal axis of the reactor (101). The position could be behind or before the drawing plane. This gives the opportunity to generate, accelerate or reduce swirl. However, the nozzle at position (B) can inject the carbon black feedstock to induce or enhance the swirl. It is also desired that the feedstock is introduced directly in the plasma (004) according to position (C). Thus, the means to introduce the feedstock is positioned downstream the microwave radiation supplied into the reactor chamber (002) and at a position where the plasma (004) is present. Position (B) indicates that the feedstock is introduced upstream the microwave radiation supplied into the reactor chamber (002) and upstream the plasma. Preferably, the introduction of the feedstock occurs according to position D directly behind the plasma. The injection can be realized perpendicular to reactor axis in the drawing plane, behind the drawing plane or before the drawing plane. The injection can be split to several injection tubes. This setup is particularly preferred if the plasma gas (102) is swirled. A combination of different positions for the introduction of the feedstock is preferred. For instance, a feedstock (103) is introduced upstream the plasma (004) and a second feedstock (103) is introduced downstream the microwave radiation supplied into the reactor chamber (002). For example, a first feedstock is introduced at position (A) and a second feedstock is introduced at position (C).

The plasma gas (102) and the feedstock (103) can be preheated before entering the reaction chamber (002). Preheating should be done using electricity. It is particularly preferred that the plasma gas and/or the feedstock is not heated by a combustion of a fuel.

FIG. 1 relates to a section of a reactor of the production of carbon black. It is desired that a quenching chamber is present downstream the reaction chamber (002). Moreover, it is possible that a swirling element is positioned upstream the reaction chamber (002) to introduce a swirl to the plasma gas (102). Accordingly, it is possible that the swirl of the plasma gas provides a stable and uniform plasma that is not in contact with the inner lining of the reaction chamber. The injection B can be upstream or downstream of the swirl element. However, it is also possible to use e.g. a ring resonator so that the microwave radiation is directed circumferentially into the reaction chamber (002) that is stable and is not in contact with the inner lining of the reaction chamber (002).

The swirling element can be any suitable mean to provide a swirl to the plasma gas. The following figures show a possible element using vanes or fins to provide the desired swirl.

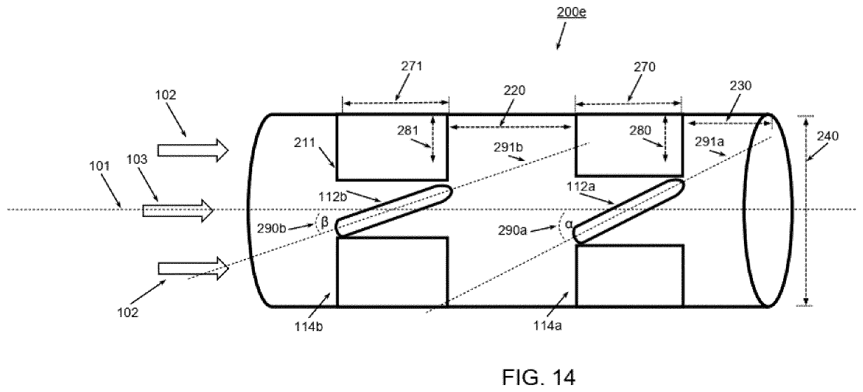

It should be noted that the swirling elements shown in the following figures comprise a feedstock lance. If, however, no feedstock lance is used to provide the feedstock, the tubular conduit can be adapted accordingly, as shown in FIG. 14.

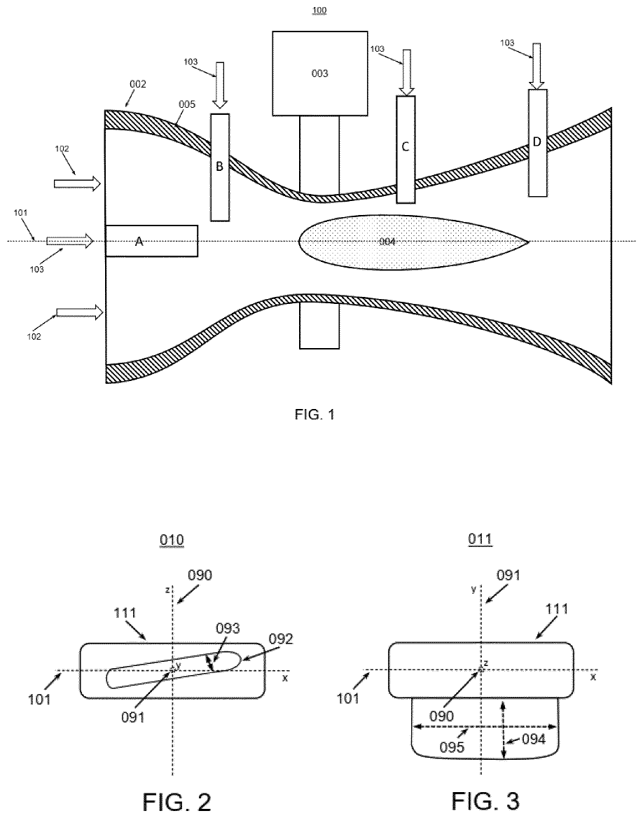

Referring to FIG. 2 and FIG. 3, therein is illustrated a section of a swirling element in the x-z-plane (010) and a section of a swirling element in the x-y-plane (011).

As mentioned above, the swirling element may comprise vanes that are inclined with respect to the flow direction of reactor along the central longitudinal axis of a reactor. FIG. 2 is a view in the x-z plane of the specific vane (092) attached to a feedstock lance (111) inside the tubular conduit (110). Alternatively, if no feedstock lance (111) is present, the vane can be attacked on the inner surface of a tubular conduit. The longitudinal axis of the feedstock lance (111) is coaxial to the central longitudinal axis of a reactor (101). The central longitudinal axis of a reactor (101) represents the x-axis of the plane in the coordinate system. The coordinate system is a Cartesian coordinate system. The z-axis as well as y-axis in the coordinate system depend on the specific vane (092) that is being considered. The z-axis is the respective transversal axis (090) that is orthogonal to the central longitudinal axis of the reactor (101) and orthogonal to a respective lateral axis (091). The respective lateral axis (091) for the vane (092) that is being considered is the y-axis (091) in the coordinate system. The respective lateral axis (091) is orthogonal to the central longitudinal axis of the reactor (101) and is extending in the direction of the width of the respective vane. The width of the vane (094) and the y-axis (091) extending in the direction of the width of the vane (094) that is being considered is shown in FIG. 3. If the angle (or position, alignment, rotation, and/or inclination) of a different vane is considered, another respective lateral axis (z-axis) (090) and respective lateral axis (091) (y-axis) for the considered vane will be used for the coordinate system. In other words, the y- and z-axis depends on the respective vane. Furthermore, the direction of the length (longitude) of the vane (095) extends in the flow direction. The height of the vane (093) is shown in FIG. 2. Preferably, the x-values increases or decreases, preferably increases, in the direction of the flow.

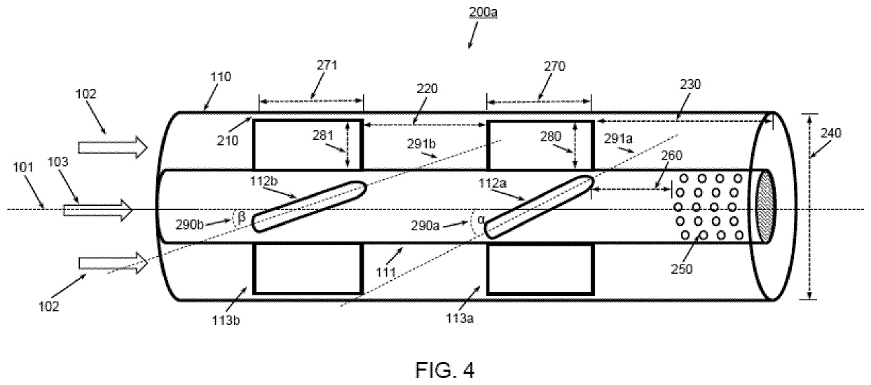

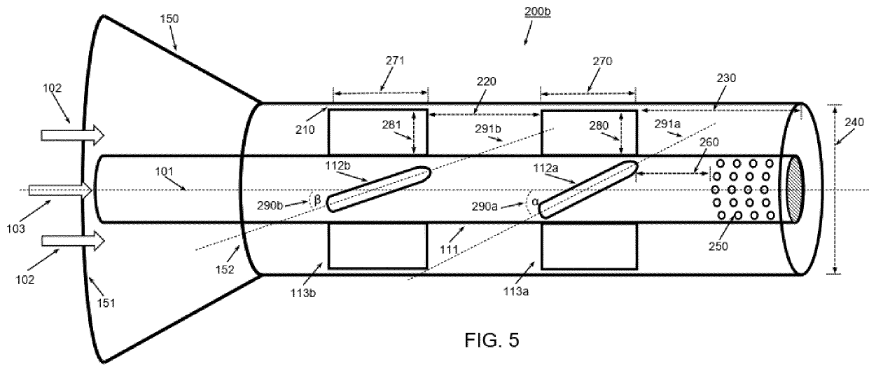

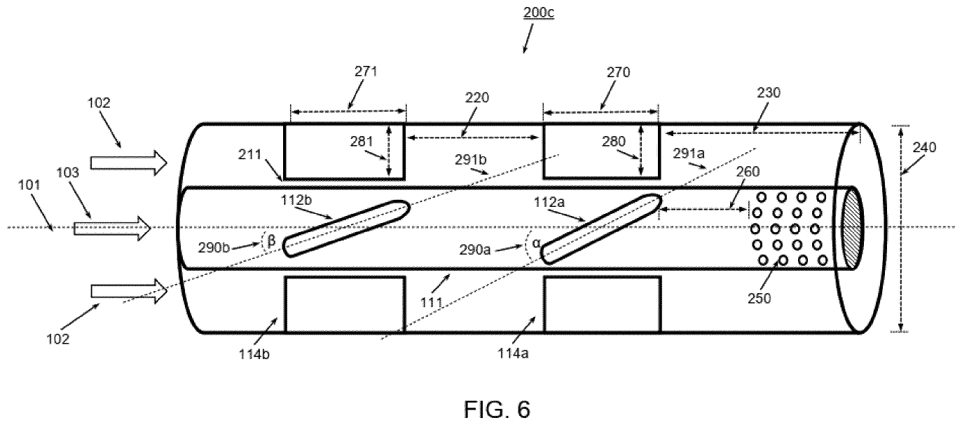

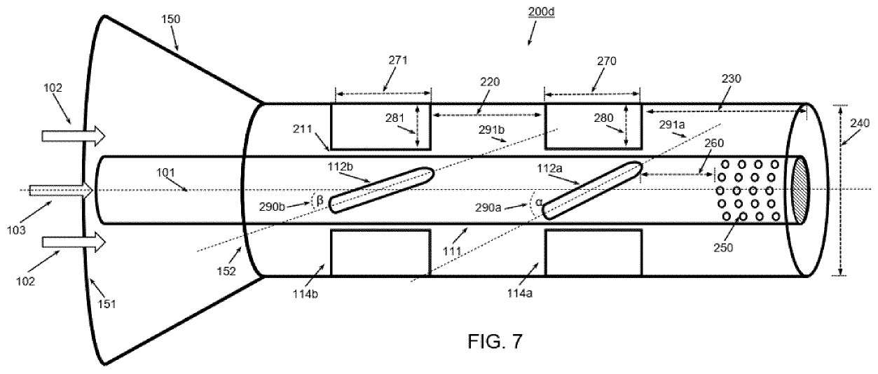

Referring to FIG. 4, FIG. 5, FIG. 6 and FIG. 7, therein are illustrated sections of a tubular conduit including a feedstock lance and a swirling element. The swirling element can be directly attached to the reaction chamber shown in FIG. 1. Particularly, FIG. 4 refers to a section of a tubular conduit including a feedstock lance and a swirling element connected to the outer surface of feedstock lance (200a). FIG. 5 refers to section of a tubular conduit including an inflow funnel, a feedstock lance and a swirling element connected to the outer surface of feedstock lance (200b). FIG. 6 refers to a section of a tubular conduit including a feedstock lance and a swirling element connected to the inner surface of tubular conduit (200c). FIG. 7 refers to a section of a tubular conduit including an inflow funnel, a feedstock lance and a swirling element connected to the inner surface of tubular conduit (200d).

Again, the tubular conduit comprises two swirling elements (113a and 113b or 114a and 114b) that are arranged along the central longitudinal axis of the reactor (101). As mentioned above, FIG. 4 and FIG. 5 reveal a tubular conduit (110), wherein the swirling elements (113a, 113b) are attached to the feedstock lance (111). In FIG. 6 and FIG. 7 the swirling elements (114a, 114b) are attached to the inner wall of the tubular conduit (110). In FIG. 5 and FIG. 7 an inflow funnel (150) is in connection with the tubular conduit (110).

In these figures the feedstock means are provided as multiply injection openings (250) arranged circumferentially around the outer wall of the feedstock lance so that the injection openings (250) are able to inject the feedstock in a substantially orthogonal direction with respect to the central longitudinal axis of the reactor (101).

Referring to FIG. 4 and FIG. 5, the vanes (112a) of the first swirling element (113a) and the vanes (112b) of the second swirling element (113b) are attached to the outer wall of the feedstock lance (111) so that a gap between a vane and the inner surface of the tubular conduit (210) emerges. In FIG. 6 and FIG. 7, the vanes (112a) of the first swirling element (114a) and the vanes (112b) of the second swirling element (114b) are attached to the outer wall of the feedstock lance (111) so that a gap between a vane and the outer surface of the feedstock lance (211) emerges. The size of the respective gap should be in the range of 0 mm to 10 cm, such as 0 mm to 10 cm, 0 mm to 1 cm, 0 mm to 5 mm, 0.1 mm to 10 cm, 1 mm to 1 cm, 1 mm to 5 mm, or 1 mm to 2 mm, as mentioned above. The gap is preferably as small as possible, i.e. 0 mm, so that most of the plasma gas is swirled.

The distance between the first and second swirling element (220) can be in the range from 0 und 300 cm, such as 1 to 300 cm, 1 to 200 cm, 1 to 100 cm, 1 to 70 cm, 10 to 90 cm, 10 to 60 cm, 15 to 40 cm. The distance can be 0 cm. The distance between the first swirling element and the end of the tubular conduit connected to the reaction chamber (230) can be in the range from 0 to 2 m, such as 0 to 1.5 m, 1 cm to 1.5 m, 1 cm to 1 m, 1 cm to 60 cm, 10 cm to 60 cm, 15 cm to 40, 5 cm to 30 cm, or 20 cm to 1 m.

The inner diameter of the tubular conduit (240) can be chosen from 1 cm to 3 m, such as 2 cm to 3 m, 3 cm to 3 m, 2 cm to 10 cm, 13 cm to 1.5 m, 0.1 m to 2 m, 20 cm to 1 m, 30 cm to 1.5 m, 15 cm to 60 cm, or 15 cm to 90 cm, as already described above. The inner diameter of the tubular conduit (240) has an influence of the flow rate of the plasma gas and should be adjusted depending on the size of the reactor.

The distance between the first swirling element and the feedstock inlets (260) can be in the range from 1 cm to 1.5 m, such as 2 cm to 1 m, 10 cm to 1 m, 20 cm to 1 m, or 30 cm to 1 m.

As can be seen from the above-mentioned figures, the vane of the first swirling element (112a) that is closest to the plasma zone (004) is inclined with respect to the central longitudinal axis of the reactor (101) considering the coordinate system as described above. The first angle of a vane of the first swirling element (290a) between the length axis of the vane of the first swirling element (291a) and the central longitudinal axis of the reactor (101) is higher than the second angle of a vane of the second swirling element (290b) between the length axis of the vane of the second swirling element (291b) and the central longitudinal axis of the reactor (101). It should be noted that the vane is positioned on the feedstock lance (111) in such a way that the plasma gas is swirled in a left rotation in view of the flow direction. However, it is also according to the present invention that the plasma gas is swirled in a right rotation in view of the flow direction. It is desired that multiply swirling elements induce the swirl in the same direction. A right rotation can be simply obtained by pointing the vanes (112a, 112b) downwards at e.g. the same angle as shown in said figures so that the opposite side of the vane is facing the plasma gas flow.

Nevertheless, it is desired that all vanes and swirling elements provided inside the same tubular conduit induce swirl in the same rotation such as left or right.

The position and alignment of the vanes can also be described with a function in the coordinate system mentioned above, where the z-axis as well as y-axis in the coordinate system depend on the specific vane (092) that is being considered. Particularly, the respective lateral axis (091) for the respective vane (092) is the y-axis (091) in the coordinate system. The respective lateral axis (091) is orthogonal to the central longitudinal axis of the reactor (101) and is extending in the direction of the width of the respective vane. The z-axis is the respective lateral axis (090) that is orthogonal to the central longitudinal axis of the reactor (101) and orthogonal to a respective lateral axis (091). In this Cartesian coordinate system, the x- and z-axes are being considered for the respective vane. The origin in this Cartesian coordinate system can be in a location on the surface of the vane, which is adjacent to the feedstock lance or the conduit. The vanes in FIGS. 1 to 7 have an area of a constant increasing/decreasing pitch except the rounded corners/edges so that the side of the vane that faces the plasma gas flow can be described with a function such as f(x)=(−)n*x, wherein n is the pitch and the x-axis is represented by the central longitudinal axis of the reactor (101). The term “(−)” in a formula relates to an alternative negative sign indicating a decreasing pitch. Thus, the minus sign is optional. A continuously increasing/decreasing pitch can be described with f(x)=(−)x^{m} (or f(x)=(−) n*x^{m}), wherein m can be chosen from greater than 1 to 10 such as 2 to 10, 1 to 5, 1 to 3, 1.1 to 5, or 2 to 3. The derivative of the function at a specific point x reveals the pitch of the vane at this position. The function can be shifted in the x-, y- and z-direction, for instance f(x)=(−)n*(x+b)^{m}, where the function is shifted in the x-direction. The pitch of a vane that has a constant pitch or an area of a constant pitch is preferably in the range of 0.09 to 10, 0.17 to 6, 0.26 to 6, 0.26 to 3, or 0.17 to 1.75 without a sign (i.e. absolute value). The maximum pitch of a vane without a constant area of a pitch, such as the pitch increases/decreases constantly, is preferably in the range of 0.09 to 10, 0.17 to 6, 0.26 to 6, 0.26 to 3, 0.17 to 2.74, 0.26 to 1.73, 0.46 to 1.42, 0.46 to 1.2, or 0.17 to 1.75 without a sign (i.e. absolute value). Since the absolute value of the maximum pitch is defined, the maximum pitch describes the continuously increasing as well as the decreasing pitch.

The dimensions of the vanes of each swirling element (113a and 113b or 114a and 114b) can be the same or different. For instance, the length of the vanes (095) of the first swirling element (270) can be in the range from 1 cm to 3 m, such as 5 cm to 2 m, 10 cm to 1 m, 15 cm to 1 m, 20 cm to 90 cm, 25 cm to 1 m, 30 to 60 cm, 40 to 1.5 m, or 35 to 3 m. The length of the vanes (095) of the second swirling element (271) can be in the range from 1 cm to 3 m, such as 5 cm to 2 m, 10 cm to 1 m, 15 cm to 1 m, 20 cm to 90 cm, 25 cm to 1 m, 30 to 60 cm, 40 cm to 1.5 m, or 35 cm to 3 m. The width of the vanes (094) of the first swirling element (280) can be in the range from 0.24 cm to 2.9 m, such as 1 cm to 2.5 m, 9 cm to 2.5 m, 10 cm to 2 m, 20 cm to 2 m, 8 cm to 1 m, 12 cm to 1.4 m, 0.1 m to 2 m, 19 cm to 1 m, 30 cm to 1.5 m, 14 cm to 60 cm, 14 to 59, or 14 cm to 89 cm. The width of the vanes (094) of the second swirling element (281) can be in the range from 4 cm to 2.9 m, such as 5 cm to 2.5 m, 9 cm to 2.5 m, 10 cm to 2 m, 20 cm to 2 m, 8 cm to 1 m, 12 cm to 1.4 m, 0.1 m to 2 m, 19 cm to 1 m, 30 cm to 1.5 m, 14 cm to 60 cm, 14 to 59, or 14 cm to 89 cm. Particularly, the width of the vanes (094) of the swirling elements (280, 281) should be selected to that angular gap between a loose end of the at least one swirling element(s) and the inner surface of the tubular conduit or the outer surface of the feedstock lance, to which the swirling element is not affixed to or integrally formed on, is as small as possible such as not more than 0 mm to 10 cm, such as 0 mm to 10 cm, 0 mm to 1 cm, 0 mm to 5 mm, 0.1 mm to 10 cm, 1 mm to 1 cm, 1 mm to 5 mm, or 1 mm to 2 mm, as defined above. It is desired that the shape and dimension of the vane of a specific swirling element are the same. According to the invention, more than two swirl elements are also desirable and the dimensions of vanes of further swirling elements can be selected from the above-mentioned dimensions.

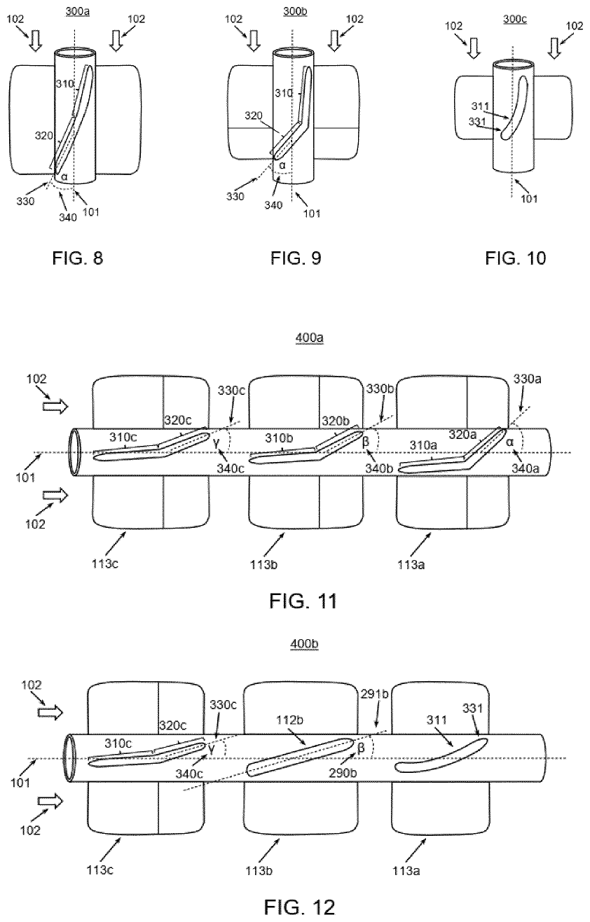

Referring to FIG. 8, FIG. 9, and FIG. 10, therein are illustrated sections of swirling elements. Particularly, FIG. 8 refers to a section of swirling element having two areas of constant pitches with a smooth connection (300a). FIG. 9 refers to a section of swirling element having two areas of constant pitches with a sharp connection (300b). FIG. 10 refers to a section of swirling element having a continuously decreasing pitch (300c). The flow direction is indicated with the arrow showing the passageway for the plasma gas (102). The areas of pitches refer to the side of the vane facing the flow.

FIG. 8 reveals a swirling element that has a first area of a vane having a first constant pitch (310) and a second area of a vane having a second constant pitch (320). Alternatively, the two areas of pitches can be described as two swirling elements that are attached to each other with a distance of 0 mm so that no gap between the vanes are present. The second area of a vane having a second constant pitch (320) comprises an area of a constant pitch and the length axis of the second area of a vane having a second constant pitch (330). The angle of the length axis of the second area of a vane of the first swirling element having a second constant pitch with respect to the central longitudinal axis of the reactor (340) can be the same as defined above, i.e. in an angle of 10 to 70°, preferably 15 to 60°, more preferably 25 to 55° and most preferably 25 to 50. The pitch of the second area of a vane having a second constant pitch (320) can be in the range of 0.09 to 10, 0.17 to 6, 0.26 to 6, 0.26 to 3, 0.17 to 2.74, 0.26 to 1.73, 0.46 to 1.42, 0.46 to 1.2, or 0.17 to 1.75 without a sign (i.e. absolute value).

FIG. 9 differs from FIG. 8 in that the first area of a vane having a first constant pitch (310) and the second area of a vane having a second constant pitch (320) is connected at a sharp angle.

The swirling element (300c) shown in FIG. 10 has a continuously decreasing pitch with respect to the side of the vane that faces the plasma gas flow. Considering the flow direction of the plasma gas (102), the pitch decreases constantly. The function describing the side facing the plasma gas and having constantly decreasing pitch can be described with f(x)=n*(−x)². The maximum pitch of the vane (331) is preferably in the range of 0.09 to 10, 0.17 to 6, 0.26 to 6, 0.26 to 3, 0.17 to 2.74, 0.26 to 1.73, 0.46 to 1.42, 0.46 to 1.2, or 0.17 to 1.75 without a sign (i.e. absolute value). Since the absolute value of the maximum pitch is defined, the maximum pitch describes the continuously increasing as well as the decreasing pitch. It should be noted that the maximum pitch as well as the angle of the vane is responsible for the degree of swirl or spin.

Referring to FIG. 11, and FIG. 12, therein are illustrated sections of a feedstock lance containing three swirling elements having different alignments (400a, 400b).

Particularly, the aforementioned figures reveal different possible configurations of swirling elements attached to a feedstock lance. It is evident that these swirling elements can also be attached to the inner wall of a tubular conduit. Moreover, different arrangement of the different swirling elements is possible.

As can be seen in FIG. 11, three swirling elements are arranged in series. The first swirling that is located closest to the plasma zone (004) comprises a first area of a vane having a first pitch (310a) and a second area of a vane having a second pitch (320a). The second swirling that is located between the first and third swirling element (113c) comprises a first area of a vane having a first pitch (310b) and a second area of a vane having a second pitch (320b). The third swirling element (113c) comprises a first area of a vane having a first pitch (310c) and a second area of a vane having a second pitch (320c). The angles (340a, 340b and 340c) between each length axis of the second area of the respective vane having a second pitch (330a, 330b, and 330c) and the central longitudinal axis of the reactor (101) increases successively in the flow direction so that the degree of swirl is also successively increased.

In FIG. 12, three different types of swirling elements are attached to the feedstock lance. The first swirling element comprises vanes that have a continuous increasing pitch (311) with a maximum pitch (331) at the end of the vane. The second swirling element (112b) has a constant pitch and is inclined with a specific angle (290b) with respect to the length axis of the vane of the second swirling element (291b) and the central longitudinal axis of the reactor (101). The third swirling element comprises a first area of a vane having a first pitch (310c) and a second area of a vane having a second pitch (320c). Again, the pitch and/or angle increases successively in the flow direction.

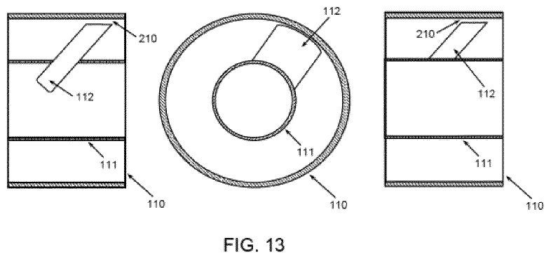

FIG. 13 shows a multiview projection of a swirling element having one vane attached to the outer surface of the feedstock lance (112) inside a tubular conduit (110). It is possible to attach multiple vanes to the feedstock lance. Preferably, multiple vanes are attached to the feedstock lance so that each vane at least partially overlaps with at least a second vane. The vane in FIG. 13 has a constant pitch (311) but other forms of the vane as described above can be used as desired. Moreover, the vanes can also be attached to the inner surface of the tubular conduit (110), particularly if no feedstock lance is present.

FIG. 14 reveals a tubular conduit (110) without a feedstock lance.

It will be appreciated that various modifications can be made, and that many changes can be made in the preferred embodiments without departing from the principle of the invention.
1. A method for producing carbon black, preferably using reactor according to aspects 35 to 60, comprising:
   (a) injecting plasma gas to a carbon black reactor,
   (b) subjecting the plasma gas to a plasma zone (or plasma torch) to obtain a product mixture comprising carbon black,
   (c) quenching the product mixture,
   (d) separating carbon black from the product mixture,
   wherein (i) the plasma gas comprises or consists of a carbon black feedstock, (ii) the carbon black feedstock is injected to the plasma gas upstream the plasma zone, (iii) the carbon black feedstock is injected in the plasma zone, but preferably after the area where the plasma is generated, and/or (iv) the carbon black feedstock is injected to the plasma gas downstream the plasma zone.
2. The method according to aspect 1, wherein plasma is generated in response to excitation of the plasma gas by microwave energy, plasma is generated in response to excitation of the plasma gas by an electric arc, plasma is generated in response to excitation of the plasma gas by a corona discharge, plasma is generated in response to excitation of the plasma gas by a dielectric-barrier discharge (DBD), and/or plasma is generated in response to excitation of the plasma gas by radio frequency energy, preferably plasma is generated in response to excitation of the plasma gas by microwave energy.
3. The method according to any one of aspects 1 or 2, wherein the plasma gas is preheated before subjecting the gas to the plasma zone, preferably the plasma gas is preheated to a temperature between 100 to 1600° C., such as 300 to 1400° C., 400 to 1200° C., 500 to 1000° C., 600 to 1500° C., 100 to 300° C., 200 to 400° C., 300 to 500° C., 400 to 600° C., 1000 to 1500° C., or 700 to 900° C.
4. The method according to any one of the preceding aspects, wherein the plasma gas comprising the carbon black feedstock has a temperature: (i) from 260 to 920 K, preferably 269 to 700 K, (ii) 290 to 340 K, (iii) 340 to 390 K, (iv) 390 to 440 K, (v) 440 to 490 K, (vi) 490 to 540 K, (vii) 540 to 590 K, (viii) 590 to 640 K, (ix) 640 to 690 K, or (x) 690 to 740 K.
5. The method according to any one of the preceding aspects, wherein the plasma gas comprises or is hydrogen and/or H₂O (preferably H₂), and/or wherein the plasma gas comprises or is the carbon black feedstock.
6. The method according to any one of the preceding aspects, wherein (A) the plasma gas and the carbon black feedstock are mixed before subjecting the gas to the plasma zone, and/or (B) the plasma gas comprises or consists (preferably consists) of materials having a critical temperature below the temperature of the gas (plasma gas mixture), and/or (C) the carbon black feedstock (preferably the first carbon black feedstock) comprises or consists of a material having a critical temperature above the temperature of the gas (plasma gas mixture).
7. The method according to any one of the preceding aspects, wherein the plasma gas and the carbon black feedstock are mixed before subjecting the gas to the plasma zone in a molar ratio that the carbon black feedstock does not form droplets (or does not condensate, or is not in a liquid phase) in the carbon black reactor.
8. The method according to any one of the preceding aspects, wherein a material having a critical temperature below the temperature of the gas is present in the plasma gas including the carbon black feedstock, before subjecting the gas to the plasma zone, in a molar ratio that the carbon black feedstock does not form droplets (or does not condensate, or is not in a liquid phase) in the carbon black reactor.
9. The method according to any one of the preceding aspects, wherein the plasma gas and the carbon black feedstock (plasma gas and carbon black mixture) are mixed before subjecting the gas to the plasma zone, wherein the molar percent, based on the total molar amount of the plasma gas including the carbon black feedstock, of the plasma gas and/or of the materials having a critical temperature below the temperature of the gas is
   (i) 1 to 20 mol-% for a carbon black feedstock having a normal boiling point and/or a final normal boiling point of 270 to 300 K and a temperature of the gas mixture of from 250 to 290 K,
   (ii) 30 to 95 mol-% for a carbon black feedstock having a normal boiling point of more than 300 to 350 K and a temperature of the gas mixture of from 270 to 300 K,
   (iii) 50 to 80 mol-% for a carbon black feedstock having a normal boiling point and/or a final normal boiling point of more than 350 to 400 K and a temperature of the gas mixture of from 340 to 360 K,
   (iv) 50 to 75 mol-% for a carbon black feedstock having a normal boiling point and/or a final normal boiling point of more than 400 to 450 K and a temperature of the gas mixture of from 390 to 420 K,
   (v) 40 to 65 mol-% for a carbon black feedstock having a normal boiling point and/or a final normal boiling point of more than 450 to 500 K and a temperature of the gas mixture of from 440 to 460 K,
   (vi)²⁰ to 65 mol-% for a carbon black feedstock having a normal boiling point and/or a final normal boiling point of more than 500 to 550 K and a temperature of the gas mixture of from 490 to 520 K,
   (vii)²⁰ to 55 mol-% for a carbon black feedstock having a normal boiling point and/or a final normal boiling point of more than 550 to 610 K and a temperature of the gas mixture of from 540 to 570 K, or
   (viii) 30 to 65 mol-% for a carbon black feedstock having a normal boiling point and/or a final normal boiling point of more than 610 to 670 K and a temperature of the gas mixture of from 590 to 630 K.
10. The method according to any one of the preceding aspects, wherein the plasma gas comprising carbon black feedstock, before subjecting the gas to the plasma zone,
   (i) for a carbon black feedstock having a final normal boiling point of 270 to 300 K and a temperature of the gas mixture of from 250 to 290 K, comprises 1 mol-% to 20 mol-% of materials having a critical temperature below the temperature of the gas,
   (ii) for a carbon black feedstock having a final normal boiling point of more than 300 to 350 K and a temperature of the gas mixture of from 270 to 290 K, comprises 30 to 95 mol-% of materials having a critical temperature below the temperature of the gas,
   (iii) for a carbon black feedstock having a final normal boiling point of more than 350 to 400 K and a temperature of the gas mixture of from 340 to 360 K, comprises 50 to 80 mol-% of materials having a critical temperature below the temperature of the gas,
   (iv) for a carbon black feedstock having a final normal boiling point of more than 400 to 450 K and a temperature of the gas mixture of from 390° C. to 420 K, comprises 50 to 75 mol-% of materials having a critical temperature below the temperature of the gas,
   (v) for a carbon black feedstock having a final normal boiling point of more than 450 to 500 K and a temperature of the gas mixture of from 440 to 460 K, comprises 40 to 65 mol-% of materials having a critical temperature below the temperature of the gas,
   (vi) for a carbon black feedstock having a final normal boiling point of more than 500 to 550 K and a temperature of the gas mixture of from 490 to 520 K, comprises 20 to 65 mol-% of materials having a critical temperature below the temperature of the gas,
   (vii) for a carbon black feedstock having a final normal boiling point of more than 550 to 610 K and a temperature of the gas mixture of from 540 to 570 K, comprises 20 to 55 mol-% of materials having a critical temperature below the temperature of the gas, or
   (viii) for a carbon black feedstock having a final normal boiling point of more than 610 to 670 K and a temperature of the gas mixture of from 590 to 630 K, comprises 30 to 65 mol-% of materials having a critical temperature below the temperature of the gas,
   wherein the materials preferably comprise plasma gas, such as hydrogen, or carbon black feedstock.
11. The method according to any one of the preceding aspects, wherein the plasma gas and the carbon black feedstock are mixed before subjecting the gas to the plasma zone, wherein the molar percent of the plasma gas, the molar percent of the plasma gas having a critical temperature below the temperature of the gas, and/or the molar percent of the materials having a critical temperature below the temperature of the gas (preferably the molar percent of materials having a critical temperature below the temperature of the gas) is more than x_{dilutant}, based on the total molar amount of the plasma gas including the carbon black feedstock, wherein x_{dilutant} is calculated according to Formula (V):

$${x}_{dilutant} = max ( 1 - \frac{{P}_{0} exp ( - \frac{{Δ}_{vap} {H}_{m}}{RT} + \frac{{Δ}_{vap} {H}_{m}}{{RT}_{b}} )}{P} , 0 ) \cdot 100 \qquad Formula ( V )$$

wherein x_{dilutant} is the dilution, P [Pa] is the pressure of the plasma gas mixture, P₀ [Pa] is the atmospheric pressure, set to 101325 Pa, ΔᵥₐₚHₘ [J/mol] is the normal molar enthalpy of evaporation (e.g. calculated according to Formula (I)) of the carbon black feedstock, R [J/mol/K] is universal gas constant, i.e. 8.314463 J/mol/K, T [K] is system temperature or temperature of the plasma gas mixture, T_{b} [K] is the normal boiling temperature of the carbon black feedstock,
   preferably the molar percent of the plasma gas is between more than x_{dilutant} and (x_{dilutant}+20 mol-%), more preferably the molar percent of the plasma gas is between (x_{dilutant}+1 mol-%) and (x_{dilutant}+15 mol-%), even more preferably the molar percent of the plasma gas is between (x_{dilutant}+3 mol-%) and (x_{dilutant}+12 mol-%), and most preferably the molar percent of the plasma gas is between (x_{dilutant}+5 mol-%) and (x_{dilutant}+10 mol-%).
12. The method according to any one of the preceding aspects, wherein the plasma gas and the carbon black feedstock are mixed before subjecting the gas to the plasma zone, wherein the molar percent of the plasma gas, the molar percent of the plasma gas having a critical temperature below the temperature of the gas, and/or the molar percent of the materials having a critical temperature below the temperature of the gas (preferably the molar percent of materials having a critical temperature below the temperature of the gas) is more than x_{dilutant}, based on the total molar amount of the plasma gas including the carbon black feedstock, wherein x_{dilutant} is calculated according to Formula (IX):

$${x}_{dilutant} = max ( 1 - \frac{1}{P {\sum }_{i = 1}^{N} \frac{{x}_{i}^{vapour}}{100 {P}_{i}^{s}}} , 0 ) \cdot 100 \qquad Formula ( IX )$$

wherein x_{dilutant} is the dilution, P [Pa] is the pressure of the plasma gas mixture, i is the respective compound in the carbon black feedstock,

$${\sum }_{i = 1}^{N}$$

is the sum from i equals 1 to N, i is the compound index of the compounds in the carbon black feedstock,

$${x}_{i}^{vapour}$$

is the molar percentage of the respective compound in the carbon feedstock,

$${P}_{i}^{s} [ Pa ]$$

is the vapor pressure of the respective compound i in the carbon black feedstock at the plasma gas temperature T [K],

$${P}_{i}^{s}$$

is calculated according to Formula (X),

$${P}_{i}^{s} = {P}_{0} exp ( - \frac{{Δ}_{vap} {H}_{m , i}}{RT} + \frac{{Δ}_{vap} {H}_{m , i}}{{RT}_{b , i}} ) \qquad Formula ( X )$$

P₀ [Pa] is the atmospheric pressure, set to 101325 Pa, ΔᵥₐₚHₘᵢ [J/mol] is the molar normal enthalpy of evaporation (e.g. calculated according to Formula (I)) of the respective compound in the carbon black feedstock, R [J/mol/K] is universal gas constant, i.e. 8.314463 J/mol/K, T [K] is system temperature or temperature of the plasma gas mixture, T_{b,i} [K] is the normal boiling temperature of the respective compound in the carbon black feedstock,
   preferably the molar percent of the plasma gas is between more than x_{dilutant} and (x_{dilutant}+20 mol-%), more preferably the molar percent of the plasma gas is between (x_{dilutant}+1 mol-%) and (x_{dilutant}+15 mol-%), even more preferably the molar percent of the plasma gas is between (x_{dilutant}+3 mol-%) and (x_{dilutant}+12 mol-%), and most preferably the molar percent of the plasma gas is between (x_{dilutant}+5 mol-%) and (x_{dilutant}+10 mol-%).
13. The method according to any one of the preceding aspects, wherein the plasma gas and the carbon black feedstock are mixed before subjecting the gas to the plasma zone, wherein the molar percent of the plasma gas, the molar percent of the plasma gas having a critical temperature below the temperature of the gas, and/or the molar percent of the materials having a critical temperature below the temperature of the gas (preferably the molar percent of the plasma gas having a critical temperature below the temperature of the gas) is more than x_{dilutant}, based on the total molar amount of the plasma gas including the carbon black feedstock, wherein x_{dilutant} is calculated according to Formula (XVII):

$${x}_{dilutant} = max ( 1 - \frac{1}{P {\sum }_{i = 1}^{10} \frac{{x}_{pseudo , i}^{vapour}}{100 {P}_{pseudo , i}^{s}}} , 0 ) \cdot 100 \qquad Formula ( XVII )$$

wherein x_{dilutant} is the dilution, P [Pa] is the pressure of the plasma gas mixture, i is the respective sample of the carbon black feedstock,

$${\sum }_{i = 1}^{10}$$

is the sum from i equals 1 to N, i is the compound index of the sample of the carbon black feedstock,

$${x}_{pseudo , i}^{vapour}$$

is the molar percentage of the respective sample of the carbon black feedstock

$${P}_{pseudo , i}^{s} [ Pa ]$$

is the vapor pressure of the respective sample i of the carbon black feedstock at the plasma gas temperature T [K],

$${P}_{pseudo , i}^{s}$$

is calculated according to Formula (XVIII),

$${P}_{pseudo , i}^{s} = {P}_{0} exp ( - \frac{{Δ}_{vap} {H}_{m , i}}{RT} + \frac{{Δ}_{vap} {H}_{m , i}}{{RT}_{b , i}} ) \qquad Formul a ( XVIII )$$

P₀ [Pa] is the atmospheric pressure, set to 101325 Pa, ΔᵥₐₚH_{m,i} [J/mol] is the normal molar enthalpy of evaporation (e.g. calculated according to Formula (XIII)) of the respective sample of the carbon black feedstock, R [J/mol/K] is universal gas constant, i.e. 8.314463 J/mol/K, T [K] is system temperature or temperature of the plasma gas mixture, T_{b,i} [K] is the normal boiling temperature of the respective sample of the carbon black feedstock,
   preferably the molar percent of the plasma gas is between more than x_{dilutant} and (x_{dilutant}+20 mol-%), more preferably the molar percent of the plasma gas is between (x_{dilutant}+1 mol-%) and (x_{dilutant}+15 mol-%), even more preferably the molar percent of the plasma gas is between (x_{dilutant}+3 mol-%) and (x_{dilutant}+12 mol-%), and most preferably the molar percent of the plasma gas is between (x_{dilutant}+5 mol-%) and (x_{dilutant}+10 mol-%).
14. The method according to aspect 13, wherein the carbon black feedstock that is mixed before subjecting the gas to the plasma zone is analyzed by distillation of the carbon black feedstock, wherein the carbon black feedstock is separated by distillation into 10 samples/fractions (preferably 10 samples/fractions having each 10 vol.-% of materials based on the total amount of the analyzed sample) and the temperature at which the last drop of each respective sample/fraction is distilled is used as the respective boiling point T_{b,i} [K] of the sample/fraction, preferably for each sample/fraction the molar fraction is calculated.
15. The method according to any one of the preceding aspects, wherein the plasma gas and the carbon black feedstock are mixed before subjecting the gas to the plasma zone, wherein the molar percent of the plasma gas, the molar percent of the plasma gas having a critical temperature below the temperature of the gas, and/or the molar percent of the materials having a critical temperature below the temperature of the gas (preferably the molar percent of the plasma gas having a critical temperature below the temperature of the gas) is more than x_{dilutant}, based on the total molar amount of the plasma gas including the carbon black feedstock, wherein x_{dilutant} is calculated according to Formula (V), Formula (IX) and/or Formula (XVII),

$${x}_{dilutant} = max ( 1 - \frac{{P}_{0} exp ( - \frac{{Δ}_{vap} {H}_{m}}{RT} + \frac{{Δ}_{vap} {H}_{m}}{{RT}_{b}} )}{P} , 0 ) \cdot 100 \qquad Formula ( V )$$

wherein x_{dilutant} is the dilution, P [Pa] is the pressure of the plasma gas mixture, P₀ [Pa] is the atmospheric pressure, set to 101325 Pa, ΔᵥₐₚHₘ [J/mol] is the normal molar enthalpy of evaporation (e.g. calculated according to Formula (I)) of the carbon black feedstock, R [J/mol/K] is universal gas constant, i.e. 8.314463 J/mol/K, T [K] is system temperature or temperature of the plasma gas mixture, T_{b} [K] is the normal boiling temperature of the carbon black feedstock,

$${x}_{dilutant} = max ( 1 - \frac{1}{P {\sum }_{i = 1}^{N} \frac{{x}_{i}^{vapour}}{100 {P}_{t}^{s}}} , 0 ) \cdot 100 \qquad Formula ( lX )$$

wherein x_{dilutant} is the dilution, P [Pa] is the pressure of the plasma gas mixture, i is the respective compound in the carbon black feedstock,

$${\sum }_{i = 1}^{N}$$

is the sum from i equals 1 to N, i is the compound index of the compounds in the carbon black feedstock,

$${x}_{i}^{vapour}$$

is the molar percentage of the respective compound in the carbon black feedstock,

$${P}_{i}^{s} [ Pa ]$$

is the vapor pressure of the respective compound i in the carbon black feedstock at the plasma gas temperature T [K],

$${P}_{i}^{s}$$

is calculated according to Formula (X),

$${P}_{i}^{s} = {P}_{0} exp ( - \frac{{Δ}_{vap} {H}_{m , i}}{RT} + \frac{{Δ}_{vap} {H}_{m , i}}{{RT}_{b , i}} ) \qquad Formula ( X )$$

P₀ [Pa] is the atmospheric pressure, set to 101325 Pa, ΔᵥₐₚHₘᵢ [J/mol] is the molar normal enthalpy of evaporation (e.g. calculated according to Formula (I)) of the respective compound in the carbon black feedstock, R [J/mol/K] is universal gas constant, i.e. 8.314463 J/mol/K, T [K] is system temperature or temperature of the plasma gas mixture, T_{b,i} [K] is the normal boiling temperature of the respective compound in the carbon black feedstock,

$${x}_{dilutant} = max ( 1 - \frac{1}{P {\sum }_{i = 1}^{10} \frac{{x}_{pseudo , i}^{vapour}}{100 {P}_{pseudo , i}^{s}}} , 0 ) \cdot 100 \qquad Formula ( XVII )$$

wherein x_{dilutant} is the dilution, P [Pa] is the pressure of the plasma gas mixture, i is the respective sample of the carbon black feedstock,

$${\sum }_{i = 1}^{10}$$

is the sum form i equals 1 to N, i is the compound index of the sample of the carbon black feedstock,

$${x}_{pseudo , i}^{vapour}$$

is the molar percentage of the respective sample of the carbon black feedstock,

$${P}_{pseudo , i}^{s} [ Pa ]$$

is the vapor pressure of the respective sample i of the carbon black feedstock at the plasma gas temperature T [K],

$${P}_{pseudo , i}^{s}$$

is calculated according to Formula (XCIII),

$${P}_{pseudo , i}^{s} = {P}_{0} exp ( - \frac{{Δ}_{vap} {H}_{m , i}}{RT} + \frac{{Δ}_{vap} {H}_{m , i}}{{RT}_{b , i}} ) \qquad Formula ( XVIII )$$

P₀ [Pa] is the atmospheric pressure, set to 101325 Pa, ΔᵥₐₚH_{m,i} [J/mol] is the normal molar enthalpy of evaporation (e.g. calculated according to Formula (XIII)) of the respective sample of the carbon black feedstock, R [J/mol/K] is universal gas constant, i.e. 8.314463 J/mol/K, T [K] is system temperature or temperature of the plasma gas mixture, T_{b,i} [K] is the normal boiling temperature of the respective sample of the carbon black feedstock,
   preferably the molar percent of the plasma gas is between more than x_{dilutant} and (x_{dilutant}+20 mol-%), more preferably the molar percent of the plasma gas is between (x_{dilutant}+1 mol-%) and (x_{dilutant}+15 mol-%), even more preferably the molar percent of the plasma gas is between (x_{dilutant}+3 mol-%) and (x_{dilutant}+12 mol-%), and most preferably the molar percent of the plasma gas is between (x_{dilutant}+5 mol-%) and (x_{dilutant}+10 mol-%).
16. The method according to any one of the preceding aspects, wherein the pressure in the plasma zone and/or the pressure of the plasma gas in the plasma zone is 0.1 to 1.3 bar, such as 0.1 to 1.2 bar, 0.1 to 1.1 bar, 0.1 to 1 bar, 0.2 to 1 bar, 0.2 to below 1 bar, 0.1 to 0.5 bar, 0.2 to 0.9 bar, 0.3 to 0.8 bar, or 0.3 to 0.5 bar, wherein preferably the pressure upstream the plasma zone and/or the pressure of the plasma gas upstream the plasma zone is higher than the pressure in the plasma zone and/or the pressure of the plasma gas in the plasma zone.
17. The method according to any one of the preceding aspects, wherein the pressure upstream the plasma zone and/or the pressure of the plasma gas upstream the plasma zone is 0.1 to 3 bar, such as 0.2 to 2.6 bar, 0.5 to 2.5 bar, 0.9 to 2.2 bar, 1 to 2 bar, 1.5 to 2 bar, 1.6 to 3 bar, 1 bar to 1.5 bar, or 1.1 to 1.4 bar, wherein preferably the pressure upstream the plasma zone and/or the pressure of the plasma gas upstream the plasma zone is higher than the pressure in the plasma zone and/or the pressure of the plasma gas in the plasma zone.
18. The method according to any one of the preceding aspects, wherein the reaction chamber is designed as a Laval nozzle so that the gas flow has a speed below 1 Ma before the narrowed portion of the Laval nozzle, a speed of 1 Ma in the narrowed portion of the Laval nozzle and a speed above 1 Ma after the narrowed portion of the Laval nozzle, wherein the plasma is generated in the narrowed portion of the Laval nozzle.
19. The method according to any one of the preceding aspects, wherein the reaction chamber is designed as a Laval nozzle, wherein the plasma is generated in the narrowed portion of the Laval nozzle.
20. The method according to any one of the preceding aspects, wherein the reaction chamber is designed as a Laval nozzle so that the gas flow has a speed below 1 Ma before the narrowed portion of the Laval nozzle, a speed of below 1 Ma in the narrowed portion of the Laval nozzle and a speed below 1 Ma after the narrowed portion of the Laval nozzle,
   wherein the plasma is generated in the narrowed portion of the Laval nozzle, wherein the gas flow speed in the narrowed portion is higher as before the narrowed portion and the gas flow speed after the narrowed portion is higher as in the narrowed portion.
21. The method according to any one of the preceding aspects, wherein the plasma gas, before subjecting the gas to the plasma zone, is swirled, preferably the plasma gas has a swirl number between 0.2 and 1.2, preferably 0.3 to 0.8, more preferably 0.5 to 0.7, even more preferably 0.55 to 0.65.
22. The method according to any one of the preceding aspects, wherein the plasma is generated in response to excitation of the plasma gas by microwave energy and thereby generating a plasma zone, wherein the microwave radiation is applied perpendicular to the central longitudinal axis of the reactor or the flow direction of the plasma gas, and/or the microwave radiation is applied radially and circumferentially to the central longitudinal axis of the reactor or the flow direction of the plasma gas.
23. The method according to any one of the preceding aspects, wherein the plasma gas further comprises H₂O, and/or silica is injected to the product mixture after (downstream) the plasma zone.
24. The method according to any one of the preceding aspects, wherein the temperature in the plasma zone is between 1200 and 5000 K, such as 1300 to 4000 K, 1300 to 3000 K, 1400 to 3500 K, 1300 to 2500 K, 1300 to 2000 K, 1300 to 1800 K, or 1500 to 3000 K.
25. The method according to any one of the preceding aspects, wherein the carbon black feedstock is a liquid, preferably at 23° C. and 1 atm.
26. The method according to any one of the preceding aspects, wherein the carbon black feedstock comprises non-aromatic feedstock, an aromatic feedstock, aliphatic feedstock, aliphatic oil, sustainable feedstock, renewable carbon black feedstock and/or a bio-based feedstock.
27. The method according to any one of the preceding aspects, preferably the plasma gas comprising or is hydrogen and is derived from the pyrolysis of the carbon black feedstock.
28. The method according to any one of the preceding aspects, wherein the method further comprising separating carbon black and H₂ present in the product mixture, and/or providing the separated H₂ as the plasma supply gas.
29. The method according to any one of the preceding aspects, wherein the plasma supply gas or the hot plasma supply gas is not heated by the combustion of a fuel.
30. The method according to any one of the preceding aspects, wherein a first carbon black feedstock is injected in the plasma gas before subjecting the plasma gas to a plasma zone, and wherein a second carbon black feedstock is injected in the plasma zone but preferably after the area where the plasma is generated, wherein preferably the first carbon black feedstock is the carbon black feedstock as defined in any one of the proceedings aspects.
31. The method according to any one of the preceding aspects, wherein a first carbon black feedstock is injected in the plasma gas before subjecting the plasma gas to a plasma zone, and wherein a second carbon black feedstock injected directly after the plasma zone,
   wherein preferably the first carbon black feedstock is the carbon black feedstock as defined in any one of the proceedings aspects.
32. The method according to any one of the preceding aspects, wherein the produced carbon black has
   (a) a STSA surface area determined according to ASTM D6556-17 in a range from 40 to 140 m²/g, preferably from 60 to 130 m²/g, more preferably 65 to 120 m²/g, and an oil absorption number (OAN) measured according to ASTM D2414-18 in a range from 40 to 200 mL/100 g, preferably from 60 to 180 mL/100 g, more preferably from 80 to 160 mL/100 g,
   (b) a STSA surface area determined according to ASTM D6556-17 in a range from 40 to 120 m²/g, preferably from 50 to 100 m²/g, more preferably 65 to 90 m²/g, and an oil absorption number (OAN) measured according to ASTM D2414-18 in a range from 40 to 180 mL/100 g, preferably from 50 to 160 mL/100 g, more preferably from 70 to 150 mL/100 g,
   (c) a STSA surface area determined according to ASTM D6556-17 in a range from 200 to 600 m²/g, preferably from 250 to 500 m²/g, more preferably 300 to 450 m²/g, and an oil absorption number (OAN) measured according to ASTM D2414-18 in a range from 50 to 150 mL/100 g, preferably from 60 to 120 mL/100 g, more preferably from 70 to 100 mL/100 g, and/or
   (d) (d) a STSA surface area determined according to ASTM D6556-17 in a range from 140 to 210 m²/g, preferably from 150 to 200 m²/g, more preferably 160 to 190 m²/g, and an oil absorption number (OAN) measured according to ASTM D2414-18 in a range from 100 to 200 mL/100 g, preferably from 110 to 170 mL/100 g, more preferably from 120 to 160 mL/100 g.
33. The method according to any one of the preceding aspects, wherein 60 to 100 wt.-%, preferably 90 to 100 wt.-%, more preferably 97 to 100 wt.-%, even more preferably 99 to 100 wt.-% and most preferably 99.9 to 100 wt.-% of the carbon black feedstock comprises compounds comprising at least 5 carbon atoms.
34. The method according to any one of the preceding aspects, wherein plasma gas flow (or the hydrogen gas flow) is 10 Nm³/h to 10000 Nm³/h, such as 20 Nm³/h to 5000 Nm³/h, 30 Nm³/h to 2000 Nm³/h, 40 Nm³/h to 1000 Nm³/h, or 50 Nm³/h to 500 Nm³/h.
35. A reactor for producing carbon black having a flow passage along a central longitudinal axis of the reactor, preferably according to any one of the preceding aspects, and comprising:
   (A) a reaction chamber,
   (B) injection means for supplying carbon black feedstock, and
   (C) means to generate a plasma in the reaction chamber thereby forming a plasma zone, wherein (i) the injection means for supplying carbon black feedstock are located upstream the plasma zone, (ii) the injection means for supplying carbon black feedstock are located at the plasma zone, but preferably after the area where the plasma is generated, and/or (iii) the injection means for supplying carbon black feedstock are located downstream the plasma zone, preferably directly behind the plasma zone.
36. The reactor according to aspect 35, wherein the reaction chamber is designed as a Laval nozzle, comprising a narrowed portion in which the plasma is generated.
37. The reactor according to any one of aspects 35 or 36, wherein the reaction chamber is a tubular conduit.
38. The reactor according to any one of aspects 35 to 37, wherein the means to generate a plasma is an arc plasma generator, a microwave plasma generator, a radiofrequency (RF) plasma generator, a corona discharge plasma generator, or a dielectric-barrier discharge (DBD) plasma generator, preferably a microwave plasma generator.
39. The reactor according to any one of aspects 35 to 38, wherein the means to generate a plasma is a microwave generator, wherein the microwave generator is located outside the reaction chamber.
40. The reactor according to any one of aspects 35 to 39, wherein the means to generate a plasma is a microwave plasma generator, wherein the microwave plasma generator comprises a ring resonator circumferentially attached to the reaction chamber.
41. The reactor according to any one of aspects 35 to 40, wherein the means to generate a plasma is a microwave plasma torch, wherein the microwave plasma generator comprises a waveguide and a resonator so that the microwave energy is perpendicular applied to the plasma gas with respect to the central longitudinal axis of the reaction chamber.
42. The reactor according to any one of aspects 35 to 41, wherein the injection means for supplying carbon black feedstock are located upstream the plasma zone and is a feedstock lance arranged coaxial to the central longitudinal axis of the reactor.
43. The reactor according to any one of aspects 35 to 42, wherein the injection means for supplying carbon black feedstock are located upstream the plasma zone and is a feedstock lance arranged coaxial to the central longitudinal axis of the reactor and the injection means for supplying carbon black feedstock are located at the plasma zone, but preferably after the area where the plasma is generated.
44. The reactor according to any one of aspects 35 to 43, wherein the inner lining of the reaction chamber comprises aluminum oxide, preferably the inner lining of the reaction chamber in the area of the plasma zone comprises aluminum oxide, preferably 90 to 100 wt.-% of aluminum oxide, more preferably 95 to 100 wt.-% of aluminum oxide, most preferably 98 to 100 wt.-% of aluminum oxide.
45. The reactor according to any one of aspects 35 to 44, wherein the reactor further comprises a swirling element that is able to swirl the plasma gas and wherein the swirling element is attached upstream to the reaction chamber.
46. The reactor according to any one of aspects 35 to 45, wherein the reactor further comprises a flow guide means connected upstream to the reaction chamber or upstream to the swirling element, wherein the flow guide means is able to receive the plasma gas and cause the plasma gas to flow parallel to the central longitudinal axis of the reactor.
47. The reactor according to aspect 46, wherein the flow guide means comprises a cylindrical body comprising openings in the wall of the cylindrical body that are substantially orthogonal, preferably orthogonal, to the central longitudinal axis of the reactor and the cylindrical body is in connection with the tubular conduit and positioned along the central longitudinal axis of the reactor
48. The reactor according to any one of aspects 35 to 47, wherein the feedstock injection means is a feedstock lance and extending through a tubular conduit with a gap between the inner surface of the conduit and the outer surface of the feedstock lance defining a passageway for the plasma gas, wherein preferably the feedstock lance being arranged along the central longitudinal axis of the reactor, or wherein the injection means is a lance and extending through the tubular conduit with a gap between the inner surface of the conduit and the outer surface of the lance defining a passageway for the plasma gas,
   wherein preferably the lance being arranged along the central longitudinal axis of the reactor.
49. The reactor according to any one of aspects 35 to 48, wherein the reactor comprises a first and a second swirling element, wherein the first swirling element is arranged closer to the reaction chamber.
50. The reactor according to any one of aspects 35 to 49, wherein the swirling element(s) each individually comprises at least one vane, preferably a plurality of vanes, wherein the plurality of vanes is preferably arranged rotationally symmetric with respect to the central longitudinal axis of the reactor.
51. The reactor according to any one of aspects 35 to 50, the swirling element(s) each individually comprises at least one vane, preferably a plurality of vanes, wherein preferably the at least one vane is inclined with respect to the central longitudinal axis of the reactor, preferably in an angle of 10 to 70°, preferably 15 to 60°, more preferably 25 to 55° and most preferably 25 to 50°.
52. The reactor according to any one of aspects 35 to 51, wherein the at least one vane is inclined with respect to the central longitudinal axis of the reactor in the plane containing the central longitudinal axis of the reactor and a respective transversal axis, wherein the respective transversal axis is orthogonal to the central longitudinal axis of the reactor and orthogonal to a respective lateral axis, wherein the respective lateral axis is orthogonal to the central longitudinal axis of the reactor and is extending in the direction of the width of the respective vane, wherein preferably the vane is inclined with respect to the central longitudinal axis of the reactor in the aforementioned plane in an angle of 10 to 70°, preferably 15 to 60°, more preferably 25 to 55° and most preferably 25 to 50°.
53. The reactor according to any one of aspects 35 to 52, wherein the side of the at least one vane facing the flow has a constant pitch and/or a continuous increasing/decreasing pitch along the flow direction with respect to the central longitudinal axis of the reactor in the plane containing the central longitudinal axis of the reactor and a respective transversal axis, wherein the respective transversal axis is orthogonal to the central longitudinal axis of the reactor and orthogonal to a respective lateral axis, wherein the respective lateral axis is orthogonal to the central longitudinal axis of the reactor and is extending in the direction of the width of the respective vane.
54. The reactor according to any one of aspects 35 to 53, wherein at least one the swirling element comprises a vane forming a continuous thread along the central longitudinal axis of the reactor, preferably the vane has 2 to 10 windings, such as 2 to 5 windings, preferably the continuous thread has different pitches, namely a first and a second pitch, wherein the second pitch is larger than the first pitch, and/or the continuous thread has a constant pitch, and/or the pitch of the continuous thread increases/decreases continuously.
55. The reactor according to any one of aspects 35 to 54, wherein the at least one vane has a planar or curved shape or a combination thereof, and/or wherein the at least one vane has a continuous increasing/decreasing pitch along the flow direction.
56. The reactor according to any one of aspects 35 to 55, wherein the first swirling element has at least one vane inclined with a first angle with respect to the central longitudinal axis of the reactor in the plane containing the central longitudinal axis of the reactor and a respective transversal axis, and wherein the second swirling element has at least one vane inclined with a second angle with respect to the central longitudinal axis of the reactor in the plane containing the central longitudinal axis of the reactor and a respective transversal axis, wherein the respective transversal axis is orthogonal to the central longitudinal axis of the reactor and orthogonal to a respective lateral axis, wherein the respective lateral axis is orthogonal to the central longitudinal axis of the reactor and is extending in the direction of the width of the respective vane, wherein the first angle is greater than the second angle, preferably the first angle is in the range between 15 to 70°, such as 20 to 60°, 30 to 55°, 35 to 60°, 35 to 55°, or 40 to 50°, and/or the second angle is in the range of 10 to 60°, such as 10 to 55°, 15 to 50°, 20 to 45°, 20 to 40°, or 25 to 35°, and/or wherein the first angle differs from the second angle by at least 5 to 40°, such as 5 to 30°, 8 to 25°, 5 to 20°, or 10 to 20°.
57. The reactor according to any one of aspects 35 to 56, wherein the at least one swirling element(s) is/are affixed to or integrally formed on the inner surface of the tubular conduit and/or on the outer surface of the feedstock lance, wherein the at least one swirling element(s) is/are preferably replaceable affixed to the inner surface of the tubular conduit and/or on the outer surface of the feedstock lance.
58. The reactor according to any one of aspects 35 to 57, wherein the tubular conduit further comprises an inflow funnel located in front of the swirling elements with respect to the flow direction, wherein the diameter of the inflow funnel preferably decreases continuously along the flow direction, preferably the diameter ratio of the maximum diameter to the minimum diameter of the inflow funnel is in the range of greater than 1 to 3, such as 1.1 to 2 or 1.5 to 2.
59. The reactor according to any one of aspects 35 to 58, wherein the feedstock injection means comprises at least one injection opening and/or at least one nozzle, wherein the at least one injection opening and/or at least one nozzle is arranged substantially orthogonal to the central longitudinal axis of the reactor and/or arranged at an angle in the range of 70 to 90°, such as 75 to 89°, 80 to 88°, to the central longitudinal axis of the reactor.
60. The reactor according to any one of aspects 35 to 59, wherein the reactor further comprises a quenching chamber subsequent and downstream to the reaction chamber, preferably comprising means for injecting a quenching medium into the flow passage along the central longitudinal axis of the reactor or using a heat exchanger to reduce the temperature.
61. Carbon black produced according to any one of aspect 1 to 34 and preferably using the reactor according to any one of aspects 35 to 60.
62. Use of a minimum molar percentage of plasma gas, plasma gas having a critical temperature below the temperature of the gas, and/or materials having a critical temperature below the temperature of the gas (preferably plasma gas having a critical temperature below the temperature of the gas) for the production carbon black, preferably a reactor according to any one of aspects 35 to 60, preferably utilizing the method according to any one of aspects 1 to 34, to prevent the formation of droplets in a reactor (or condensation in a reactor), wherein the plasma gas and the carbon black feedstock are mixed before subjecting the gas to the plasma zone, wherein the minimum molar percentage is more than x_{dilutant}, based on the total molar amount of the plasma gas including the carbon black feedstock, wherein x_{dilutant} is calculated according to Formula (V), Formula (IX) and/or Formula (XVII),

$${x}_{dilutant} = max ( 1 - \frac{{P}_{0} exp ( - \frac{{Δ}_{vap} {H}_{m}}{RT} + \frac{{Δ}_{vap} {H}_{m}}{{RT}_{b}} )}{P} , 0 ) \cdot 100 \qquad Formula ( V )$$

wherein x_{dilutant} is the dilution, P [Pa] is the pressure of the plasma gas mixture, P₀ [Pa] is the atmospheric pressure, set to 101325 Pa, ΔᵥₐₚHₘ [J/mol] is the normal molar enthalpy of evaporation (e.g. calculated according to Formula (I)) of the carbon black feedstock, R [J/mol/K] is universal gas constant, i.e. 8.314463 J/mol/K, T [K] is system temperature or temperature of the plasma gas mixture, T_{b} [K] is the normal (at atmospheric pressure P₀=101325 Pa) boiling temperature of the carbon black feedstock,

$${x}_{dilutant} = max ( 1 - \frac{1}{P {\sum }_{i = 1}^{N} \frac{{x}_{i}^{vapour}}{100 {P}_{i}^{s}}} , 0 ) \cdot 100 \qquad Formula ( IX )$$

wherein x_{dilutant} is the dilution, P [Pa] is the pressure of the plasma gas mixture, i is the respective compound in the carbon black feedstock,

$${\sum }_{i = 1}^{N}$$

is the sum from i equals 1 to N, i is the compound index of the compounds in the carbon black feedstock

$${x}_{i}^{vapour}$$

is the molar percentage of the respective compound in the carbon black feedstock,

$${P}_{i}^{s} [ Pa ]$$

is the vapor pressure of the respective compound i in the carbon black feedstock at the plasma gas temperature T [K],

$${P}_{i}^{s}$$

is calculated according to Formula (X),

$${P}_{i}^{s} = {P}_{0} exp ( - \frac{{Δ}_{vap} {H}_{m , i}}{RT} + \frac{{Δ}_{vap} {H}_{m , i}}{{RT}_{b , i}} ) \qquad Formula ( X )$$

P₀ [Pa] is the atmospheric pressure, set to 101325 Pa, ΔᵥₐₚHₘᵢ [J/mol] is the molar normal enthalpy of evaporation (e.g. calculated according to Formula (I)) of the respective compound in the carbon black feedstock, R [J/mol/K] is universal gas constant, i.e. 8.314463 J/mol/K, T [K] is system temperature or temperature of the plasma gas mixture, T_{b,i} [K] is the normal (at atmospheric pressure P₀=101325 Pa) boiling temperature of the respective compound in the carbon black feedstock,

$${x}_{dilutant} = max ( 1 - \frac{1}{P {\sum }_{i = 1}^{10} \frac{{x}_{pseudo , i}^{vapour}}{100 {P}_{pseudo , i}^{s}}} , 0 ) \cdot 100 \qquad Formula ( XVII )$$

wherein x_{dilutant} is the dilution, P [Pa] is the pressure of the plasma gas mixture, i is the respective sample of the carbon black feedstock,

$${\sum }_{i = 1}^{10}$$

is the sum from i equals 1 to N, i is the compound index of the sample of the carbon black feedstock,

$${x}_{pseudo , i}^{vapour}$$

is the molar percentage of the respective sample of the carbon black feedstock,

$${P}_{pseudo , i}^{s} [ Pa ]$$

is the vapor pressure of the respective sample i of the carbon black feedstock at the plasma gas temperature T [K],

$${P}_{pseudo , i}^{s}$$

is calculated according to Formula (XVIII),

$${P}_{pseudo , i}^{s} = {P}_{0} exp ( - \frac{{Δ}_{vap} {H}_{m , i}}{RT} + \frac{{Δ}_{vap} {H}_{m , i}}{{RT}_{b , i}} ) \qquad Formula ( XVIII )$$

P₀ [Pa] is the atmospheric pressure, set to 101325 Pa, ΔᵥₐₚH_{m,i} [J/mol] is the normal molar enthalpy of evaporation (e.g. calculated according to Formula (XIII)) of the respective sample of the carbon black feedstock, R [J/mol/K] is universal gas constant, i.e. 8.314463 J/mol/K, T [K] is system temperature or temperature of the plasma gas mixture, T_{b,i} [K] is the normal (at atmospheric pressure P₀=101325 Pa) boiling temperature of the respective sample of the carbon black feedstock,
preferably the molar percent of the plasma gas is between more than x_{dilutant} and (x_{dilutant}+mol-%), more preferably the molar percent of the plasma gas is between (x_{dilutant}+1 mol-%) and (x_{dilutant}+15 mol-%), even more preferably the molar percent of the plasma gas is 20 between (x_{dilutant}+3 mol-%) and (x_{dilutant}+12 mol-%), and most preferably the molar percent of the plasma gas is between (x_{dilutant}+5 mol-%) and (x_{dilutant}+10 mol-%).
62. Use of at least two injection means for a carbon black feedstock in a reactor, preferably a reactor according to any one of aspects 35 to 60, for producing carbon black having a flow passage along a central longitudinal axis of the reactor, preferably according to any one of aspects 1 to 34, to prevent the formation of droplets in a reactor (or condensation in a reactor), wherein the reactor comprises: (A) a reaction chamber, (B) injection means for supplying carbon black feedstock, and (C) means to generate a plasma in the reaction chamber thereby forming a plasma zone, wherein (i) the injection means for supplying carbon black feedstock are located upstream the plasma zone, (ii) the injection means for supplying carbon black feedstock are located at the plasma zone, but preferably after the area where the plasma is generated, and/or (iii) the injection means for supplying carbon black feedstock are located downstream the plasma zone, preferably directly behind the plasma zone.
63. Use according to aspect 62, wherein the at least two injection means are (i) the injection means for supplying carbon black feedstock are located upstream the plasma zone and (ii) the injection means for supplying carbon black feedstock are located at the plasma zone, but preferably after the area where the plasma is generated.

1. A method for producing carbon black, comprising:
(a) injecting plasma gas to a carbon black reactor,
(b) subjecting the plasma gas to a plasma zone to obtain a product mixture comprising carbon black,
(c) quenching the product mixture,
(d) separating carbon black from the product mixture,
wherein (i) the plasma gas comprises or consists of a carbon black feedstock, (ii) the carbon black feedstock is injected to the plasma gas upstream the plasma zone, (iii) the carbon black feedstock is injected in the plasma zone, but preferably after the area where the plasma is generated, and/or (iv) the carbon black feedstock is injected to the plasma gas downstream the plasma zone.

2. The method according to claim 1, wherein plasma is generated in response to excitation of the plasma gas by microwave energy, plasma is generated in response to excitation of the plasma gas by an electric arc, plasma is generated in response to excitation of the plasma gas by a corona discharge, plasma is generated in response to excitation of the plasma gas by a dielectric-barrier discharge (DBD), and/or plasma is generated in response to excitation of the plasma gas by radio frequency energy, preferably plasma is generated in response to excitation of the plasma gas by microwave energy.

3. The method according to claim 1, wherein the plasma gas is preheated before subjecting the gas to the plasma zone, preferably the plasma gas is preheated to a temperature between 100 to 1600° C., such as 300 to 1400° C., 400 to 1200° C., 500 to 1000° C., 600 to 1500° C., 100 to 300° C., 200 to 400° C., 300 to 500° C., 400 to 600° C., 1000 to 1500° C., or 700 to 900° C.

4. The method according to claim 1, wherein the plasma gas comprises or is hydrogen and/or H₂O, and/or wherein the plasma gas comprises or is the carbon black feedstock.

5. The method according to claim 1, wherein the plasma gas and the carbon black feedstock are mixed before subjecting the gas to the plasma zone in a molar ratio that the carbon black feedstock does not form droplets in the carbon black reactor.

6. The method according to claim 1, wherein the plasma gas comprising carbon black feedstock, before subjecting the gas to the plasma zone,
(i) for a carbon black feedstock having a final normal boiling point of 270 to 300 K and a temperature of the gas mixture of from 250 to 290 K, comprises 1 mol-% to 20 mol-% of materials having a critical temperature below the temperature of the gas,
(ii) for a carbon black feedstock having a final normal boiling point of more than 300 to 350 K and a temperature of the gas mixture of from 270 to 290 K, comprises 30 to 95 mol-% of materials having a critical temperature below the temperature of the gas,
(iii) for a carbon black feedstock having a final normal boiling point of more than 350 to 400 K and a temperature of the gas mixture of from 340 to 360 K, comprises 50 to 80 mol-% of materials having a critical temperature below the temperature of the gas,
(iv) for a carbon black feedstock having a final normal boiling point of more than 400 to 450 K and a temperature of the gas mixture of from 390° C. to 420 K, comprises 50 to 75 mol-% of materials having a critical temperature below the temperature of the gas,
(v) for a carbon black feedstock having a final normal boiling point of more than 450 to 500 K and a temperature of the gas mixture of from 440 to 460 K, comprises 40 to 65 mol-% of materials having a critical temperature below the temperature of the gas,
(vi) for a carbon black feedstock having a final normal boiling point of more than 500 to 550 K and a temperature of the gas mixture of from 490 to 520 K, comprises 20 to 65 mol-% of materials having a critical temperature below the temperature of the gas,
(vii) for a carbon black feedstock having a final normal boiling point of more than 550 to 610° K and a temperature of the gas mixture of from 540 to 570 K, comprises 20 to 55 mol-% of materials having a critical temperature below the temperature of the gas, or
(viii) for a carbon black feedstock having a final normal boiling point of more than 610 to 670 K and a temperature of the gas mixture of from 590 to 630 K, comprises 30 to 65 mol-% of materials having a critical temperature below the temperature of the gas,
wherein the materials preferably comprise plasma gas, such as hydrogen, or carbon black feedstock.

7. The method according to any claim 1, wherein the plasma gas and the carbon black feedstock are mixed before subjecting the gas to the plasma zone, wherein the molar percent of the plasma gas, the molar percent of the plasma gas having a critical temperature below the temperature of the gas, and/or the molar percent of the materials having a critical temperature below the temperature of the gas (preferably the molar percent of the plasma gas having a critical temperature below the temperature of the gas) is more than x_{dilutant}, based on the total molar amount of the plasma gas including the carbon black feedstock, wherein x_{dilutant} is calculated according to Formula (V), Formula (IX) and/or Formula (XVII),
$${x}_{diluant} = max ( 1 - \frac{{P}_{0} exp ( - \frac{{Δ}_{vap} {H}_{m , i}}{RT} + \frac{{Δ}_{vap} {H}_{m , i}}{{RT}_{b , i}} )}{P} , 0 ) \cdot 100 \qquad Formula ( V )$$
wherein x_{dilutant} is the dilution, P [Pa] is the pressure of the plasma gas mixture, P₀ [Pa] is the atmospheric pressure, set to 101325 Pa, ΔᵥₐₚHₘ [J/mol] is the normal molar enthalpy of evaporation (e.g. calculated according to Formula (I)) of the carbon black feedstock, R [J/mol/K] is universal gas constant, i.e. 8.314463 J/mol/K, T [K] is system temperature or temperature of the plasma gas mixture, T_{b} [K] is the normal (at atmospheric pressure P₀=101325 Pa) boiling temperature of the carbon black feedstock,
$${x}_{diluant} = max ( 1 - \frac{1}{P {\sum }_{i = 1}^{N} \frac{{x}_{i}^{vapour}}{100 {P}_{i}^{s}}} , 0 ) \cdot 100 \qquad Formula ( IX )$$
wherein x_{dilutant} is the dilution, P [Pa] is the pressure of the plasma gas mixture, i is the respective compound in the carbon black feedstock,
$${\sum }_{i = 1}^{N}$$
is the sum from i equals 1 to N, i is the compound index of the compounds in the carbon black feedstock,
$${x}_{i}^{vapour}$$
is the molar percentage of the respective compound in the carbon black feedstock
$${P}_{i}^{s} [ Pa ]$$
is the vapor pressure of the respective compound i in the carbon black feedstock at the plasma gas temperature T [K],
$${P}_{i}^{s}$$
is calculated according to Formula (X),
$${P}_{i}^{s} = {P}_{0} exp ( - \frac{{Δ}_{vap} {H}_{m , i}}{RT} + \frac{{Δ}_{vap} {H}_{m , i}}{{RT}_{b , i}} ) \qquad Formula ( X )$$
P₀ [Pa] is the atmospheric pressure, set to 101325 Pa, ΔᵥₐₚHₘᵢ [J/mol] is the molar normal enthalpy of evaporation (e.g. calculated according to Formula (I)) of the respective compound in the carbon black feedstock, R [J/mol/K] is universal gas constant, i.e. 8.314463 J/mol/K, T [K] is system temperature or temperature of the plasma gas mixture, T_{b,i} [K] is the normal (at atmospheric pressure P₀=101325 Pa) boiling temperature of the respective compound in the carbon black feedstock,
$${x}_{diluant} = max ( 1 - \frac{1}{P {\sum }_{i = 1}^{10} \frac{{x}_{pseudo , i}^{vapour}}{100 {P}_{pseudo , i}^{s}}} , 0 ) \cdot 100 \qquad Formula ( XVII )$$
wherein x_{dilutant} is the dilution, P [Pa] is the pressure of the plasma gas mixture, i is the respective sample of the carbon black feedstock,
$${\sum }_{i = 1}^{10}$$
is the sum form i equals 1 to N, i is the compound index of the sample of the carbon black feedstock,
$${x}_{pseudo , i}^{vapour}$$
is the molar percentage of the respective sample of the carbon black feedstock,
$${P}_{pseudo , i}^{s} [ Pa ]$$
is the vapor pressure of the respective sample i of the carbon black feedstock at the plasma gas temperature T [K],
$${P}_{pseudo , i}^{s}$$
is calculated according to Formula (XVIII),
$${P}_{pseudo , i}^{s} = {P}_{0} exp ( - \frac{{Δ}_{vap} {H}_{m , i}}{RT} + \frac{{Δ}_{vap} {H}_{m , i}}{{RT}_{b , i}} ) \qquad Formula ( XVIII )$$
P₀ [Pa] is the atmospheric pressure, set to 101325 Pa, ΔᵥₐₚH_{m,i} [J/mol] is the normal molar enthalpy of evaporation (e.g. calculated according to Formula (XIII)) of the respective sample of the carbon black feedstock, R [J/mol/K] is universal gas constant, i.e. 8.314463 J/mol/K, T [K] is system temperature or temperature of the plasma gas mixture, T_{b,i} [K] is the normal (at atmospheric pressure P₀=101325 Pa) boiling temperature of the respective sample of the carbon black feedstock,
preferably the molar percent of the plasma gas is between more than x_{dilutant} and (x_{dilutant}+20 mol-%), more preferably the molar percent of the plasma gas is between (x_{dilutant}+1 mol-%) and (x_{dilutant}+15 mol-%), even more preferably the molar percent of the plasma gas is between (x_{dilutant}+3 mol-%) and (x_{dilutant}+12 mol-%), and most preferably the molar percent of the plasma gas is between (x_{dilutant}+5 mol-%) and (x_{dilutant}+10 mol-%).

8. The method according to claim 1, wherein the reaction chamber is designed as a Laval nozzle, wherein the plasma is generated in the narrowed portion of the Laval nozzle, and/or wherein the plasma gas, before subjecting the gas to the plasma zone, is swirled, preferably the plasma gas has a swirl number between 0.2 and 1.2, preferably 0.3 to 0.8, more preferably 0.5 to 0.7, even more preferably 0.55 to 0.65.

9. A reactor for producing carbon black having a flow passage along a central longitudinal axis of the reactor and comprising:
(A) a reaction chamber,
(B) injection means for supplying carbon black feedstock, and
(C) means to generate a plasma in the reaction chamber thereby forming a plasma zone,
wherein (i) the injection means for supplying carbon black feedstock are located upstream the plasma zone, (ii) the injection means for supplying carbon black feedstock are located at the plasma zone, but preferably after the area where the plasma is generated, and/or (iii) the injection means for supplying carbon black feedstock are located downstream the plasma zone, preferably directly behind the plasma zone.

10. The reactor according to claim 9, wherein the reaction chamber is designed as a Laval nozzle, comprising a narrowed portion in which the plasma is generated and/or wherein the means to generate a plasma is an arc plasma generator, a microwave plasma generator, a radiofrequency (RF) plasma generator, a corona discharge plasma generator, or a dielectric-barrier discharge (DBD) plasma generator, preferably a microwave plasma generator.

11. The reactor according to claim 9, wherein the inner lining of the reaction chamber comprises aluminum oxide, preferably the inner lining of the reaction chamber in the area of the plasma zone comprises aluminum oxide, preferably 90 to 100 wt.-% of aluminum oxide, more preferably 95 to 100 wt.-% of aluminum oxide, most preferably 98 to 100 wt.-% of aluminum oxide.

12. The reactor according to claim 9, wherein the reactor further comprises a swirling element that is able to swirl the plasma gas and wherein the swirling element is attached upstream to the reaction chamber.

13. Carbon black produced according to claim 1 using a reactor comprising:
(A) a reaction chamber,
(B) injection means for supplying carbon black feedstock, and
(C) means to generate a plasma in the reaction chamber thereby forming a plasma zone,
wherein (i) the injection means for supplying carbon black feedstock are located upstream the plasma zone, (ii) the injection means for supplying carbon black feedstock are located at the plasma zone, but preferably after the area where the plasma is generated, and/or (iii) the injection means for supplying carbon black feedstock are located downstream the plasma zone, preferably directly behind the plasma zone.

14. Use of a minimum molar percentage of plasma gas, plasma gas having a critical temperature below the temperature of the gas, and/or materials having a critical temperature below the temperature of the gas for the production carbon black to prevent the formation of droplets in a reactor, wherein the plasma gas and the carbon black feedstock are mixed before subjecting the gas to the plasma zone, wherein the minimum molar percentage is more than x_{dilutant}, based on the total molar amount of the plasma gas including the carbon black feedstock, wherein x_{dilutant} is calculated according to Formula (V), Formula (IX) and/or Formula (XVII),
$${x}_{diluant} = max ( 1 - \frac{{P}_{0} exp ( - \frac{{Δ}_{vap} {H}_{m , i}}{RT} + \frac{{Δ}_{vap} {H}_{m , i}}{{RT}_{b , i}} )}{P} , 0 ) \cdot 100 \qquad Formula ( V )$$
wherein x_{dilutant} is the dilution, P [Pa] is the pressure of the plasma gas mixture, P₀ [Pa] is the atmospheric pressure, set to 101325 Pa, ΔᵥₐₚHₘ [J/mol] is the normal molar enthalpy of evaporation (e.g. calculated according to Formula (I)) of the carbon black feedstock, R [J/mol/K] is universal gas constant, i.e. 8.314463 J/mol/K, T [K] is system temperature or temperature of the plasma gas mixture, T_{b} [K] is the normal (at atmospheric pressure P₀=101325 Pa) boiling temperature of the carbon black feedstock,
$${x}_{diluant} = max ( 1 - \frac{1}{P {\sum }_{i = 1}^{N} \frac{{x}_{i}^{vapour}}{100 {P}_{i}^{s}}} , 0 ) \cdot 100 \qquad Formula ( IX )$$
wherein x_{dilutant} is the dilution, P [Pa] is the pressure of the plasma gas mixture, i is the respective compound in the carbon black feedstock,
$${\sum }_{i = 1}^{N}$$
is the sum from i equals 1 to N, i is the compound index of the compounds in the carbon black feedstock,
$${x}_{i}^{vapour}$$
is the molar percentage of the respective compound in the carbon black feedstock
$${P}_{i}^{s} [ Pa ]$$
is the vapor pressure of the respective compound i in the carbon black feedstock at the plasma gas temperature T [K],
$${P}_{i}^{s}$$
is calculated according to Formula (X),
$${P}_{i}^{s} = {P}_{0} exp ( - \frac{{Δ}_{vap} {H}_{m , i}}{RT} + \frac{{Δ}_{vap} {H}_{m , i}}{{RT}_{b , i}} ) \qquad Formula ( X )$$
P₀ [Pa] is the atmospheric pressure, set to 101325 Pa, ΔᵥₐₚHₘᵢ [J/mol] is the molar normal enthalpy of evaporation (e.g. calculated according to Formula (I)) of the respective compound in the carbon black feedstock, R [J/mol/K] is universal gas constant, i.e. 8.314463 J/mol/K, T [K] is system temperature or temperature of the plasma gas mixture, T_{b,i} [K] is the normal (at atmospheric pressure P₀=101325 Pa) boiling temperature of the respective compound in the carbon black feedstock,
$${x}_{diluant} = max ( 1 - \frac{1}{P {\sum }_{i = 1}^{N} \frac{{x}_{pseudo , i}^{vapour}}{100 {P}_{pseudo , i}^{s}}} , 0 ) \cdot 100 \qquad Formula ( XVII )$$
wherein x_{dilutant} is the dilution, P [Pa] is the pressure of the plasma gas mixture, i is the respective sample of the carbon black feedstock,
$${\sum }_{i = 1}^{10}$$
is the sum form i equals 1 to N, i is the compound index of the sample of the carbon black feedstock,
$${x}_{pseudo , i}^{vapour}$$
is the molar percentage of the respective sample of the carbon black feedstock,
$${P}_{pseudo , i}^{s} [ Pa ]$$
is the vapor pressure of the respective sample i of the carbon black feedstock at the plasma gas temperature T [K],
$${P}_{pseudo , i}^{s}$$
is calculate according to Formula (XVIII),
$${P}_{pseudo , i}^{s} = {P}_{0} exp ( - \frac{{Δ}_{vap} {H}_{m , i}}{RT} + \frac{{Δ}_{vap} {H}_{m , i}}{{RT}_{b , i}} ) \qquad Formula ( XVIII )$$
P₀ [Pa] is the atmospheric pressure, set to 101325 Pa, ΔᵥₐₚH_{m,i} [J/mol] is the normal molar enthalpy of evaporation (e.g. calculated according to Formula (XIII)) of the respective sample of the carbon black feedstock, R [J/mol/K] is universal gas constant, i.e. 8.314463 J/mol/K, T [K] is system temperature or temperature of the plasma gas mixture, T_{b,i} [K] is the normal (at atmospheric pressure P₀=101325 Pa) boiling temperature of the respective sample of the carbon black feedstock,
preferably the molar percent of the plasma gas is between more than x_{dilutant} and (x_{dilutant}+20 mol-%), more preferably the molar percent of the plasma gas is between (x_{dilutant}+1 mol-%) and (x_{dilutant}+15 mol-%), even more preferably the molar percent of the plasma gas is between (x_{dilutant}+3 mol-%) and (x_{dilutant}+12 mol-%), and most preferably the molar percent of the plasma gas is between (x_{dilutant}+5 mol-%) and (x_{dilutant}+10 mol-%).

15. Use of at least two injection means for a carbon black feedstock in a reactor for producing carbon black having a flow passage along a central longitudinal axis of the reactor to prevent the formation of droplets in a, wherein the reactor comprises: (A) a reaction chamber, (B) injection means for supplying carbon black feedstock, and (C) means to generate a plasma in the reaction chamber thereby forming a plasma zone, wherein (i) the injection means for supplying carbon black feedstock are located upstream the plasma zone, (ii) the injection means for supplying carbon black feedstock are located at the plasma zone, but preferably after the area where the plasma is generated, and/or (iii) the injection means for supplying carbon black feedstock are located downstream the plasma zone, preferably directly behind the plasma zone
